(19) United States
(12) Patent Application Publication
(10) Pub. No.: US 2014/0321546 A1
(43) Pub. Date: Oct. 30, 2014

(54) IMAGE PROCESSING APPARATUS AND IMAGE PROCESSING METHOD

(71) Applicants: Hironari Sakurai, Tokyo (JP); Yoshitomo Takahashi, Kanagawa (JP); Shinobu Hattori, Tokyo (JP)

(72) Inventors: Hironari Sakurai, Tokyo (JP); Yoshitomo Takahashi, Kanagawa (JP); Shinobu Hattori, Tokyo (JP)

(73) Assignee: Sony Corporation, Tokyo (JP)

(21) Appl. No.: 14/239,591

(22) PCT Filed: Aug. 21, 2012
(86) PCT No.: PCT/JP2012/071030

§ 371 Date: May 13, 2014

(30) Foreign Application Priority Data
Aug. 31, 2011 (JP) 2011-188995
Nov. 18, 2011 (JP) 2011-253173
Jan. 31, 2012 (JP) 2012-018410
Jan. 31, 2012 (JP) 2012-018978

(51) Int. Cl. H04N 13/00; H04N 19/597; H04N 19/51

(52) U.S. Cl. CPC H04N 13/0048; H04N 19/00684; H04N 19/00769
USPC 375/240.16

(57) ABSTRACT

The present technology relates to an image processing apparatus and an image processing method capable of improving an encoding efficiency of a parallax image using information with regard to the parallax image.

A depth correction unit performs a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target. A luminance correction unit generates a depth prediction image by performing a weighting prediction process using a weighting coefficient and an offset after the depth weighting prediction process is performed. A target depth image to be encoded is encoded using a depth prediction image and a depth stream is generated. The present technology can be applied to, for example, an encoding apparatus of a depth image.

### TECHNICAL FIELD

The present technology relates to an image processing apparatus and an image processing method, and particularly to an image processing apparatus and an image processing method which can improve encoding efficiency of a parallax image using information with regard to the parallax image.

### BACKGROUND ART

In recent days, attention has been paid to 3D images and an encoding method of a parallax image which is used for generation of multi-viewpoint 3D images has been proposed (for example, Non-Patent Literature 1). In addition, a parallax image is an image having a disparity value representing distance in a horizontal direction of a position on a screen of each pixel of a color image having a viewpoint corresponding to the parallax image and the corresponding pixel of a color image having a viewpoint as a reference.

Further, recently, standardization of an encoding method called HEVC (High Efficiency Video Coding) has been proceeding for the purpose of further improvement of encoding efficiency than that of an AVC (Advanced Video Coding) method, and as of August 2011, Non-Patent Literature 2 has been published as a draft.

### CITATION LIST

### Non Patent Literature

NPL 1: “Call for Proposals on 3D Video Coding Technology”, ISO/IEC JTC1/SC29/WG11, MPEG2011/N12036, Geneva, Switzerland, March 2011

NPL 2: Thomas Wiegand, Woo-jin Han, Benjamin Bross, Jens-Rainer Ohm, Gary J. Sullivian, “WD3: Working Draft3 of High-Efficiency Video Coding” JCTVC-E603_d5 (version 5), May 20, 2011

### SUMMARY OF INVENTION

### Technical Problem

However, an encoding method which improves encoding efficiency of a parallax image using information with regard to the parallax image has not been proposed.

The present technology has been made in light of the above problem and can improve encoding efficiency of a parallax image using information with regard to the parallax image.

### Solution to Problem

An image processing apparatus according to a first aspect of the present technology includes a depth motion prediction unit which performs a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target; a motion prediction unit which generates a depth prediction image by performing a weighting prediction process using a weighting coefficient and an offset after the depth weighting prediction process is performed by the depth motion prediction unit; and an encoding unit which generates a depth stream by encoding a target depth image to be encoded, using the depth prediction image generated by the motion prediction unit.

An image processing method according to the first aspect of the present technology corresponds to the image processing apparatus according to the first aspect of the present technology.

In the first aspect of the present technology, a depth weighting prediction process is performed using a depth weighting coefficient and a depth offset based on a depth range indicating a range of a position in a depth direction, which is used when a depth value representing the position in the depth direction as a pixel value of a depth image is normalized, with the depth image as a target; a depth prediction image is generated by performing a weighting prediction process using a weighting coefficient and an offset after the depth weighting prediction process is performed; and a depth stream is generated by encoding a target depth image to be encoded, using the depth prediction image.

An image processing apparatus according to a second aspect of the present technology includes a receiving unit which receives a depth stream, encoded using a prediction image of a depth image that is corrected using information with regard to the depth image, and the information with regard to the depth image; a depth motion prediction unit which calculates a depth weighting coefficient and a depth offset based on a depth range indicating a range of a position in a depth direction, which is used when a depth value representing the position in the depth direction as a pixel value of a depth image is normalized, using the information with regard to the depth image received by the receiving unit and performs a depth weighting prediction process using the depth weighting coefficient and the depth offset with the depth image as a target; a motion prediction unit which generates a depth prediction image by performing a weighting prediction process using a weighting coefficient and an offset after the depth weighting prediction process is performed by the depth motion prediction unit; and a decoding unit which decodes the depth stream received by the receiving unit using the depth prediction image generated by the motion prediction unit.

An image processing method according to the second aspect of the present technology corresponds to the image processing apparatus according to the second aspect of the present technology.

In the second aspect of the present technology, a depth stream encoded using a prediction image of a depth image that is corrected using information with regard to the depth image, and the information with regard to the depth image are received; a depth weighting coefficient and a depth offset are calculated based on a depth range indicating a range of a position in a depth direction, which is used when a depth value representing the position in the depth direction as a pixel value of the depth image is normalized, using the received information with regard to the depth image, and a depth weighting prediction process is performed using the depth weighting coefficient and the depth offset with the depth image as a target; a depth prediction image is generated by performing a weighting prediction process using a weighting coefficient and an offset after the depth weighting prediction process is performed; and the depth stream is decoded using the generated depth prediction image.

An image processing apparatus according to a third aspect of the present technology includes a depth motion prediction unit which performs a depth weighting prediction process using a depth weighting coefficient and a depth offset based on a disparity range indicating a range of a disparity, which is used when the disparity as a pixel value of a depth image is normalized, with the depth image as a target; a motion prediction unit which generates a depth prediction image by performing a weighting prediction process using a weighting coefficient and an offset after the depth weighting prediction process is performed by the depth motion prediction unit; and an encoding unit which generates a depth stream by encoding a target depth image to be encoded, using the depth prediction image generated by the motion prediction unit.

An image processing method according to the third aspect of the present technology corresponds to the image processing apparatus according to the third aspect of the present technology.

In the third aspect of the present technology, a depth weighting prediction process is performed using a depth weighting coefficient and a depth offset based on a disparity range indicating a range of a disparity, which is used when the disparity as a pixel value of a depth image is normalized, with the depth image as a target; a depth prediction image is generated by performing a weighting prediction process using a weighting coefficient and an offset after the depth weighting prediction process is performed; and a depth stream is generated by encoding a target depth image to be encoded, using the generated depth prediction image.

An image processing apparatus according to a fourth aspect of the present technology includes a receiving unit which receives a depth stream, encoded using a prediction image of a depth image that is corrected using information with regard to the depth image, and the information with regard to the depth image; a depth motion prediction unit which calculates a depth weighting coefficient and a depth offset based on a disparity range indicating a range of a disparity, which is used when the disparity as a pixel value of the depth image is normalized, using the information with regard to the depth image received by the receiving unit and performs a depth weighting prediction process using the depth weighting coefficient and the depth offset with the depth image as a target; a motion prediction unit which generates a depth prediction image by performing a weighting prediction process using a weighting coefficient and an offset after the depth weighting prediction process is performed by the depth motion prediction unit; and a decoding unit which decodes the depth stream received by the receiving unit using the depth prediction image generated by the motion prediction unit.

An image processing method according to the fourth aspect of the present technology corresponds to the image processing apparatus according to the fourth aspect of the present technology.

In the fourth aspect of the present technology, a depth stream encoded using a prediction image of a depth image that is corrected using information with regard to the depth image, and the information with regard to the depth image are received; a depth weighting coefficient and a depth offset are calculated based on a disparity range indicating a range of a disparity, which is used when the disparity as a pixel value of the depth image is normalized, using the received information with regard to the depth image and a depth weighting prediction process is performed using the depth weighting coefficient and the depth offset with the depth image as a target; a depth prediction image is generated by performing a weighting prediction process using a weighting coefficient and an offset after the depth weighting prediction process is performed; and the received depth stream is decoded using the generated depth prediction image.

### Advantageous Effects of Invention

According to the first and third aspects of the present technology, it is possible to improve encoding efficiency of a parallax image using information with respect to the parallax image.

Further, according to the second and fourth aspects of the present technology, it is possible to decode encoded data of a parallax image in which the encoding efficiency is improved by being encoded using information with regard to the parallax image.

### BRIEF DESCRIPTION OF DRAWINGS

FIG. 1 is a block diagram illustrating a configuration example of an embodiment of an encoding apparatus to which the present technology is applied.

FIG. 2 is a diagram describing a maximum disparity value and a minimum disparity value of information for generating viewpoints.

FIG. 3 is a diagram describing a disparity precision parameter of information for generating viewpoints.

FIG. 4 is a diagram describing a distance between cameras of information for generating viewpoints.

FIG. 5 is a block diagram illustrating a configuration example of a multi-viewpoint image encoding unit of FIG. 1.

FIG. 6 is a block diagram illustrating a configuration example of an encoding unit.

FIG. 7 is a diagram illustrating a configuration example of an encoded bit stream.

FIG. 8 is a diagram illustrating an example of PPS syntax of FIG. 7.

FIG. 9 is a diagram illustrating an example of syntax of a slice header.

FIG. 10 is a diagram illustrating an example of syntax of the slice header.

FIG. 11 is a flowchart describing an encoding process of the encoding apparatus of FIG. 1.

FIG. 12 is a flowchart describing details of a multi-viewpoint encoding process of FIG. 11.

FIG. 13 is a flowchart describing details of a parallax image encoding process of FIG. 12.

FIG. 14 is a flowchart describing details of the parallax image encoding process of FIG. 12.

FIG. 15 is a block diagram illustrating a configuration example of an embodiment of a decoding apparatus to which the present technology is applied.

FIG. 16 is a block diagram illustrating a configuration example of a multi-viewpoint image decoding unit of FIG. 15.

FIG. 17 is a block diagram illustrating a configuration example of a decoding unit.

FIG. 18 is a flowchart describing a decoding process of a decoding apparatus 150 of FIG. 15.

FIG. 19 is a flowchart describing details of a multi-viewpoint decoding process of FIG. 18.

FIG. 20 is a flowchart describing details of a parallax image decoding process of FIG. 16.

FIG. 21 is a diagram describing a transmission method of information used to correct a prediction image.

FIG. 22 is a diagram illustrating a configuration example of an encoded bit stream in a second transmission method.

FIG. 23 is a diagram illustrating a configuration example of an encoded bit stream in a third transmission method.

FIG. 24 is a block diagram illustrating a configuration example of a slice encoding unit.

FIG. 25 is a block diagram illustrating a configuration example of the encoding unit.

FIG. 26 is a block diagram illustrating a configuration example of a correction unit.

FIG. 27 is a diagram for describing a position of a disparity value and a depth direction.

FIG. 28 is a diagram illustrating an example of a position relationship of an object to be imaged.

FIG. 29 is a diagram describing a relationship between the maximum and the minimum for the position in the depth direction.

FIG. 30 is a diagram for describing the position relationship and luminance of the object to be imaged.

FIG. 31 is a diagram for describing the position relationship and luminance of the object to be imaged.

FIG. 32 is another diagram for describing the position relationship and luminance of the object to be imaged.

FIG. 33 is a flowchart describing details of the parallax image encoding process.

FIG. 34 is another flowchart describing details of the parallax image encoding process.

FIG. 35 is a flowchart for describing a prediction image generation process.

FIG. 36 is a block diagram illustrating a configuration example of the slice decoding unit.

FIG. 37 is a block diagram illustrating a configuration example of the decoding unit.

FIG. 38 is a block diagram illustrating a configuration example of the correction unit.

FIG. 39 is a flowchart describing details of the parallax image decoding process.

FIG. 40 is a flowchart for describing the prediction image generation process.

FIG. 41 is a diagram illustrating a configuration example of an embodiment of a computer.

FIG. 42 is a diagram schematically illustrating a configuration example of a television apparatus to which the present technology is applied.

FIG. 43 is a diagram schematically illustrating a configuration example of a cellular phone to which the present technology is applied.

FIG. 44 is a diagram schematically illustrating a configuration example of a recording and reproducing apparatus to which the present technology is applied.

FIG. 45 is a diagram schematically illustrating a configuration example of an imaging apparatus to which the present technology is applied.

### DESCRIPTION OF EMBODIMENTS

### Embodiment

### Configuration Example of Embodiment of Encoding Apparatus

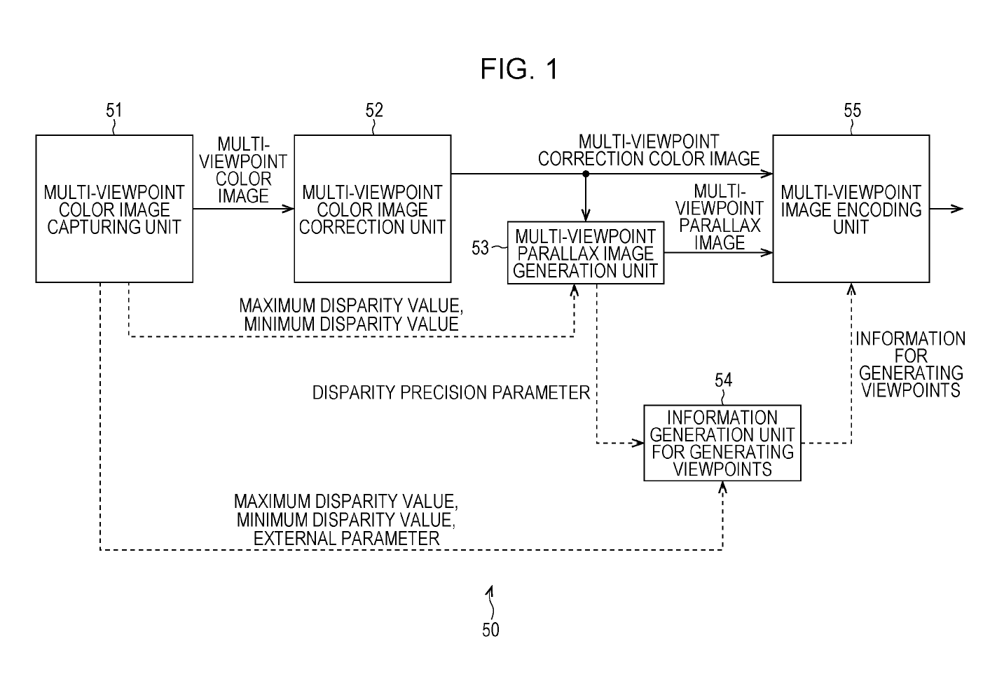

FIG. 1 is a block diagram illustrating a configuration example of an embodiment of an encoding apparatus to which the present technology is applied.

An encoding apparatus 50 of FIG. 1 is formed of a multi-viewpoint color image capturing unit 51, a multi-viewpoint color image correction unit 52, a multi-viewpoint parallax image correction unit 53, an information generation unit 54 for generating viewpoints, and a multi-viewpoint image encoding unit 55.

The encoding apparatus 50 encodes a parallax image with a predetermined viewpoint using information with regard to the parallax image.

Specifically, the multi-viewpoint color image capturing unit 51 of the encoding apparatus 50 images a multi-viewpoint color image and supplies the image to the multi-viewpoint color image correction unit 52 as a multi-viewpoint color image. In addition, the multi-viewpoint color image capturing unit 51 generates an external parameter, a maximum disparity value, and a minimum disparity value (the details will be described below). The multi-viewpoint color image capturing unit 51 supplies the external parameter, the maximum disparity value, and the minimum disparity value to the information generation unit 54 for generating viewpoints and supplies the maximum disparity value and the minimum disparity value to a multi-viewpoint parallax image generation unit 53.

Further, the external parameter is a parameter which defines a position of the multi-viewpoint color image capturing unit 51 in a horizontal direction. In addition, the maximum disparity value and the minimum disparity value are the maximum value and the minimum value of a disparity value on a world coordinate which can be acquired in a multi-viewpoint parallax image.

The multi-viewpoint color image correction unit 52 performs color correction, luminance correction, and distortion correction on the multi-viewpoint color image supplied from the multi-viewpoint color image capturing unit 51. In this way, a focal distance of the multi-viewpoint color image capturing unit 51 in the horizontal direction (X direction) in a corrected multi-viewpoint color image becomes common in all viewpoints. The multi-viewpoint color image correction unit 52 supplies the corrected multi-viewpoint color image to the multi-viewpoint parallax image generation unit 53 and the multi-viewpoint image encoding unit 55 as a multi-viewpoint correction color image.

The multi-viewpoint parallax image generation unit 53 generates a multi-viewpoint parallax image from the multi-viewpoint correction color image supplied from the multi-viewpoint color image correction unit 52 based on the maximum disparity value and the minimum disparity value supplied from the multi-viewpoint color image capturing unit 51. Specifically, the multi-viewpoint parallax image generation unit 53 acquires a disparity value of each pixel from the multi-viewpoint correction color image with regard to each viewpoint of the multi-viewpoints and normalizes the disparity values based on the maximum disparity value and the minimum disparity value. Further, the multi-viewpoint parallax image generation unit 53 generates a parallax image whose normalized disparity value of each pixel is a pixel value of each pixel of the parallax image, with regard to each viewpoint of the multi-viewpoints.

Further, the multi-viewpoint parallax image generation unit 53 supplies the generated multi-viewpoint parallax image to the multi-viewpoint image encoding unit 55 as a multi-viewpoint parallax image. In addition, the multi-viewpoint parallax image generation unit 53 generates a disparity precision parameter representing precision of a pixel value of a multi-viewpoint parallax image and supplies the parameter to the information generation unit 54 for generating viewpoints.

The information generation unit 54 for generating viewpoints generates information for generating viewpoints, which is used when a color image having a viewpoint other than multi-viewpoints is generated, using a correction color image and a parallax image having multi-viewpoints. Specifically, the information generation unit 54 for generating viewpoints acquires distance between cameras based on the external parameter supplied from the multi-viewpoint color image capturing unit 51. The distance between cameras is the distance between a position of the multi-viewpoint color image capturing unit 51 in the horizontal direction when a color image is imaged for every viewpoint of a multi-viewpoint parallax image and a position of the multi-viewpoint color image capturing unit 51 in the horizontal direction when a color image having the disparity corresponding to the color image and the parallax image is imaged.

The information for generating viewpoints of the information generation unit 54 for generating viewpoints is the maximum disparity value and the minimum disparity value from the multi-viewpoint color image capturing unit 51, the distance between cameras, and the disparity precision parameter from the multi-viewpoint parallax image generation unit 53. The information generation unit 54 for generating viewpoints supplies generated information for generating viewpoints to the multi-viewpoint image encoding unit 55.

The multi-viewpoint image encoding unit 55 encodes the multi-viewpoint correction color image supplied from the multi-viewpoint color image correction unit 52 with the HEVC method. In addition, the multi-viewpoint image encoding unit 55 encodes the multi-viewpoint parallax image supplied from the multi-viewpoint parallax image generation unit 53 in conformity with the HEVC method, using the maximum disparity value, the minimum disparity value, and the distance between cameras among the information for generating viewpoints supplied from the information generation unit 54 for generating viewpoints as the information with regard to the disparity.

Further, the multi-viewpoint image encoding unit 55 performs differential encoding on the maximum disparity value, the minimum disparity value, and the distance between cameras among the information for generating viewpoints supplied from the information generation unit 54 for generating viewpoints and allows them to be included in the information (encoding parameter) with regard to the encoding used when the multi-viewpoint parallax image is encoded. In addition, the multi-viewpoint image encoding unit 55 transmits the information with regard to the encoding including the encoded multi-viewpoint correction color image and multi-viewpoint parallax image, and the differential-encoded maximum disparity value, minimum disparity value, and distance between cameras and the bit stream made of the disparity precision parameter or the like from the information generation unit 54 for generating viewpoints, as an encoded bit stream.

As described above, since the multi-viewpoint image encoding unit 55 transmits the maximum disparity value, the minimum disparity value, and the distance between cameras by performing differential encoding on them, it is possible to reduce the code amount of the information for generating viewpoints. Since it is highly likely that the maximum disparity value, the minimum disparity value, and the distance between cameras are not largely changed between pictures in order to provide a comfortable 3D image, it is effective to perform differential encoding for reduction of the code amount.

In addition, in the encoding apparatus 50, the multi-viewpoint parallax image is generated from the multi-viewpoint correction color image, but the multi-viewpoint parallax image may be generated by a sensor which detects the disparity value at the time of imaging the multi-viewpoint color image.

### [Description of Information for Generating Viewpoints]

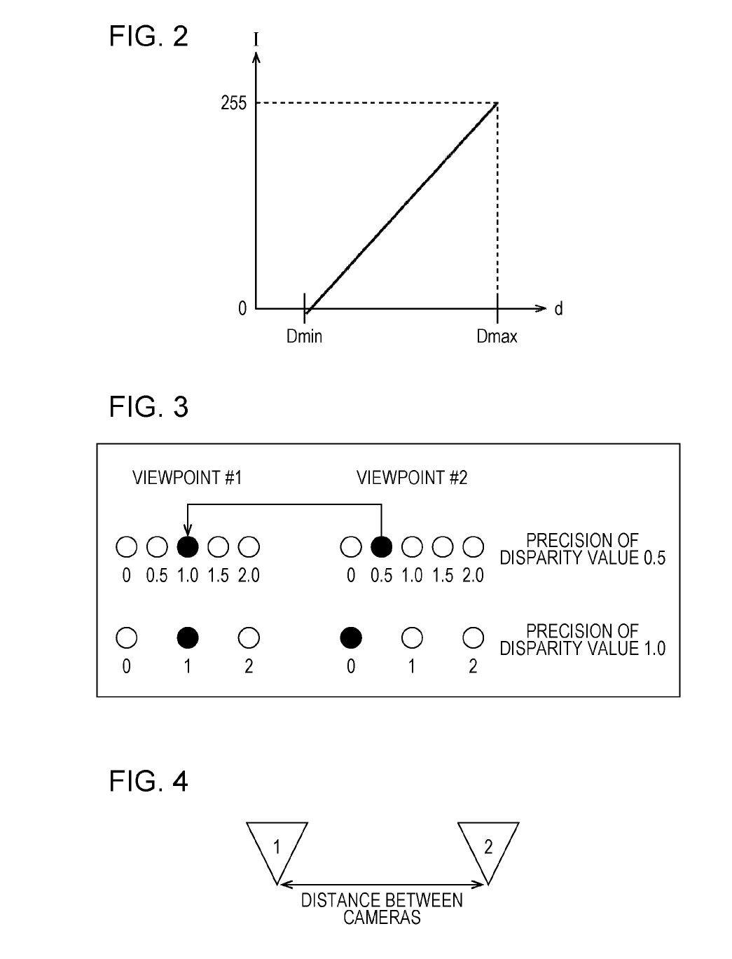

FIG. 2 is a diagram describing the maximum disparity value and the minimum disparity value of the information for generating viewpoints.

Further, in FIG. 2, the horizontal axis is a disparity value before normalization and the vertical axis is a pixel value of a parallax image.

As shown in FIG. 2, the multi-viewpoint parallax image generation unit 53 normalizes the disparity value of each pixel to, for example, a value of 0 to 255 using a minimum disparity value Dmin and a maximum disparity value Dmax. In addition, the multi-viewpoint parallax image generation unit 53 generates a parallax image with the disparity value of each pixel after the normalization, which is any of the value of 0 to 255, as a pixel value.

In other words, a pixel value I of each pixel of a parallax image is represented by the following formula (1) with the disparity value d before normalization of each pixel, the minimum disparity value Dmin, and the maximum disparity value Dmax.

$$\begin{matrix}[ Expression 1 ] & \\ I = \frac{255 * ( d - {D}_{min} )}{{D}_{max} - {D}_{min}} & ( 1 )\end{matrix}$$

Accordingly, in a decoding apparatus described below, it is necessary to restore the disparity value d before normalization using the minimum disparity value Dmin and the maximum disparity value Dmax from the pixel value I of each pixel of the parallax image with the following formula (2).

$$\begin{matrix}[ Expression 2 ] & \\ d = \frac{I}{255} ( {D}_{max} - {D}_{min} ) + {D}_{min} & ( 2 )\end{matrix}$$

Therefore, the minimum disparity value Dmin and the maximum disparity value Dmax are transmitted to the decoding apparatus.

FIG. 3 is a diagram describing the disparity precision parameter of the information for generating viewpoints.

As shown in the upper rows of FIG. 3, when the disparity value before normalization per the disparity value of 1 after normalization is 0.5, the disparity precision parameter represents the precision 0.5 of the disparity value. Further, as shown in the lower rows of FIG. 3, when the disparity value before normalization per the disparity value of 1 after normalization is 1, the disparity precision parameter represents the precision 1.0 of the disparity value.

In an example of FIG. 3, the disparity value before normalization of a viewpoint #1 as a first viewpoint is 1.0 and the disparity value before normalization of a viewpoint #2 as a second viewpoint is 0.5. Accordingly, the disparity value after normalization of the viewpoint #1 is 1.0 in either case of the precision of the disparity value being 0.5 or 1.0. In contrast, the disparity value of the viewpoint #2 is 0.5 when the precision of the disparity value is 0.5, and the disparity value of the viewpoint #2 is 0 when the precision of the disparity value is 1.0.

FIG. 4 is a diagram describing distance between cameras of the information for generating viewpoints.

As shown in FIG. 4, the distance between cameras of the parallax image with the viewpoint #2 as a reference of the viewpoint #1 is the distance between the position represented by the external parameter of the viewpoint #1 and the position represented by the external parameter of the viewpoint #2.

### [Configuration Example of Multi-Viewpoint Image Encoding Unit]

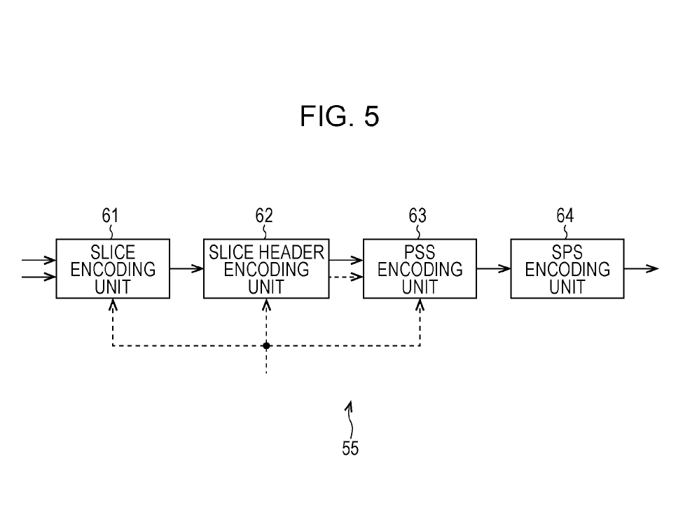

FIG. 5 is a block diagram illustrating the configuration example of the multi-viewpoint image encoding unit 55 of FIG. 1.

The multi-viewpoint image encoding unit 55 of FIG. 5 is formed of a slice encoding unit 61, a slice header encoding unit 62, a PPS encoding unit 63, and an SPS encoding unit 64.

The slice encoding unit 61 of the multi-viewpoint image encoding unit 55 performs encoding in a slice unit with the HEVC method with respect to the multi-viewpoint correction color image supplied from the multi-viewpoint color image correction unit 52. In addition, the slice encoding unit 61 performs encoding in a slice unit with a method in conformity with the HEVC method with respect to the multi-viewpoint parallax image from the multi-viewpoint parallax image generation unit 53 using the maximum disparity value, the minimum disparity value, and the distance between cameras among the information for generating viewpoints supplied from the information generation unit 54 for generating viewpoints of FIG. 1 as the information with regard to the disparity. The slice encoding unit 61 supplies the encoded data or the like in a slice unit obtained as a result of encoding to the slice header encoding unit 62.

The slice header encoding unit 62 maintains the maximum disparity value, the minimum disparity value, and the distance between cameras among the information for generating viewpoints supplied from the information generation unit 54 for generating viewpoints as the maximum disparity value, the minimum disparity value, and the distance between cameras of the slice to be processed currently.

In addition, the slice header encoding unit 62 determines whether the maximum disparity value, the minimum disparity value, and the distance between cameras of the slice to be processed currently match a maximum disparity value, a minimum disparity value, and a distance between cameras of the previous slice in the encoding order, respectively, of the unit to which the same PPS is added (hereinafter, referred to as “the same PPS unit”).

Further, when it is determined that the maximum disparity value, the minimum disparity value, and the distance between cameras of all slices constituting the same PPS unit match the maximum disparity value, the minimum disparity value, and the distance between cameras of the previous slice in the encoding order, the slice header encoding unit 62 adds information with regard to the encoding other than the maximum disparity value, the minimum disparity value, and the distance between cameras of each slice as the slice header of the encoded data of each slice constituting the same PPS unit, and supplies the information to the PPS encoding unit 63. In addition, the slice header encoding unit 62 supplies a transmission flag representing that the results of differential encoding of the maximum disparity value, the minimum disparity value, and the distance between cameras are not transmitted to the PPS encoding unit 63.

On the other hand, when it is determined that the maximum disparity value, the minimum disparity value, and the distance between cameras of at least one slice constituting the same PPS unit do not match the maximum disparity value, the minimum disparity value, and the distance between cameras of the previous slice in the encoding order, the slice header encoding unit 62 adds information with regard to the encoding including the maximum disparity value, the minimum disparity value, and the distance between cameras of the slice to the encoded data of an intra type slice as the slice header, and supplies the information to the PPS encoding unit 63.

Further, the slice header encoding unit 62 performs differential encoding on the maximum disparity value, the minimum disparity value, and the distance between cameras of a slice with regard to an inter type slice. Specifically, the slice header encoding unit 62 subtracts the maximum disparity value, the minimum disparity value, the distance between cameras of the previous slice in the encoding order from the maximum disparity value, the minimum disparity value, and the distance between cameras of the inter type slice, and sets the subtracted results as the results of differential encoding. Further, the slice header encoding unit 62 adds information with regard to the encoding including the results of differential encoding of the maximum disparity value, the minimum disparity value, and the distance between cameras to the encoded data of the inter type slice as the slice header and supplies the information to the PPS encoding unit 63.

In addition, in this case, the slice header encoding unit 62 supplies the transmission flag representing that the results of differential encoding of the maximum disparity value, the minimum disparity value, and the distance between cameras are transmitted, to the PPS encoding unit 63.

The PPS encoding unit 63 generates the PPS including the transmission flag supplied from the slice header encoding unit 62 and the disparity precision parameter among the information for generating viewpoints supplied from the information generation unit 54 for generating viewpoints of FIG. 1. The PPS encoding unit 63 adds the PPS to the encoded data in a slice unit to which the slice header supplied from the slice header encoding unit 62 is added in the same PPS unit and supplies the data to the SPS encoding unit 64.

The SPS encoding unit 64 generates SPS. In addition, the SPS encoding unit 64 adds the SPS to the encoded data to which the PPS supplied from the PPS encoding unit 63 is added in a sequence unit. The SPS encoding unit 64 functions as a transmission unit and transmits the bit stream obtained from the functionality as the encoded bit stream.

### [Configuration Example of Slice Encoding Unit]

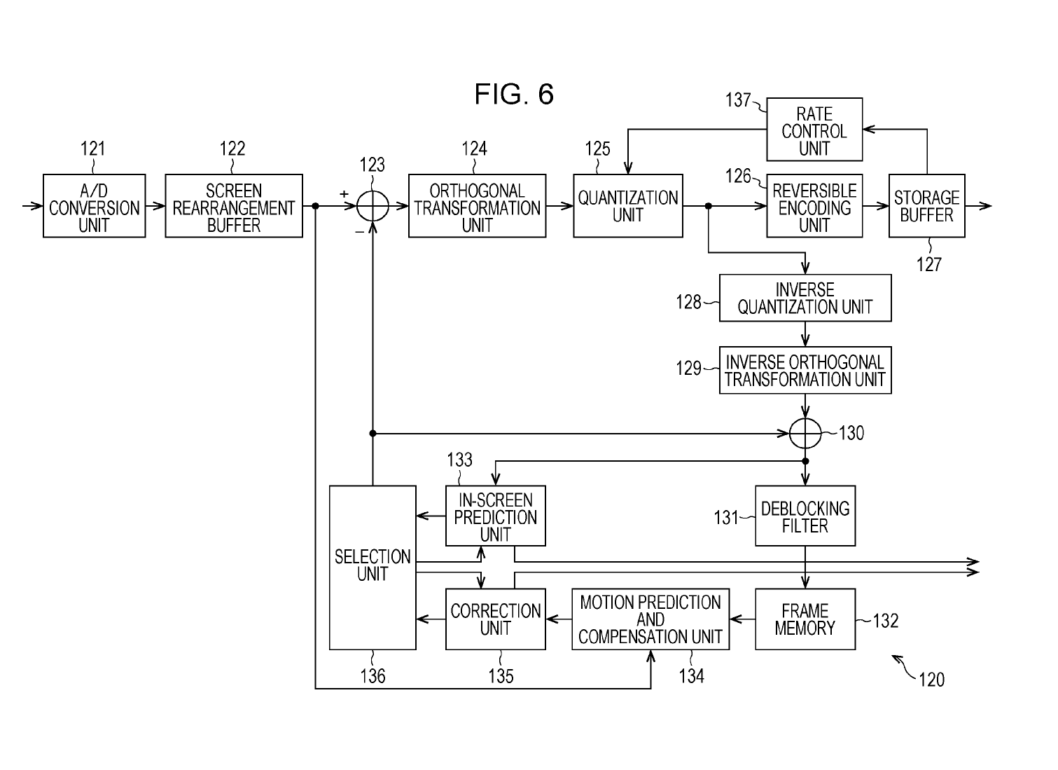

FIG. 6 is a block diagram illustrating the configuration example of an encoding unit encoding a parallax image having one optional viewpoint among the slice encoding unit 61 of FIG. 5. That is, the encoding unit which encodes a multi-viewpoint parallax image among the slice encoding unit 61 is formed of an encoding unit 120 to the number of viewpoints of FIG. 6.

The encoding unit 120 of FIG. 6 is formed of an A/D conversion unit 121, a screen rearrangement buffer 122, an arithmetic unit 123, an orthogonal transformation unit 124, a quantization unit 125, a reversible encoding unit 126, a storage buffer 127, an inverse quantization unit 128, an inverse orthogonal transformation unit 129, an addition unit 130, a deblocking filter 131, a frame memory 132, an in-screen prediction unit 133, a motion prediction and compensation unit 134, a correction unit 135, a selection unit 136, and a rate control unit 137.

The A/D conversion unit 121 of the encoding unit 120 performs A/D conversion on a multiplexed image in a frame unit having a predetermined viewpoint, which is supplied from the multi-viewpoint parallax image generation unit 53 of FIG. 1 and outputs the converted multiplexed image to the screen rearrangement buffer 122 to be stored. The screen rearrangement buffer 122 rearranges a parallax image with a frame unit in the stored display order to be in the order for encoding in accordance to a GOP (Group of Picture) structure, and outputs the parallax image to the arithmetic unit 123, the in-screen prediction unit 133, and the motion prediction and compensation unit 134.

The arithmetic unit 123 functions as an encoding unit and encodes a target parallax image to be encoded by performing an arithmetic operation on the difference between the prediction image supplied from the selection unit 136 and the target parallax image to be encoded, which is output from the screen rearrangement buffer 122. Specifically, the arithmetic unit 123 subtracts the prediction image supplied from the selection unit 136 from the target parallax image to be encoded, which is output from the screen rearrangement buffer 122. The arithmetic unit 123 outputs the image obtained from the subtraction to the orthogonal transformation unit 124 as residual information. In addition, when the prediction image is not supplied from the selection unit 136, the arithmetic unit 123 outputs the parallax image read from the screen rearrangement buffer 122 to the orthogonal transformation unit 124 as the residual information as is.

The orthogonal transformation unit 124 performs orthogonal transformation such as discrete cosine transformation or Karhunen-Loeve transformation on the residual information from the arithmetic unit 123 and supplies the coefficient obtained from the transformation to the quantization unit 125.

The quantization unit 125 quantizes the coefficient supplied from the orthogonal transformation unit 124. The quantized coefficient is input to the reversible encoding unit 126.

The reversible encoding unit 126 performs reversible encoding such as variable length coding (for example, CAVLC (Context-Adaptive Variable Length Coding) or the like) or arithmetic coding (for example, CABAC (Context-Adaptive Binary Arithmetic Coding) or the like) on the quantized coefficient supplied from the quantization unit 125. The reversible encoding unit 126 supplies the encoded data obtained from the reversible encoding to the storage buffer 127 and stores the encoded data in the storage buffer 127.

The storage buffer 127 temporarily stores the encoded data supplied from the reversible encoding unit 126 and supplies the encoded data to the slice header encoding unit 62 in a slice unit.

In addition, the quantized coefficient which is output from the quantization unit 125 is input to the inverse quantization unit 128 and is supplied to the inverse orthogonal transformation unit 129 after inverse quantization.

The inverse orthogonal transformation unit 129 performs inverse orthogonal transformation such as inverse discrete cosine transformation or inverse Karhunen-Loeve transformation on the coefficient supplied from the inverse quantization unit 128 and supplies the residual information obtained from the transformation to the addition unit 130.

The addition unit 130 obtains a locally decoded parallax image by adding the residual information as a decoding target parallax image supplied from the inverse orthogonal transformation unit 129 and the prediction image supplied from the selection unit 136. In addition, when the prediction image is not supplied from the selection unit 136, the addition unit 130 sets the residual information supplied from the inverse orthogonal transformation unit 129 to the locally decoded parallax image. The addition unit 130 supplies the locally decoded parallax image to the deblocking filter 131 and to the in-screen prediction unit 133 as a reference image.

The deblocking filter 131 removes block distortion by filtering the locally decoded parallax image supplied from the addition unit 130. The deblocking filter 131 supplies the parallax image obtained from the result to the frame memory 132 and stores the parallax image in the frame memory 132. The parallax image stored in the frame memory 132 is output to the motion prediction and compensation unit 134 as a reference image.

The in-screen prediction unit 133 performs in-screen prediction of all intra-prediction modes being candidates using the reference image supplied from the addition unit 130 and generates a prediction image.

In addition, the in-screen prediction unit 133 calculates a cost function value (details will be described below) with respect to all intra-prediction modes being candidates. Further, the in-screen prediction unit 133 determines the intra-prediction mode whose cost function value is the minimum to the optimum intra-prediction mode. The in-screen prediction unit 133 supplies the prediction image generated in the optimum intra-prediction mode and the corresponding cost function value to the selection unit 136. When the in-screen prediction unit 133 is informed of selection of the prediction image generated in the optimum intra-prediction mode by the selection unit 136, the in-screen prediction unit 133 supplies the in-screen prediction information indicating the optimum intra-prediction mode or the like to the slice header encoding unit 62 of FIG. 5. The in-screen prediction information is included in the slice header as the information related to encoding.

In addition, the cost function value is also referred to as RD (Rate Distortion) cost and is calculated based on either method of a High Complexity mode or a Low Complexity mode, determined by JM (Joint Model) which is reference software in, for example, the H. 264/AVC method.

Specifically, when the High Complexity mode is adopted as a calculation method of the cost function value, the cost function value represented by the following formula (3) is calculated for each prediction mode by temporarily performing reversible encoding on all prediction modes being candidates.

Cost(Mode)=D+λ·R (3)

D represents the difference (distortion) between the original image and the decoded image, R represents the generated encoding amount including even an coefficient of the orthogonal transformation, and λ represents a Lagrange multiplier given as a function of a quantization parameter QP.

On the other hand, when the Low Complexity mode is adopted as the calculation method of the cost function value, calculation of a header bit such as information or the like indicating generation of the decoded image and the prediction mode is performed on all prediction modes being candidates, and the cost function represented by the following formula (4) is calculated on each of the prediction modes.

Cost(Mode)=D+QPtoQuant(QP)·Header_Bit (4)

D is represents difference (distortion) between the original image and the decoded image, Header_Bit represents a header bit with respect to the prediction mode, and QPtoQuant represents a function given as a function of the quantized parameter QP.

In the Low Complexity mode, a decoded image may be generated with respect to all prediction modes and the calculation amount is small because it is not necessary for the reversible encoding to be performed. Further, here, the High Complexity mode is adopted as the calculation method of the cost function value.

The motion prediction and compensation unit 134 performs the motion prediction process of all inter-prediction modes being candidates based on the parallax image supplied from the screen rearrangement buffer 122 and the reference image supplied from the frame memory 132 and generates a motion vector. Specifically, the motion prediction and compensation unit 134 matches the reference image to the parallax image supplied from the screen rearrangement buffer 122 for each of the inter-prediction modes and generates a motion vector.

In addition, the inter-prediction mode is information representing the size of a target block of the inter-prediction, the prediction direction, and a reference index. The prediction direction includes forward prediction (L0 prediction) in which a reference image whose display time is earlier than the target parallax image of the inter-prediction is used, backward prediction (L1 prediction) in which a reference image whose display time is later than the target parallax image of the inter-prediction is used, and bidirectional prediction (Bi-prediction) in which a reference image whose display time is earlier than the target parallax image of the inter-prediction and a reference image whose display time is later than the target parallax image of the inter-prediction are used. Further, the reference index means a number for specifying a reference image. For example, as a reference index of an image is closer to the target parallax image of the inter-prediction, the number is small.

Moreover, the motion prediction and compensation unit 134 functions as a prediction image generation unit and performs a motion compensation process for each of the inter-prediction modes by reading a reference image from the frame memory 132 based on the generated motion vector. The motion prediction and compensation unit 134 supplies the prediction image generated from the process to the correction unit 135.

The correction unit 135 generates a correction coefficient, which is used to correct a prediction image, with the maximum disparity value, the minimum disparity value, and the distance between cameras among the information for generating viewpoints supplied from the information generation unit 54 for generating viewpoints of FIG. 1 as the information with regard to the parallax image. The correction unit 135 corrects the prediction image of each inter-prediction mode supplied from the motion prediction and compensation unit 134 using the correction coefficient.

Here, a position Z_{c} of a subject of a target parallax image to be encoded in the depth direction and a position Zₚ of a subject of a prediction image in the depth direction are represented by the following formula (5).

$$\begin{matrix}[ Expression 3 ] & \\ {Z}_{c} = \frac{{L}_{c} f}{{d}_{c}} \\ {Z}_{p} = \frac{{L}_{p} f}{{d}_{p}} & ( 5 )\end{matrix}$$

Further, in the formula (5), L_{c} and Lₚ each represent distance between cameras of the encoding target parallax image and distance between cameras of the prediction image. f represents focal distance common to the encoding target parallax image and prediction image. In addition, d_{c} and dₚ each represent an absolute value of the disparity value before normalization of the encoding target parallax image and an absolute value of the disparity value before normalization of the prediction image.

Further, a disparity value I_{c} of the encoding target parallax image and a disparity value Iₚ of the prediction image are represented by the following formula (6) using the absolute values d_{c} and dₚ of the disparity values before normalization.

$$\begin{matrix}[ Expression 4 ] & \\ {I}_{c} = \frac{255 * ( {d}_{c} - {D}_{min}^{c} )}{{D}_{max}^{c} - {D}_{min}^{c}} \\ {I}_{p} = \frac{255 * ( {d}_{p} - {D}_{min}^{p} )}{{D}_{max}^{p} - {D}_{min}^{p}} & ( 6 )\end{matrix}$$

Further, in formula (6), D^{c}ₘᵢₙ and D^{p}ₘᵢₙ each represent the minimum disparity value of the encoding target parallax image and the minimum disparity value of the prediction image. D^{c}ₘₐₓ and D^{p}ₘₐₓ each represent the maximum disparity value of the encoding target parallax image and the maximum disparity value of the prediction image.

Accordingly, even when the position Z_{c} of a subject of the encoding target parallax image in the depth direction is the same as the position Zₚ of a subject of the prediction image in the depth direction, if at least one of the distances between cameras L_{c} and Lₚ, the minimum disparity values D^{c}ₘᵢₙ and D^{p}ₘᵢₙ, and the maximum disparity values D^{c}ₘₐₓ and D^{p}ₘₐₓ is different from each other, the disparity value I_{c} is different from the disparity value Iₚ.

Here, the correction unit 135 generates a correction coefficient which corrects the prediction image such that the disparity value I_{c} and the disparity value Iₚ become the same when the position Z_{c} is the same as the position Zₚ.

Specifically, when the position Z_{c} is the same as the position Zₚ, the following formula (7) is established from the formula (5) above.

$$\begin{matrix}[ Expression 5 ] & \\ \frac{{L}_{c} f}{{d}_{c}} = \frac{{L}_{p} f}{{d}_{p}} & ( 7 )\end{matrix}$$

In addition, the following formula (8) is established when the formula (7) is transformed.

$$\begin{matrix}[ Expression 6 ] & \\ {d}_{c} = \frac{{L}_{c}}{{L}_{p}} {d}_{p} & ( 8 )\end{matrix}$$

In addition, the following formula (9) is established when the absolute values d_{c} and dₚ of the disparity values before normalization of the formula (8) are substituted by the disparity values I_{c} and Iₚ, using the formula (6) above.

$$\begin{matrix}[ Expression 7 ] & \\ \frac{{I}_{c} ( {D}_{max}^{c} - {D}_{min}^{c} )}{255} + {D}_{min}^{c} = \frac{{L}_{c}}{{L}_{p}} ( \frac{{I}_{p} ( {D}_{max}^{p} - {D}_{min}^{p} )}{255} + {D}_{min}^{p} ) & ( 9 )\end{matrix}$$

In this way, the disparity value I_{c} is represented by the following formula (10) using the disparity value Iₚ.

$$\begin{matrix}[ Expression 8 ] & \\ \begin{matrix}{I}_{c} = \frac{\frac{{L}_{c}}{{L}_{p}} ( {D}_{max}^{p} - {D}_{min}^{p} )}{{D}_{max}^{c} - {D}_{min}^{c}} {I}_{p} + 255 \frac{\frac{{L}_{c}}{{L}_{p}} {D}_{min}^{p} - {D}_{min}^{c}}{{D}_{max}^{c} - {D}_{min}^{c}} \\ = {aI}_{p} + b\end{matrix} & ( 10 )\end{matrix}$$

Accordingly, the correction unit 135 generates a and b of the formula (10) as the correction coefficients. Further, the correction unit 135 acquires the disparity value I_{c} in the formula (10) as the disparity value of the prediction image after correction using the correction coefficients a, b, and the disparity value Iₚ.

In addition, the correction unit 135 calculates the cost function value with respect to each of the inter-prediction modes using the corrected prediction image and determines the inter-prediction mode whose cost function value is the minimum as the optimum inter-prediction mode. Further, the correction unit 135 supplies the prediction image and the cost function value generated in the optimum inter-prediction mode to the selection unit 136.

Moreover, when the correction unit 135 is informed of selection of the prediction image generated in the optimum inter-prediction mode by the selection unit 136, the correction unit 135 outputs the motion information to the slice header encoding unit 62. The motion information is formed of the optimum inter-prediction mode, the prediction vector index, a motion vector residual which is a difference in which the motion vector represented by the prediction vector index is subtracted from the current motion vector, and the like. Further, the prediction vector index means information specifying one motion vector among the motion vectors being candidates used for generation of the prediction image of the decoded parallax image. The motion information is included in the slice header as the information related to encoding.

The selection unit 136 determines either of the optimum intra-prediction mode and the optimum inter-prediction mode as the optimum prediction mode based on the cost function value supplied from the in-screen prediction unit 133 and the correction unit 135. In addition, the selection unit 136 supplies the prediction image of the optimum prediction mode to the arithmetic unit 123 and the addition unit 130. Moreover, the selection unit 136 informs the in-screen prediction unit 133 or the correction unit 135 that the prediction image of the optimum prediction mode is selected.

The rate control unit 137 controls the rate of the quantizing operation of the quantization unit 125 such that overflow or underflow does not occur, based on the encoded data stored in the storage buffer 127.

### [Configuration Example of Encoded Bit Stream]

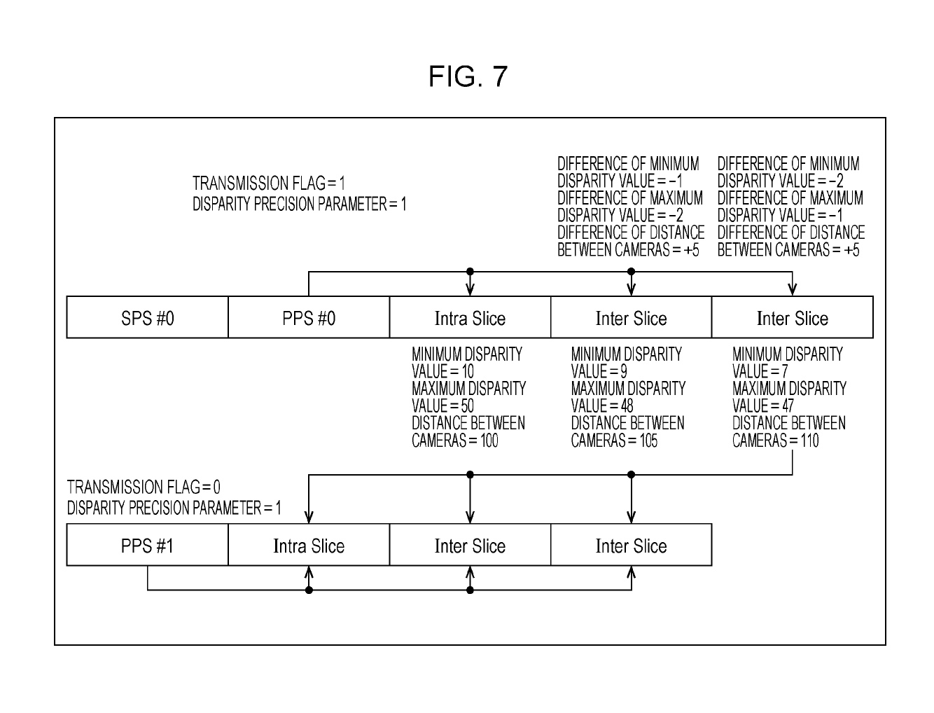

FIG. 7 is a diagram illustrating the configuration example of the encoded bit stream.

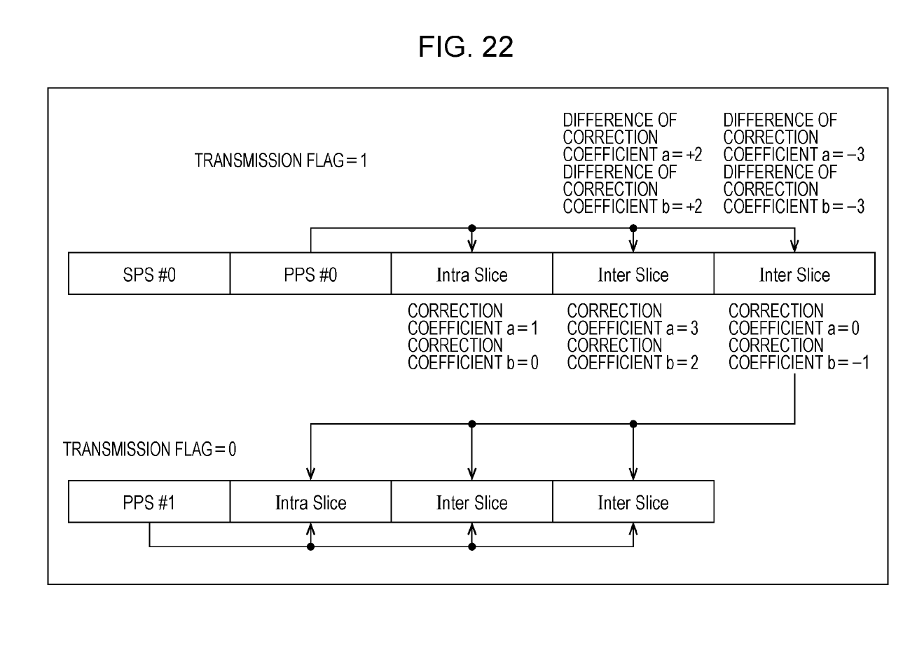

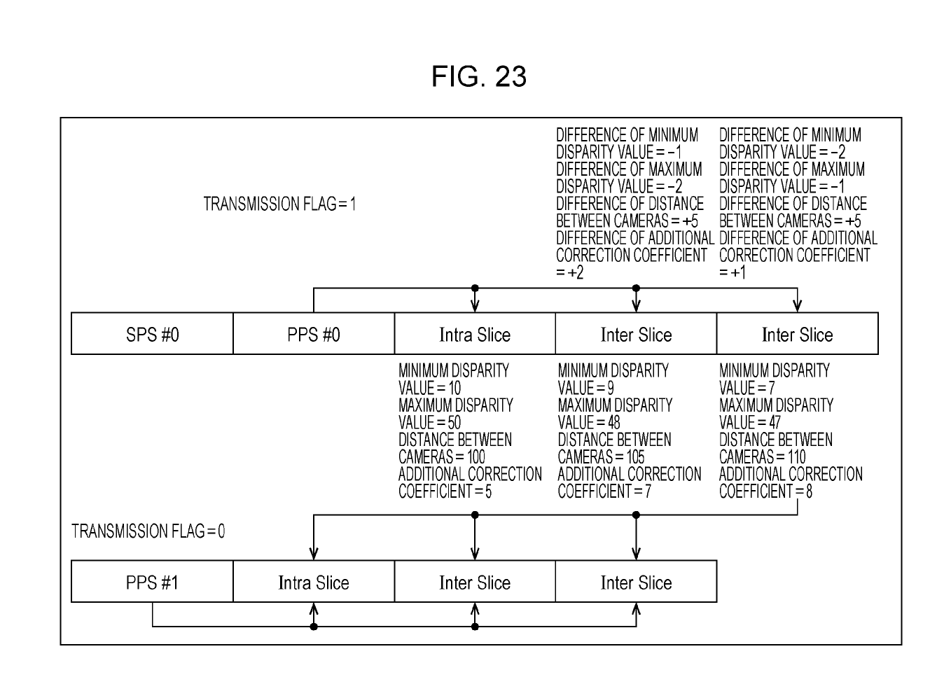

Further, FIG. 7 describes only the encoded data of the slice of the multi-viewpoint parallax image for convenience of explanation, but the encoded data of the slice of the multi-viewpoint color image is actually arranged in the encoded bit stream. This also applies to FIGS. 22 and 23 described below.

In the example of FIG. 7, the maximum disparity value, the minimum disparity value, and the distance between cameras of one intra-type slice and two intra-type slices constituting the same PPS unit of PPS#0 which is the 0-th PPS do not match the minimum disparity value, the minimum disparity value, and the distance between cameras of the previous slice in the encoding order. Accordingly, the transmission flag “1” representing that something has been transmitted is included in PPS#0. In addition, in the example of FIG. 7, the disparity precision of the slice constituting the same PPS unit of PPS#0 is 0.5 and “1” representing the disparity precision of 0.5 as the disparity precision parameter is included in PPS#0.

In addition, in the example of FIG. 7, the minimum disparity value, the maximum disparity value, and the distance between cameras of the intra-type slice constituting the same PPS unit of PPS#0 are 10, 50, and 100, respectively. Accordingly, the minimum disparity value of “10”, the maximum disparity value of “50”, and the distance between cameras of “100” are included in the slice header of the slice.

In addition, in the example of FIG. 7, the minimum disparity value, the maximum disparity value, and the distance between cameras of the first inter-type slice constituting the same PPS unit of PPS#0 are 9, 48, and 105, respectively. Accordingly, the difference “−1” in which the minimum disparity value of “10” of the previous inter-type slice in the encoding order is subtracted from the minimum disparity value of “9” of the slice is included in the slice header of the slice as the differential encoding result of the minimum disparity value. In the same way, the difference “−2” of the maximum disparity value is included as the differential encoding result of the maximum disparity value and the difference “5” of the distance between cameras is included as the differential encoding result of the distance between cameras.

In addition, in the example of FIG. 7, the minimum disparity value, the maximum disparity value, the distance between cameras of the second inter-type slice constituting the same PPS unit of PPS#0 are 7, 47, and 110, respectively. Accordingly, the difference “−2” in which the minimum disparity value of “9” of the previous first inter-type slice in the encoding order is subtracted from the minimum disparity value of “7” of the slice is included in the slice header of the slice as the differential encoding result of the minimum disparity value. In the same way, the difference “−1” of the maximum disparity value is included as the differential encoding result of the maximum disparity value and the difference “5” of the distance between cameras is included as the differential encoding result of the distance between cameras.

In addition, in the example of FIG. 7, the maximum disparity value, the minimum disparity value, and the distance between cameras of one intra-type slice and two inter-type slices constituting the same PPS unit of PPS#1 which is the first PPS match the maximum disparity value, the minimum disparity value, and the distance between cameras of the previous slice in the encoding order, respectively. That is, the minimum disparity value, the maximum disparity value, and the distance between cameras of one intra-type slice and two inter-type slices constituting the same PPS unit of PPS#1 are respectively “7”, “47”, and “110” which are the same as the second inter-type slice constituting the same PPS unit of PPS#0. Accordingly, the transmission flag “0” representing that nothing has been transmitted is included in PPS#1. Further, in the example of FIG. 7, the disparity precision of the slice constituting the same PPS unit of PPS#1 is 0.5 and “1” representing the disparity precision of 0.5 is included in PPS#1 as the disparity precision parameter.

### [Example of PPS Syntax]

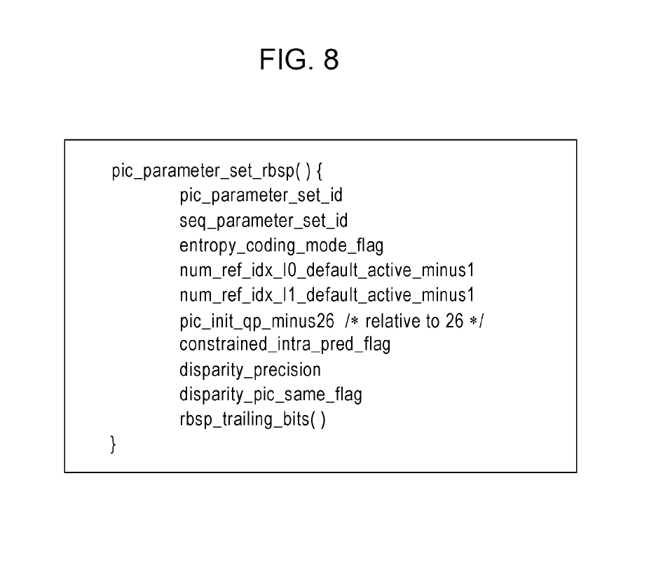

FIG. 8 is a diagram illustrating an example of PPS syntax of FIG. 7.

As shown in FIG. 8, the disparity precision parameter (disparity_precision) and the transmission flag (disparity_pic_same_flag) are included in PPS. The disparity precision parameter is “0” when the disparity precision “1” is indicated, and the disparity precision parameter is “2” when the disparity precision “0.25” is indicated. In addition, as described above, the disparity precision parameter is “1” when the disparity precision “0.5” is indicated. Further, the transmission flag is “1” when the transmission flag represents that something has been transmitted and the transmission flag is “0” when the transmission flag represents that nothing has been transmitted, as described above.

### [Example of Syntax of Slice Header]

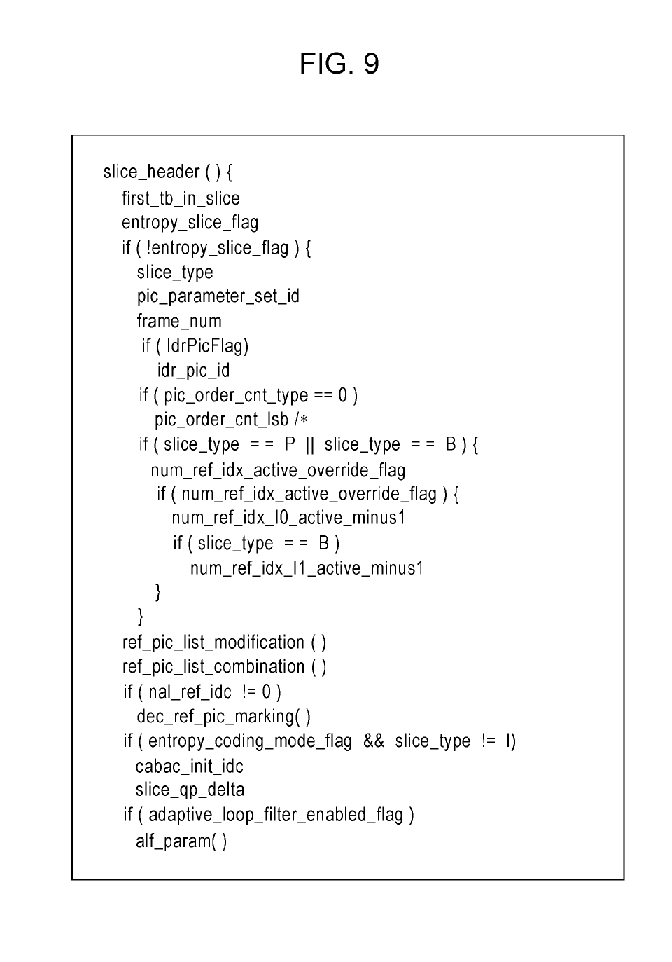

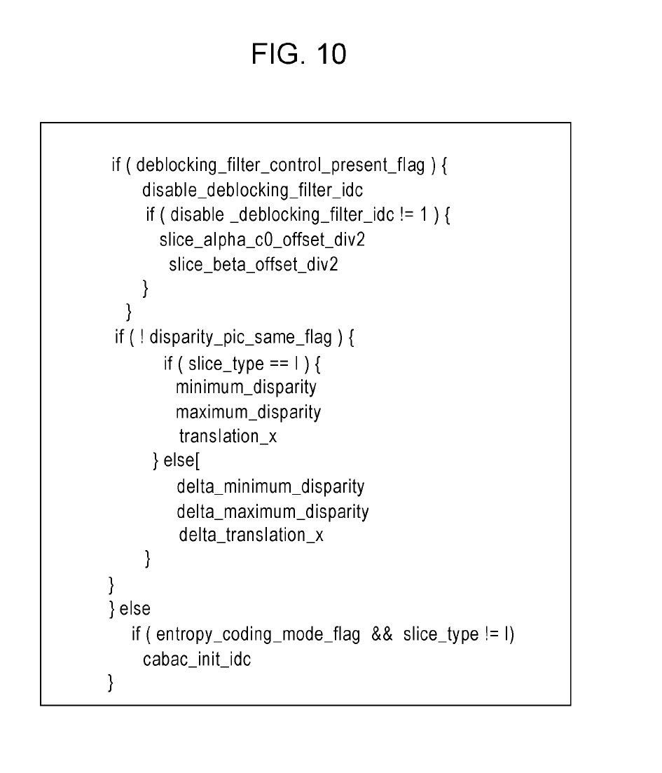

FIGS. 9 and 10 are diagrams illustrating an example of syntax of the slice header.

As shown in FIG. 10, when the transmission flag is 1 and the slice type is the intra type, the minimum disparity value (minimum_disparity), the maximum disparity value (maximum_disparity), and the distance between cameras (translation_x) are included in the slice header.

On the other hand, when the transmission flag is 1 and the slice type is the inter type, the differential encoding result of the minimum disparity value (delta_minimum_disparity), the differential encoding result of the maximum disparity value (delta_maximum_disparity), and the differential encoding result of the distance between cameras (delta_translation_x) are included in the slice header.

### [Description of Process Done by Encoding Apparatus]

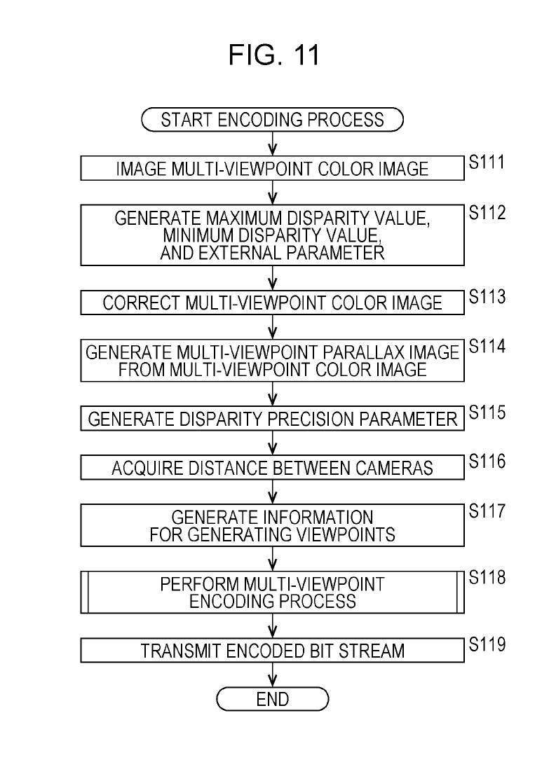

FIG. 11 is a flowchart describing the encoding process of the encoding apparatus 50 of FIG. 1.

In Step S111 of FIG. 11, the multi-viewpoint color image capturing unit 51 of the encoding apparatus 50 images the multi-viewpoint color image and supplies the image to the multi-viewpoint color image correction unit 52 as the multi-viewpoint color image.

In Step S112, the multi-viewpoint color image capturing unit 51 generates the maximum disparity value, the minimum disparity value, and the external parameter. The multi-viewpoint color image capturing unit 51 supplies the maximum disparity value, the minimum disparity value, and the external parameter to the information generation unit 54 for generating viewpoints and supplies the maximum disparity value and the minimum disparity value to the multi-viewpoint parallax image generation unit 53.

In Step S113, the multi-viewpoint color image correction unit 52 performs color correction, luminance correction, distortion correction, and the like on the multi-viewpoint color image supplied from the multi-viewpoint color image capturing unit 51. In this way, the focal distance of the multi-viewpoint color image capturing unit 51 in the corrected multi-viewpoint color image in the horizontal direction (X direction) becomes common in all viewpoints. The multi-viewpoint color image correction unit 52 supplies the corrected multi-viewpoint color image to the multi-viewpoint parallax image generation unit 53 and the multi-viewpoint image encoding unit 55 as the multi-viewpoint correction color image.

In Step S114, the multi-viewpoint parallax image generation unit 53 generates a multi-viewpoint parallax image from the multi-viewpoint correction color image supplied from the multi-viewpoint color image correction unit 52 based on the maximum disparity value and the minimum disparity value supplied from the multi-viewpoint color image capturing unit 51. Further, the multi-viewpoint parallax image generation unit 53 supplies the generated multi-viewpoint parallax image to the multi-viewpoint image encoding unit 55 as the multi-viewpoint parallax image.

In Step S115, the multi-viewpoint parallax image generation unit 53 generates a disparity precision parameter and supplies the parameter to the information generation unit 54 for generating viewpoints.

In Step S116, the information generation unit 54 for generating viewpoints acquires the distance between cameras based on the external parameter supplied from the multi-viewpoint color image capturing unit 51.

In Step S117, the information generation unit 54 for generating viewpoints generates the maximum disparity value, the minimum disparity value, and the distance between cameras from the multi-viewpoint color image capturing unit 51 and the disparity precision parameter from the multi-viewpoint parallax image generation unit 53 as the information for generating viewpoints. The information generation unit 54 for generating viewpoints supplies the generated information for generating viewpoints to the multi-viewpoint image encoding unit 55.

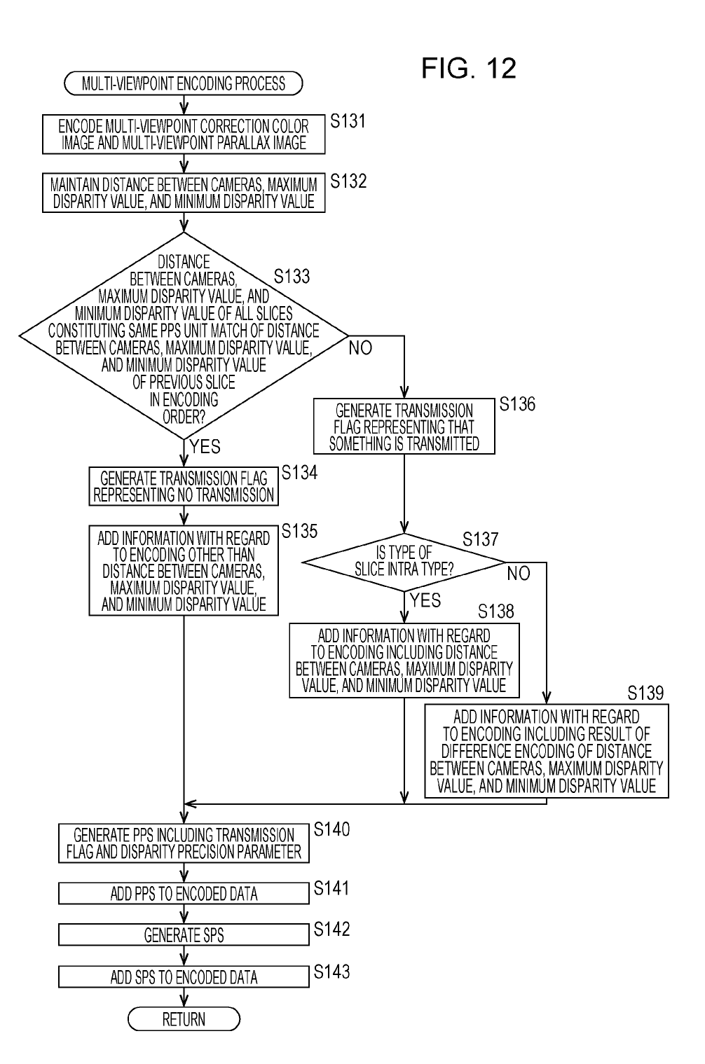

In Step S118, the multi-viewpoint image encoding unit 55 performs the multi-viewpoint encoding process which encodes the multi-viewpoint correction color image from the multi-viewpoint color image correction unit 52 and the multi-viewpoint parallax image from the multi-viewpoint parallax image generation unit 53. The details of the multi-viewpoint encoding process will be described with reference to FIG. 12 below.

In Step S119, the multi-viewpoint image encoding unit 55 transmits the encoded bit stream obtained from the multi-viewpoint encoding process and ends the process.

FIG. 12 is a flowchart describing the multi-viewpoint encoding process in Step S118 of FIG. 11.

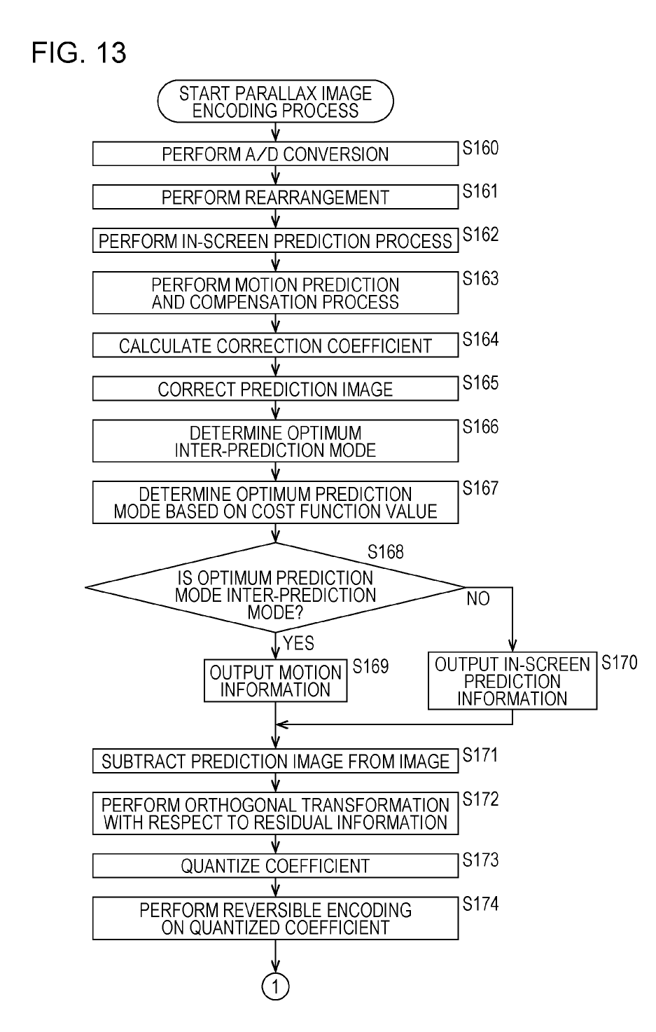

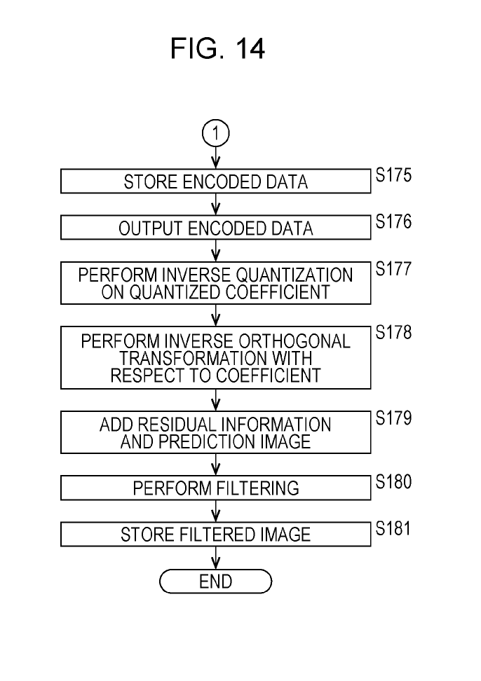

In Step S131 of FIG. 12, the slice encoding unit 61 of the multi-viewpoint image encoding unit 55 (FIG. 5) encodes the multi-viewpoint correction color image from the multi-viewpoint color image correction unit 52 and the multi-viewpoint parallax image from the multi-viewpoint parallax image generation unit 53 in a slice unit. Specifically, the slice encoding unit 61 performs a color image encoding process which encodes the multi-viewpoint correction color image in a slice unit using the HEVC method. In addition, the slice encoding unit 61 performs the parallax image encoding process which encodes the multi-viewpoint parallax image in a slice unit in conformity with the HEVC method, using the maximum disparity value, the minimum disparity value, and the distance between cameras among the information for generating viewpoints supplied from the information generation unit 54 for generating viewpoints of FIG. 1. The details of the parallax image encoding process will be described with reference to FIGS. 13 and 14 below. The slice encoding unit 61 supplies the encoded data in a slice unit obtained from the result of encoding to the slice header encoding unit 62.

In Step S132, the slice header encoding unit 62 sets the distance between cameras, the maximum disparity value, and the minimum disparity value among the information for generating viewpoints supplied from the information generation unit 54 for generating viewpoints to the distance between cameras, the maximum disparity value, and the minimum disparity value of the current target slice to be processed and maintains them.

In Step S133, the slice header encoding unit 62 determines whether the distance between cameras, the maximum disparity value, and the minimum disparity value of all slices constituting the same PPS unit respectively match the distance between cameras, the maximum disparity value, and the minimum disparity value of the previous slice in the encoding order.

When it is determined that the distance between cameras, the maximum disparity value, and the minimum disparity value match each other in Step S133, the slice header encoding unit 62 generates the transmission flag representing that the differential encoding results of the distance between cameras, the maximum disparity value, and the minimum disparity value are not transmitted and supplies the transmission flag to the PPS encoding unit 63 in Step S134.

In Step S135, the slice header encoding unit 62 adds the information related to encoding other than the distance between cameras, the maximum disparity value, and the minimum disparity value of each slice to the encoded data of each slice constituting the same PPS unit as a target to be processed in Step S133, as the slice header. In addition, the in-screen prediction information or the motion information supplied from the slice encoding unit 61 are included in the information related to encoding. Further, the slice header encoding unit 62 supplies the encoded data of each slice constituting the same PPS unit obtained from the result to the PPS encoding unit 63 and advances the process to Step S140.

On the other hand, when it is determined that the distance between cameras, the maximum disparity value, and the minimum disparity value do not match each other in Step S133, the slice header encoding unit 62 supplies the transmission flag representing that the differential encoding results of the distance between cameras, the maximum disparity value, the minimum disparity value are transmitted to the PPS encoding unit 63 in Step S136. In addition, the processes of Steps S137 to S139 described below are performed for each slice constituting the same PPS unit as a target to be processed in Step S133.

In Step S137, the slice header encoding unit 62 determines whether the type of the slice constituting the same PPS unit as a target to be processed in Step S133 is the intra type. When it is determined that the type of the slice is the intra type in Step S137, the slice header encoding unit 62 adds the information related to encoding including the distance between cameras, the maximum disparity value, and the minimum disparity value of the slice to the encoded data of the slice as the slice header in Step S138. Further, the in-screen prediction information or the motion information supplied from the slice encoding unit 61 is included in the information related to encoding. Furthermore, the slice header encoding unit 62 supplies the encoded data in a slice unit obtained from the result to the PPS encoding unit 63 and advances the process to Step S140.

On the other hand, when it is determined that the slice type is not the intra type in Step S137, that is, the slice type is the inter type, the process proceeds to Step S139. In Step S139, the slice header encoding unit 62 performs differential encoding on the distance between cameras, the maximum disparity value, and the minimum disparity value of the slice and adds the information related to encoding including the differential encoding results to the encoded data of the slice as the slice header. Further, the in-screen prediction information or the motion information supplied from the slice encoding unit 61 is included in the information related to encoding. Furthermore, the slice header encoding unit 62 supplies the encoded data in a slice unit obtained from the result to the PPS encoding unit 63 and advances the process to Step S140.

In Step S140, the PPS encoding unit 63 generates the PPS including the transmission flag supplied from the slice header encoding unit 62 and the disparity precision parameter among the information for generating viewpoints supplied from the information generation unit 54 for generating viewpoints of FIG. 1.

In Step S141, the PPS encoding unit 63 adds the PPS to the encoded data in a slice unit to which the slice header supplied from the slice header encoding unit 62 is added in the same PPS unit and supplies the encoded data to the SPS encoding unit 64.

In Step S142, the SPS encoding unit 64 generates SPS.

In Step S143, the SPS encoding unit 64 adds the SPS to the encoded data to which the PPS supplied from the PPS encoding unit 63 is added in a sequence unit and generates the encoded bit stream. In addition, the process returns to Step S118 of FIG. 11 and proceeds to Step S119.

FIGS. 13 and 14 are flowcharts describing the details of the parallax image encoding process of the slice encoding unit 61 of FIG. 5. The parallax image encoding process is performed for each viewpoint.

In Step S160 of FIG. 13, the A/D conversion unit 121 of the encoding unit 120 performs A/D conversion on the parallax image in a frame unit having a predetermined viewpoint which is input from the multi-viewpoint parallax image generation unit 53 and outputs the converted parallax image to the screen rearrangement buffer 122 to be stored.

In Step S161, the screen rearrangement buffer 122 rearranges the parallax image of the frame in the stored display order to be in the order for encoding in accordance to the GOP structure. The screen rearrangement buffer 122 supplies the parallax image in the frame unit after rearrangement to the arithmetic unit 123, the in-screen prediction unit 133, and the motion prediction and compensation unit 134.

In Step S162, the in-screen prediction unit 133 performs the in-screen prediction process of all intra-prediction modes being candidates using the reference image supplied from the addition unit 130. At this time, the in-screen prediction unit 133 calculates the cost function value with respect to all intra-prediction modes being candidates. In addition, the in-screen prediction unit 133 determines the intra-prediction mode whose cost function value is the minimum as the optimum intra-prediction mode. The in-screen prediction unit 133 supplies the prediction image generated in the optimum intra-prediction mode and the corresponding cost function value to the selection unit 136.

In Step S163, the motion prediction and compensation unit 134 performs the motion prediction and compensation process based on the parallax image supplied from the screen rearrangement buffer 122 and the reference image supplied from the frame memory 132.

Specifically, the motion prediction and compensation unit 134 performs the motion prediction process of all inter-prediction modes being candidates based on the parallax image supplied from the screen rearrangement buffer 122 and the reference image supplied from the frame memory 132 and generates a motion vector. In addition, the motion prediction and compensation unit 134 performs the motion compensation process for each of the inter-prediction modes by reading the reference image from the frame memory 132 based on the generated motion vector. The motion prediction and compensation unit 134 supplies the prediction image generated from the result to the correction unit 135.

In Step S164, the correction unit 135 calculates the correction coefficient based on the maximum disparity value, the minimum disparity value, and the distance between cameras among the information for generating viewpoints supplied from the information generation unit 54 for generating viewpoints of FIG. 1.

In Step S165, the correction unit 135 corrects the prediction image of each of the inter-prediction modes supplied from the motion prediction and compensation unit 134 using the correction coefficient.

In Step S166, the correction unit 135 calculates the cost function value with respect to each of the inter-prediction modes using the corrected prediction image and determines the inter-prediction mode whose cost function value is the minimum as the optimum inter-prediction mode. In addition, the correction unit 135 supplies the prediction image and the cost function value generated in the optimum inter-prediction mode to the selection unit 136.

In Step S167, the selection unit 136 determines the mode whose cost function value is the minimum between the optimum intra-prediction mode and the optimum inter-prediction mode as the optimum prediction mode based on the cost function value supplied from the in-screen prediction unit 133 and the correction unit 135. In addition, the selection unit 136 supplies the prediction image of the optimum prediction mode to the arithmetic unit 123 and the addition unit 130.

In Step S168, the selection unit 136 determines whether the optimum prediction mode is the optimum inter-prediction mode. When it is determined that the optimum prediction mode is the optimum inter-prediction mode in Step S168, the selection unit 136 informs the correction unit 135 of the selection of the prediction image generated in the optimum inter-prediction mode.

In addition, in Step S169, the correction unit 135 outputs the motion information to the slice header encoding unit 62 (FIG. 5) and advances the process to Step S171.

On the other hand, when it is determined that the optimum prediction mode is not the optimum inter-prediction mode in Step S168, that is, the optimum prediction mode is the optimum intra-prediction mode, the selection unit 136 informs the in-screen prediction unit 133 of the selection of the prediction image generated in the optimum intra-prediction mode.

Moreover, in Step S170, the in-screen prediction unit 133 outputs the in-screen prediction information to the slice header encoding unit 62 and advances the process to Step S171.

In Step S171, the arithmetic unit 123 subtracts the prediction image supplied from the selection unit 136 from the parallax image supplied from the screen rearrangement buffer 122. The arithmetic unit 123 outputs the image obtained from the subtraction to the orthogonal transformation unit 124 as the residual information.

In Step S172, the orthogonal transformation unit 124 performs the orthogonal transformation on the residual information from the arithmetic unit 123 and supplies the coefficient obtained from the result to the quantization unit 125.

In Step S173, the quantization unit 125 quantizes the coefficient supplied from the orthogonal transformation unit 124. The quantized coefficient is input to the reversible encoding unit 126 and the inverse quantization unit 128.

In Step S174, the reversible encoding unit 126 performs reversible encoding on the quantized coefficient supplied from the quantization unit 125.

In Step S175 of FIG. 14, the reversible encoding unit 126 supplies the encoded data obtained from the reversible encoding process to the storage buffer 127 to be stored.

In Step S176, the storage buffer 127 outputs the stored encoded data to the slice header encoding unit 62.

In Step S177, the inverse quantization unit 128 performs inverse quantization on the quantized coefficient supplied from the quantization unit 125.

In Step S178, the inverse orthogonal transformation unit 129 performs the inverse orthogonal transformation on the coefficient supplied from the inverse quantization unit 128 and supplies the residual information obtained from the result to the addition unit 130.

In Step S179, the addition unit 130 adds the residual information supplied from the inverse orthogonal transformation unit 129 and the prediction image supplied from the selection unit 136 and obtains a locally decoded parallax image. The addition unit 130 supplies the obtained parallax image to the deblocking filter 131 and to the in-screen prediction unit 133 as a reference image.

In Step S180, the deblocking filter 131 removes the block distortion by performing filtering on the locally decoded parallax image supplied from the addition unit 130.

In Step S181, the deblocking filter 131 supplies the filtered parallax image to the frame memory 132 to be stored. The parallax image stored in the frame memory 132 is output to the motion prediction and compensation unit 134 as a reference image. Subsequently, the process ends.

In addition, the processes in Steps S162 to S181 of FIGS. 13 and 14 are performed in a unit of a coding unit, for example. In addition, in the parallax image encoding process of FIGS. 13 and 14, the in-screen prediction process and the motion compensation process are constantly performed, for convenience of explanation, but only one of the processes is actually performed according to the picture type or the like in some cases.

As described above, the encoding apparatus 50 corrects the prediction image using the information related to the parallax image and encodes the parallax image using the corrected prediction image. More specifically, the encoding apparatus 50 corrects the prediction image such that the disparity values are the same when the positions of subjects in the depth direction are the same between the prediction image and the parallax image using the distance between cameras, the maximum disparity value, and the minimum disparity value as the information related to the parallax image and encodes the parallax image using the corrected prediction image. Accordingly, the difference between the prediction image and the parallax image generated by the information related to the parallax image is reduced and the encoding efficiency is improved. Particularly, when the information related to the parallax image is changed for each picture, the encoding efficiency is improved.

Further, the encoding apparatus 50 transmits not the correction coefficient itself but the distance between cameras, the maximum disparity value, and the minimum disparity value used to calculate the correction coefficient as the information used to correct the prediction image. Here, the distance between cameras, the maximum disparity value, and the minimum disparity value are parts of the information for generating viewpoints. Accordingly, the distance between cameras, the maximum disparity value, and the minimum disparity value can be shared as the information used to correct the prediction image and parts of the information for generating viewpoints. As a result, the information amount of the encoded bit stream can be reduced.

### [Configuration Example of Embodiment of Decoding Apparatus]

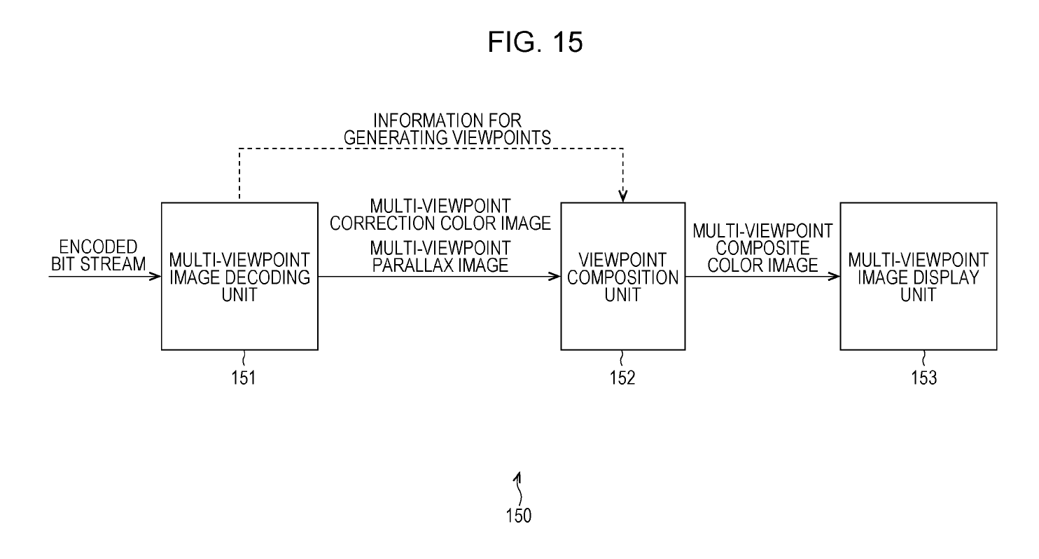

FIG. 15 is a block diagram illustrating the configuration example of an embodiment of a decoding apparatus, to which the present technology is applied and which decodes the encoded bit stream transmitted from the encoding apparatus 50 of FIG. 1.

A decoding apparatus 150 of FIG. 15 is formed of a multi-viewpoint image decoding unit 151, a viewpoint composition unit 152, and a multi-viewpoint image display unit 153. The decoding apparatus 150 decodes the encoded bit stream transmitted from the encoding apparatus 50 and generates a color image of the display viewpoint to be displayed using the multi-viewpoint color image, the multi-viewpoint parallax image, and the information for generating viewpoints obtained from the result.

Specifically, the multi-viewpoint image decoding unit 151 of the decoding apparatus 150 receives the encoded bit stream transmitted from the encoding apparatus 50 of FIG. 1. The multi-viewpoint image decoding unit 151 extracts the disparity precision parameter and the transmission flag from the PPS included in the received encoded bit stream. In addition, the multi-viewpoint image decoding unit 151 extracts the distance between cameras, the maximum disparity value, and the minimum disparity value from the slice header of the encoded bit stream in accordance to the transmission flag. The multi-viewpoint image decoding unit 151 generates information for generating viewpoints including the disparity precision parameter, the distance between cameras, the maximum disparity value, and the minimum disparity value and supplies the information to the viewpoint composition unit 152.

Further, the multi-viewpoint image decoding unit 151 decodes the encoded data of the multi-viewpoint correction color image in a slice unit included in the encoded bit stream with a method corresponding to the encoding method of the multi-viewpoint image encoding unit 55 of FIG. 1 and generates a multi-viewpoint correction color image. In addition, the multi-viewpoint image decoding unit 151 functions as a decoding unit. The multi-viewpoint image decoding unit 151 decodes the encoded data of the multi-viewpoint parallax image included in the encoded bit stream using the distance between cameras, the maximum disparity value, and the minimum disparity value, with a method corresponding to the encoding method of the multi-viewpoint image encoding unit 55 and generates a multi-viewpoint parallax image. The multi-viewpoint image decoding unit 151 supplies the generated multi-viewpoint correction color image and the multi-viewpoint parallax image to the viewpoint composition unit 152.

The viewpoint composition unit 152 performs a process of warping a display viewpoint with the number of viewpoints corresponding to the multi-viewpoint image display unit 153 on the multi-viewpoint parallax image from the multi-viewpoint image decoding unit 151 using the information for generating viewpoints from the multi-viewpoint image decoding unit 151. Specifically, the viewpoint composition unit 152 performs the process of warping the display viewpoint on the multi-viewpoint parallax image with precision corresponding to the disparity precision parameter based on the distance between cameras, the maximum disparity value, and the minimum disparity value included in the information for generating viewpoints. Further, the warping process is a process of geometric transformation from an image with a certain viewpoint to an image with a different viewpoint. Furthermore, a viewpoint other than the viewpoint corresponding to the multi-viewpoint color image is included in the display viewpoint.

In addition, the viewpoint composition unit 152 performs the process of warping the display viewpoint on the multi-viewpoint correction color image supplied from the multi-viewpoint image decoding unit 151, using the parallax image with the display viewpoint obtained from the warping process. The viewpoint composition unit 152 supplies the color image with the display viewpoint obtained from the result to the multi-viewpoint image display unit 153 as a multi-viewpoint composite color image.

The multi-viewpoint image display unit 153 displays the multi-viewpoint composite color image supplied from the viewpoint composition unit 152 such that the visible angles are different from each other for each viewpoint. A viewer can see a 3D image from plural viewpoints without wearing glasses by seeing each image having two optional viewpoints with respective right and left eyes.

As described above, since the viewpoint composition unit 152 performs the process of warping the display viewpoint on the multi-viewpoint parallax image with the precision corresponding to a viewpoint precision parameter based on the disparity precision parameter, it is not necessary for the viewpoint composition unit 152 to perform the warping process with high precision uselessly.

Moreover, since the viewpoint composition unit 152 performs the process of warping the display viewpoint on the multi-viewpoint parallax image based on the distance between cameras, it is possible to correct the disparity value to a value corresponding to a disparity within an appropriate range based on the distance between cameras when the disparity corresponding to the disparity value of the multi-viewpoint parallax image after the warping process is not within an appropriate range.

### [Configuration Example of Multi-Viewpoint Image Decoding Unit]

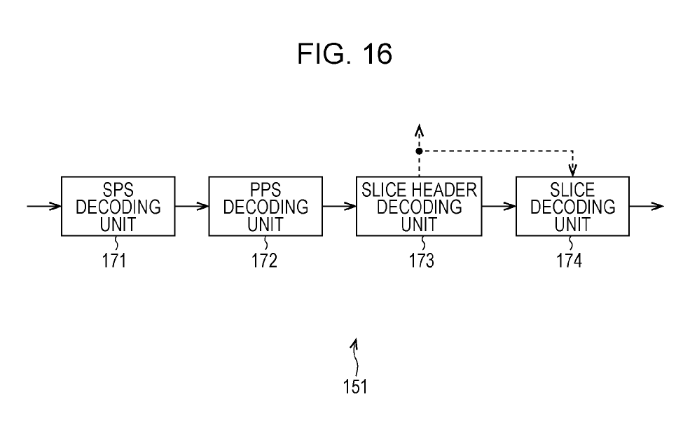

FIG. 16 is a block diagram illustrating the configuration example of the multi-viewpoint image decoding unit 151 of FIG. 15.

The multi-viewpoint image decoding unit 151 of FIG. 16 is formed of an SPS decoding unit 171, a PPS decoding unit 172, a slice header decoding unit 173, and a slice decoding unit 174.

The SPS decoding unit 171 of the multi-viewpoint image decoding unit 151 functions as a receiving unit, receives the encoded bit stream transmitted from the encoding apparatus 50 of FIG. 1, and extracts SPS among the encoded bit stream. The SPS decoding unit 171 supplies the extracted SPS and the encoded bit stream other than the SPS to the PPS decoding unit 172.

The PPS decoding unit 172 extracts the PPS from the encoded bit stream other than the SPS supplied from the SPS decoding unit 171. The PPS decoding unit 172 supplies the extracted PPS, the SPS, and the encoded bit stream other than the SPS and the PPS to the slice header decoding unit 173.

The slice header decoding unit 173 extracts the slice header from the encoded bit stream other than the SPS and PPS supplied from the PPS decoding unit 172. When the transmission flag included in the PPS from the PPS decoding unit 172 is “1” which represents that something has been transmitted, the slice header decoding unit 173 maintains the distance between cameras, the maximum disparity value, and the minimum disparity value included in the slice header or updates the distance between cameras, the maximum disparity value, and the minimum disparity value that are maintained based on the differential encoding results of the distance between cameras, the maximum disparity value, and the minimum disparity value. The slice header decoding unit 173 generates information for generating viewpoints from the disparity precision parameter included in the maintained distance between cameras, maximum disparity value, minimum disparity value, and the PPS and then supplies the information to the viewpoint composition unit 152.

Further, the slice header decoding unit 173 supplies the encoded data in a slice unit which is the encoded bit stream other than the information related to the distances between cameras, the maximum disparity values, and the minimum disparity values of the SPS, PPS, and slice header, the SPS, the PPS, and the slice header to the slice decoding unit 174. In addition, the slice header decoding unit 173 supplies the distance between cameras, the maximum disparity value, and the minimum disparity value to the slice decoding unit 174.

The slice decoding unit 174 decodes the encoded data of the multiplexed color image in a slice unit using a method corresponding to the encoding method with regard to the slice encoding unit 61 (FIG. 5), based on the information other than the information related to the distance between cameras, maximum disparity value, and minimum disparity value of the SPS, the PPS, and the slice header which are supplied from the slice header decoding unit 173. Further, the slice decoding unit 174 decodes the encoded data of the multiplexed parallax image in a slice unit using a method corresponding to the encoding method with regard to the slice encoding unit 61, based on the distance between cameras, maximum disparity value, and minimum disparity value, and the information other than the information related to the distance between cameras, maximum disparity value, and minimum disparity value of the SPS, PPS, and slice header. The slice header decoding unit 173 supplies the multi-viewpoint correction color image and the multi-viewpoint parallax image obtained from the decoding to the viewpoint composition unit 152 of FIG. 15.

### [Configuration Example of Slice Decoding Unit]

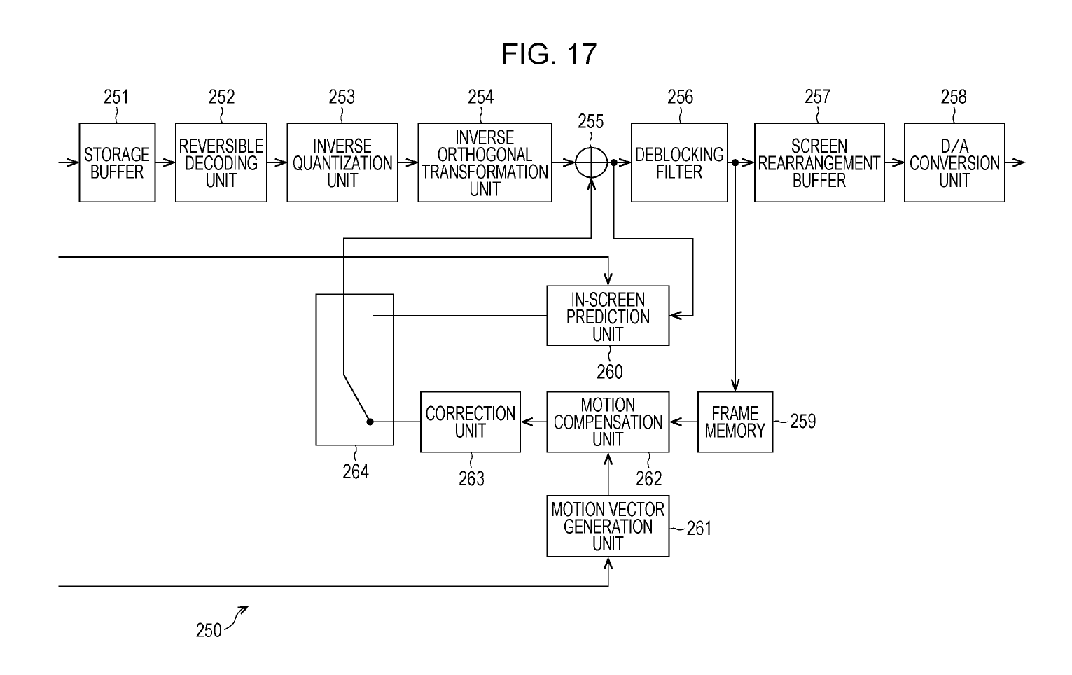

FIG. 17 is a block diagram illustrating the configuration example of a decoding unit which decodes a parallax image having one optional viewpoint among the slice decoding unit 174 of FIG. 16. That is, the decoding unit which decodes the multi-viewpoint parallax image among the slice decoding unit 174 is formed of a decoding unit 250 to the number of viewpoints of FIG. 17.

The decoding unit 250 of FIG. 17 is formed of a storage buffer 251, a reversible decoding unit 252, an inverse quantization unit 253, an inverse orthogonal transformation unit 254, an addition unit 255, a deblocking filter 256, a screen rearrangement buffer 257, a D/A conversion unit 258, a frame memory 259, an in-screen prediction unit 260, a motion vector generation unit 261, a motion compensation unit 262, a correction unit 263, and a switch 264.

The storage buffer 251 of the decoding unit 250 receives the encoded data of the parallax image having a predetermined viewpoint in a slice unit from the slice header decoding unit 173 of FIG. 16 and stores the data. The storage buffer 251 supplies the stored encoded data to the reversible decoding unit 252.

The reversible decoding unit 252 obtains the quantized coefficient by performing reversible decoding such as variable length decoding or arithmetic decoding on the encoded data from the storage buffer 251. The reversible decoding unit 252 supplies the quantized coefficient to the inverse quantization unit 253.

The inverse quantization unit 253, the inverse orthogonal transformation unit 254, the addition unit 255, the deblocking filter 256, the frame memory 259, the in-screen prediction unit 260, the motion compensation unit 262, and the correction unit 263 perform the same processes as those of the inverse quantization unit 128, the inverse orthogonal transformation unit 129, the addition unit 130, the deblocking filter 131, the frame memory 132, the in-screen prediction unit 133, the motion prediction and compensation unit 134, and the correction unit 135 of FIG. 6, and therefore the parallax image having a predetermined viewpoint is decoded.

Specifically, the inverse quantization unit 253 performs inverse quantization on the quantized coefficient from the reversible decoding unit 252 and supplies the coefficient obtained from the result to the inverse orthogonal transformation unit 254.

The inverse orthogonal transformation unit 254 performs the inverse orthogonal transformation such as inverse discrete cosine transformation or inverse Karhunen-Loeve transformation on the coefficient from the inverse quantization unit 253 and supplies the residual information obtained from the transformation to the addition unit 255.

The addition unit 255 functions as a decoding unit and decodes a decoding target parallax image by adding the residual information as the decoding target parallax image supplied from the inverse orthogonal transformation unit 254 and the prediction image supplied from the switch 264. The addition unit 255 supplies the parallax image obtained from the result to the deblocking filter 256 and to the in-screen prediction unit 260 as a reference image. In addition, when the prediction image is not supplied from the switch 264, the addition unit 255 supplies the parallax image which is the residual information supplied from the inverse orthogonal transformation unit 254 to the deblocking filter 256 and to the in-screen prediction unit 260 as a reference image.

The deblocking filter 256 removes block distortion by filtering the parallax image supplied from the addition unit 255. The deblocking filter 256 supplies the parallax image obtained from the result to the frame memory 259 to be stored and supplies the parallax image to the screen rearrangement buffer 257. The parallax image stored in the frame memory 259 is supplied to the motion compensation unit 262 as a reference image.

The screen rearrangement buffer 257 stores the parallax image supplied from the deblocking filter 256 in a frame unit. The screen rearrangement buffer 257 rearranges the parallax image in a frame unit in the order for stored encoding to be the parallax image in the original display order and supplies the parallax image to the D/A conversion unit 258.

The D/A conversion unit 258 performs D/A conversion on the parallax image in a frame unit supplied from the screen rearrangement buffer 257 and supplies the parallax image to the viewpoint composition unit 152 (FIG. 15) as the parallax image having a predetermined viewpoint.

The in-screen prediction unit 260 performs in-screen prediction in the optimum intra-prediction mode represented by the in-screen prediction information which is supplied from the slice header decoding unit 173 (FIG. 16) using a reference image supplied from the addition unit 255 and generates a prediction image. In addition, the in-screen prediction unit 260 supplies the prediction image to the switch 264.

The motion vector generation unit 261 adds the motion vector represented by the prediction vector index included in the motion information which is supplied from the slice header decoding unit 173 among the maintained motion vectors and the motion vector residual and restores the motion vector. The motion vector generation unit 261 maintains the restored motion vector. In addition, the motion vector generation unit 261 supplies the restored motion vector, the optimum inter-prediction mode included in the motion information, and the like to the motion compensation unit 262.

The motion compensation unit 262 functions as a prediction image generation unit and performs the motion compensation process by reading the reference image from the frame memory 259 based on the motion vector supplied from the motion vector generation unit 261 and the optimum inter-prediction mode. The motion compensation unit 262 supplies the prediction image generated from the result to the correction unit 263.

The correction unit 263 generates a correction coefficient used to correct a prediction image based on the maximum disparity value, the minimum disparity value, and the distance between cameras supplied from the slice header decoding unit 173 of FIG. 16 in the same manner as the correction unit 135 of FIG. 6. In addition, the correction unit 263 corrects the prediction image in the optimum inter-prediction mode supplied from the motion compensation unit 262 using the correction coefficient in the same manner as the correction unit 135. The correction unit 263 supplies the corrected prediction image to the switch 264.

When the prediction image is supplied from the in-screen prediction unit 260, the switch 264 supplies the prediction image to the addition unit 255, and when the prediction image is supplied from the motion compensation unit 262, the switch 264 supplies the prediction image to the addition unit 255.

### [Description of Process Done by Decoding Apparatus]

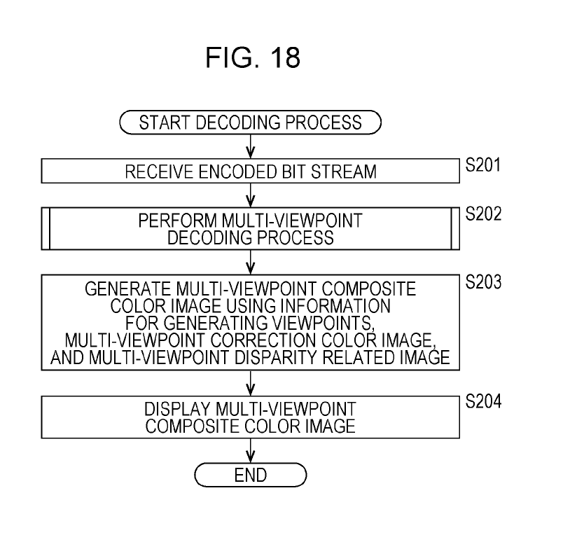

FIG. 18 is a flowchart describing a decoding process of the decoding apparatus 150 of FIG. 15. The decoding process is started, for example, when the encoded bit stream is transmitted from the encoding apparatus 50 of FIG. 1.

In Step S201 of FIG. 18, the multi-viewpoint image decoding unit 151 of the decoding apparatus 150 receives the encoded bit stream transmitted from the encoding apparatus 50 of FIG. 1.

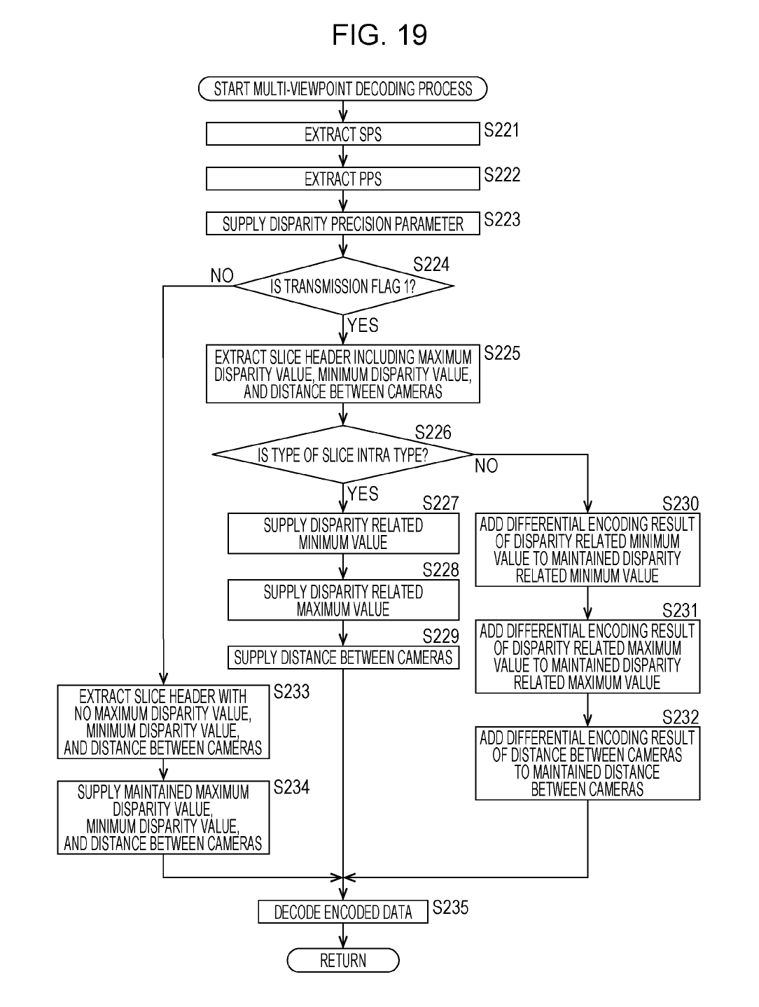

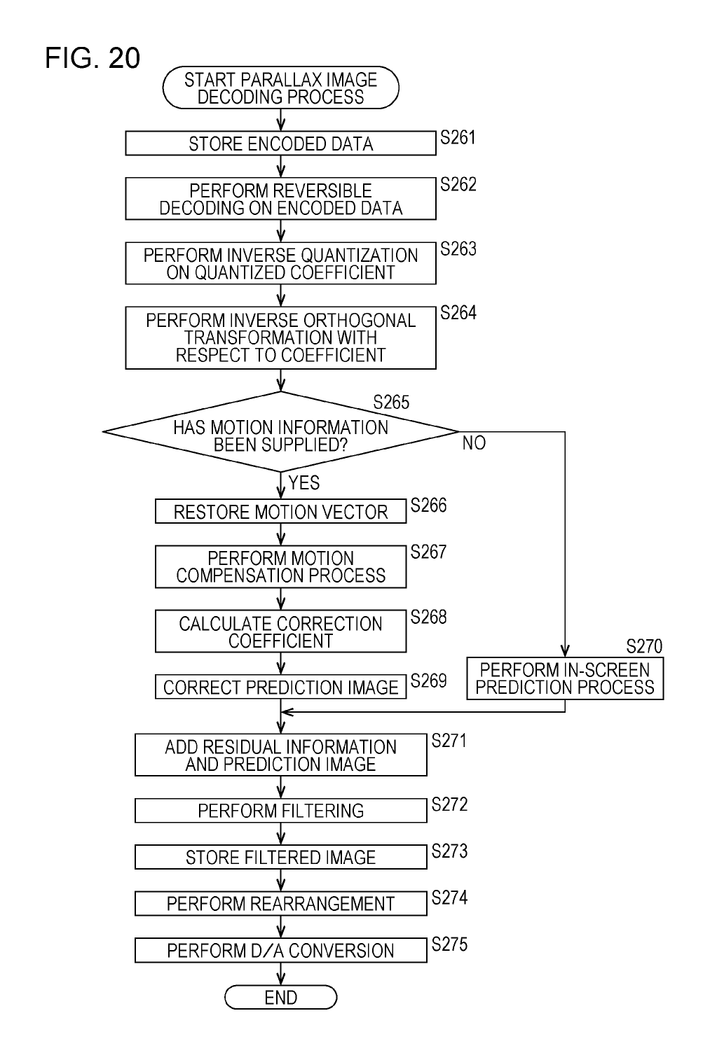

In Step S202, the multi-viewpoint image decoding unit 151 performs the multi-viewpoint decoding process which decodes the received encoded bit stream. The details of the multi-viewpoint decoding process will be described with reference to FIG. 19 below.

In Step S203, the viewpoint composition unit 152 functions as a color image generation unit and generates a multi-viewpoint composite color image using the information for generating viewpoints, the multi-viewpoint correction color image, and the multi-viewpoint parallax image supplied from the multi-viewpoint image decoding unit 151.

In Step S204, the multi-viewpoint image display unit 153 displays the multi-viewpoint composite color image supplied from the viewpoint composition unit 152 such that the visible angles are different from each other for each viewpoint and ends the process.

FIG. 19 is a flowchart describing details of the multi-viewpoint decoding process of Step S202 of FIG. 18.

In Step S221 of FIG. 19, the SPS decoding unit 171 (FIG. 16) of the multi-viewpoint image decoding unit 151 extracts the SPS among the received encoded bit stream. The SPS decoding unit 171 supplies the extracted SPS and the encoded bit stream other than the SPS to the PPS decoding unit 172.

In Step S222, the PPS decoding unit 172 extracts the PPS from the encoded bit stream other than the SPS supplied from the SPS decoding unit 171. The PPS decoding unit 172 supplies the extracted PPS and SPS and the encoded bit stream other than the SPS and PPS to the slice header decoding unit 173.

In Step S223, the slice header decoding unit 173 supplies the disparity precision parameter included in the PPS supplied from the PPS decoding unit 172 to the viewpoint composition unit 152 as a part of the information for generating viewpoints.

In Step S224, the slice header decoding unit 173 determines whether the transmission flag included in the PPS from the PPS decoding unit 172 is “1” which represents that something has been transmitted. In addition, the processes of Steps S225 to S234 are performed in a slice unit.

When it is determined that the transmission flag is “1” which represents that something has been transmitted in Step S224, the process proceeds to Step S225. In Step S225, the slice header decoding unit 173 extracts the slice header including the maximum disparity value, the minimum disparity value, and the distance between cameras or the differential encoding results of the maximum disparity value, the minimum disparity value, and the distance between cameras from the encoded bit stream other than the SPS and PPS supplied from the PPS decoding unit 172.

In Step S226, the slice header decoding unit 173 determines whether the slice type is the intra type. When it is determined whether the slice type is the intra type in Step S226, the process proceeds to Step S227.

In Step S227, the slice header decoding unit 173 maintains the minimum disparity value included in the slice header extracted in Step S225 and supplies the minimum disparity value to the viewpoint composition unit 152 as a part of the information for generating viewpoints.

In Step S228, the slice header decoding unit 173 maintains the maximum disparity value included in the slice header extracted in Step S225 and supplies the maximum disparity value to the viewpoint composition unit 152 as a part of the information for generating viewpoints.

In Step S229, the slice header decoding unit 173 maintains the distance between cameras included in the slice header extracted in Step S225 and supplies the distance between cameras to the viewpoint composition unit 152 as a part of the information for generating viewpoints. In addition, the process proceeds to Step S235.

On the other hand, when it is determined that the slice type is not the intra type in Step S226, that is, the slice type is the inter type, the process proceeds to Step S230.

In Step S230, the slice header decoding unit 173 adds the differential encoding results of the minimum disparity value included in the extracted slice header in Step S225 to the maintained minimum disparity value. The slice header decoding unit 173 supplies the minimum disparity value restored by the addition to the viewpoint composition unit 152 as a part of the information for generating viewpoints.

In Step S231, the slice header decoding unit 173 adds the differential encoding results of the maximum disparity value included in the slice header extracted in Step S225 to the maintained maximum disparity value. The slice header decoding unit 173 supplies the maximum disparity value restored by the addition to the viewpoint composition unit 152 as a part of the information for generating viewpoints.

In Step S232, the slice header decoding unit 173 adds the differential encoding results of the distance between cameras included in the slice header extracted in Step S225 to the maintained distance between cameras. The slice header decoding unit 173 supplies the distance between cameras restored by the addition to the viewpoint composition unit 152 as a part of the information for generating viewpoints. Then, the process proceeds to Step S235.

On the other hand, when it is determined that the transmission flag is not “1” which represents that something has been transmitted in Step S224, that is, the transmission flag is “0” which represents that nothing has been transmitted, the process proceeds to Step S233.

In Step S233, the slice header decoding unit 173 extracts the slice header with no maximum disparity value, minimum disparity value, distance between cameras, and no differential encoding results of the maximum disparity value, the minimum disparity value, and the distance between cameras, from the encoded bit stream other than the SPS and PPS supplied from the PPS decoding unit 172.

In Step S234, the slice header decoding unit 173 restores the maximum disparity value, the minimum disparity value, and the distance between cameras of a target slice to be processed by setting the maintained maximum disparity value, the minimum disparity value, and the distance between cameras, that is, the maximum disparity value, the minimum disparity value, and the distance between cameras of the previous slice in the encoding order to the maximum disparity value, the minimum disparity value, and the distance between cameras of the target slice to be processed. In addition, the slice header decoding unit 173 supplies the restored maximum disparity value, minimum disparity value, and distance between cameras to the viewpoint composition unit 152 as a part of the information for generating viewpoints and advances the process to Step S235.

In Step S235, the slice decoding unit 174 decodes the encoded data in a slice unit using a method corresponding to the encoding method with regard to the slice encoding unit 61 (FIG. 5). Specifically, the slice decoding unit 174 decodes the encoded data of the multi-viewpoint color image in a slice unit using a method corresponding to the encoding method with regard to the slice encoding unit 61 based on the slice header other than the information related to the SPS, PPS, distance between cameras, maximum disparity value, and minimum disparity value from the slice header decoding unit 173. In addition, the slice decoding unit 174 performs the parallax image decoding process which decodes the encoded data of the multi-viewpoint correction image in a slice unit using a method corresponding to the encoding method with regard to the slice encoding unit 61 based on the slice header other than the information related to the SPS, PPS, distance between cameras, maximum disparity value, and minimum disparity value from the slice header decoding unit 173, and the distance between cameras, maximum disparity value, and minimum disparity value. The details of the parallax image decoding process will be described with reference to FIG. 20 below. The slice header decoding unit 173 supplies the multi-viewpoint correction color image and the multi-viewpoint parallax image obtained from the decoding to the viewpoint composition unit 152 of FIG. 15.

FIG. 20 is a flowchart describing details of the parallax image decoding process of the slice decoding unit 174 of FIG. 16. The parallax image decoding process is performed for each viewpoint.

In Step S261 of FIG. 20, the storage buffer 251 of the decoding unit 250 receives the encoded data in a slice unit of the parallax image having a predetermined viewpoint from the slice header decoding unit 173 of FIG. 16 and stores the encoded data. The storage buffer 251 supplies the stored encoded data to the reversible decoding unit 252.

In Step S262, the reversible decoding unit 252 performs reversible decoding on the encoded data supplied from the storage buffer 251 and supplies the quantized coefficient obtained from the result to the inverse quantization unit 253.

In Step S263, the inverse quantization unit 253 performs inverse quantization on the quantized coefficient from the reversible decoding unit 252 and supplies the coefficient obtained from the result to the inverse orthogonal transformation unit 254.

In Step S264, the inverse orthogonal transformation unit 254 performs the inverse orthogonal transformation on the coefficient from the inverse quantization unit 253 and supplies the residual information obtained from the result to the addition unit 255.

In Step S265, the motion vector generation unit 261 determines whether the motion information from the slice header decoding unit 173 of FIG. 16 is supplied. When it is determined that the motion information is supplied in Step S265, the process proceeds to Step S266.

In Step S266, the motion vector generation unit 261 restores the motion vector based on the motion information and the maintained motion vector and maintains the motion vector. The motion vector generation unit 261 supplies the restored motion vector, the optimum inter-prediction mode included in the motion information, and the like to the motion compensation unit 262.

In Step S267, the motion compensation unit 262 performs the motion compensation process by reading the reference image from the frame memory 259 based on the motion vector and the optimum inter-prediction mode supplied from the motion vector generation unit 261. The motion compensation unit 262 supplies the prediction image generated from the motion compensation process to the correction unit 263.

In Step S268, the correction unit 263 calculates the correction coefficient based on the maximum disparity value, the minimum disparity value, and the distance between cameras supplied from the slice header decoding unit 173 of FIG. 16 in the same manner as the correction unit 135 of FIG. 6.

In Step S269, the correction unit 263 corrects the prediction image of the optimum inter-prediction mode supplied from the motion compensation unit 262 using the correction coefficient in the same manner as the correction unit 135. The correction unit 263 supplies the corrected prediction image to the addition unit 255 through the switch 264 and advances the process to Step S271.

On the other hand, when it is determined that the motion information is not supplied in Step S265, that is, the in-screen prediction information is supplied from the slice header decoding unit 173 to the in-screen prediction unit 260, the process proceeds to Step S270.

In Step S270, the in-screen prediction unit 260 performs the in-screen prediction process of the optimum intra-prediction mode indicated by the in-screen prediction information which is supplied from the slice header decoding unit 173 using the reference image supplied from the addition unit 255. The in-screen prediction unit 260 supplies the prediction image generated from the result to the addition unit 255 through the switch 264 and advances the process to Step S271.

In Step S271, the addition unit 255 adds the residual information supplied from the inverse orthogonal transformation unit 254 and the prediction image supplied from the switch 264. The addition unit 255 supplies the parallax image obtained from the result to the deblocking filter 256 and to the in-screen prediction unit 260 as a reference image.

In Step S272, the deblocking filter 256 performs filtering on the parallax image supplied from the addition unit 255 and removes the block distortion.

In Step S273, the deblocking filter 256 supplies the filtered parallax image to the frame memory 259, stores the parallax image, and supplies the parallax image to the screen rearrangement buffer 257. The parallax image stored in the frame memory 259 is supplied to the motion compensation unit 262 as a reference image.

In Step S274, the screen rearrangement buffer 257 stores the parallax image supplied from the deblocking filter 256 in a frame unit, rearranges the parallax image in a frame unit in the order for the stored encoding to be the parallax image in the original display order, and supplies the parallax image to the D/A conversion unit 258.

In Step S275, the D/A conversion unit 258 performs D/A conversion on the parallax image in a frame unit supplied from the screen rearrangement buffer 257 and supplies the parallax image to the viewpoint composition unit 152 of FIG. 15 as the parallax image having a predetermined viewpoint.

As described above, the decoding apparatus 150 receives the encoded data of the parallax image whose encoding efficiency is improved by being encoded using the corrected prediction image with the information related to the parallax image, and the encoded bit stream including the information related to the parallax image. In addition, the decoding apparatus 150 corrects the prediction image using the information related to the parallax image and decodes the encoded data of the parallax image using the corrected prediction image.

More specifically, the decoding apparatus 150 receives the encoded data, which is encoded using the corrected prediction image with the distance between cameras, the maximum disparity value, and the minimum disparity value as the information related to the parallax image, and the distance between cameras, the maximum disparity value, and the minimum disparity value. In addition, the decoding apparatus 150 corrects the prediction image using the distance between cameras, the maximum disparity value, and the minimum disparity value and decodes the encoded data of the parallax image using the corrected prediction image. In this way, the decoding apparatus 150 can decode the encoded data of the parallax image whose encoding efficiency is improved by being encoded using the corrected prediction image with the information related to the parallax image.

Further, the encoding apparatus 50 transmits the maximum disparity value, the minimum disparity value, and the distance between cameras by allowing them to be included in the slice header as the information used to correct the prediction image, but the transmission method is not limited thereto.

### [Description of Transmission Method of Information Used to Correct Prediction Image]

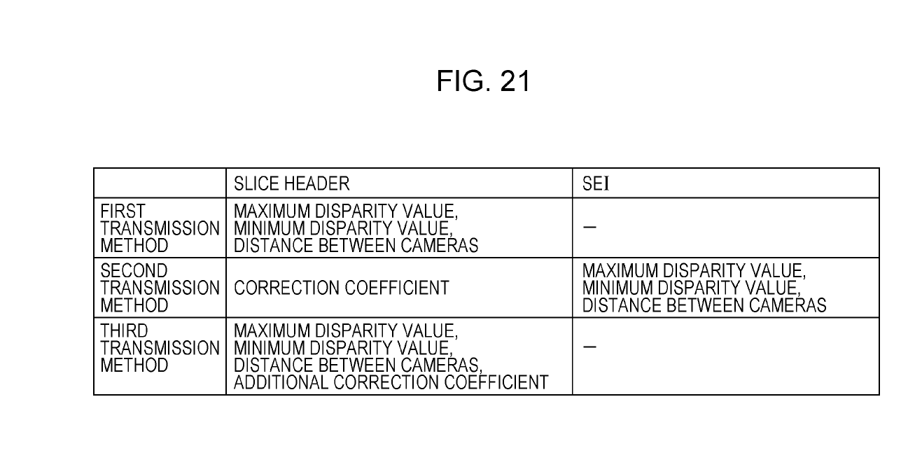

FIG. 21 is a diagram describing the transmission method of the information used to correct the prediction image.

A first transmission method of FIG. 21, as described above, is a method of transmitting the maximum disparity value, the minimum disparity value, and the distance between cameras by allowing them to be included in the slice header, as the information used to correct the prediction image. In this case, it is possible to reduce the information amount of the encoded bit stream by sharing the information used to correct the prediction image and the information for generating viewpoints. However, since it is necessary to calculate the correction coefficient using the maximum disparity value, the minimum disparity value, and the distance between cameras in the decoding apparatus 150, the processing load of the decoding apparatus 150 is bigger than that of a second transmission method described below.

On the other hand, the second transmission method of FIG. 21 is a method of transmitting the correction coefficient itself by including the correction coefficient in the slice header as the information used to correct the prediction image. In this case, since the maximum disparity value, the minimum disparity value, and the distance between cameras are not used to correct the prediction image, they are transmitted by being included in, for example, SEI (Supplemental Enhancement Information) which does not need to be referenced at the time of encoding as a part of the information for generating viewpoints. In the second transmission method, since the correction coefficient is transmitted, it is not necessary to calculate the correction coefficient in the decoding apparatus 150 and the processing load of the decoding apparatus 150 is smaller than that of the first transmission method. However, the information amount of the encoded bit stream becomes larger because the correction coefficient is newly transmitted.

In addition, in the above description, the prediction image is corrected using the maximum disparity value, the minimum disparity value, and the distance between cameras, but the prediction image can be corrected using the information related to other disparities (for example, information of an imaging position representing an imaging position in the depth direction of the multi-viewpoint color image capturing unit 51 or the like).

In this case, the maximum disparity value, the minimum disparity value, the distance between cameras, and the additional correction coefficient which is the correction coefficient generated using the information related to other disparities, as the information used to correct the prediction image, are included in the slice header to be transmitted by a third transmission method of FIG. 21. In this way, when the prediction image is corrected using the information related to the disparity other than the maximum disparity value, the minimum disparity value, and the distance between cameras, the encoding efficiency can be improved by reducing the difference between the prediction image and the parallax image due to the information related to the disparity. However, the information amount of the encoded bit stream becomes larger than that of the first transmission method because the additional correction coefficient is newly transmitted. Further, since it is necessary to calculate the correction coefficient using the maximum disparity value, the minimum disparity value, and the distance between cameras, the processing load on the decoding apparatus 150 is larger than that of the second transmission method.

FIG. 22 is a diagram illustrating the configuration example of the encoded bit stream when the information used to correct the prediction image is transmitted with the second transmission method.

In the example of FIG. 22, the correction coefficients of one intra-type slice and two inter-type slices constituting the same PPS unit of PPS#0 do not match a correction coefficient of the previous slice in the encoding order, respectively. Accordingly, the transmission flag of “1” which represents that something has been transmitted is included in PPS#0. Further, here, the transmission flag is a flag representing whether or not the correction coefficient is transmitted.

In addition, in the example of FIG. 22, a correction coefficient a of the intra-type slice constituting the same PPS unit of PPS#0 is 1 and a correction coefficient b is 0. Accordingly, the correction coefficient a of “1” and the correction coefficient b of “0” are included in the slice header of the slice.

Further, in the example of FIG. 22, the correction coefficient a of the first inter-type slice constituting the same PPS unit of PPS#0 is 3 and the correction coefficient b is 2. Accordingly, the difference “+2” in which the correction coefficient a of “1” of the previous intra-type slice in the encoding order is subtracted from the correction coefficient a of “3” of the slice is included in the slice header of the slice as the differential encoding result of the correction coefficient. In the same way, the difference of “+2” of the correction coefficient b is included as the differential encoding result of the correction coefficient b.

Moreover, in the example of FIG. 22, the correction coefficient a of the second inter-type slice constituting the same PPS unit of PPS#0 is 0 and the correction coefficient b is −1. Accordingly, the difference “−3” in which the correction coefficient a of “3” of the previous first inter-type slice in the encoding order is subtracted from the correction coefficient a of “0” of the slice is included in the slice header of the slice as the differential encoding result of the correction coefficient. In the same way, the difference of “−3” of the correction coefficient b is included as the differential encoding result of the correction coefficient b.

In addition, in the example of FIG. 22, the correction coefficients of one intra-type slice and two inter-type slices constituting the same PPS unit of PPS#1 match a correction coefficient of the previous slice in the encoding order, respectively. Accordingly, the transmission flag of “0” which represents that nothing has been transmitted is included in PPS#1.

FIG. 23 is a diagram illustrating the configuration example of the encoded bit stream when the information used to correct the prediction image is transmitted with the third transmission method.

In the example of FIG. 23, the minimum disparity value, the maximum disparity value, the distance between cameras, and the additional correction coefficient of one intra-type slice and two inter-type slices constituting the same PPS unit of PPS#0 do not match the minimum disparity value, the maximum disparity value, the distance between cameras, and an additional correction coefficient of the previous slice in the encoding order, respectively. Accordingly, the transmission flag of “1” which represents that something has been transmitted is included in PPS#0. Further, here, the transmission flag is a flag representing whether or not the minimum disparity value, the maximum disparity value, the distance between cameras, and the additional correction coefficient are transmitted.

Further, in the example of FIG. 23, the minimum disparity value, the maximum disparity value, and the distance between cameras of the slice constituting the same PPS unit of PPS#0 are the same as the case of FIG. 7 and the information related to the minimum disparity value, the maximum disparity value, and the distance between cameras included in the slice header of each slice is the same as the case of the FIG. 7, so the description will not be repeated.

Moreover, in the example of FIG. 23, the additional correction coefficient of the intra-type slice constituting the same PPS unit of PPS#0 is 5. Accordingly, the additional correction coefficient of “5” is included in the slice header of the slice.

In addition, in the example of FIG. 23, the additional correction coefficient of the first inter-type slice constituting the same PPS unit of PPS#0 is 7. Accordingly, the difference of “+2” in which the additional correction coefficient of “5” of the previous intra-type slice in the encoding order is subtracted from the additional correction coefficient of “7” of the slice is included in the slice header of the slice as the differential encoding result of the additional correction coefficient.

Further, in the example of FIG. 23, the additional correction coefficient of the second inter-type slice constituting the same PPS unit of PPS#0 is 8. Accordingly, the difference of “+1” in which the additional correction coefficient of “7” of the previous first inter-type slice in the encoding order is subtracted from the additional correction coefficient of “8” of the slice is included in the slice header of the slice as the differential encoding result of the additional correction coefficient.

Further, in the example of FIG. 23, the minimum disparity value, the maximum disparity value, the distance between cameras, and the additional correction coefficient of one intra-type slice and two inter-type slices constituting the same PPS unit of PPS#1 match the minimum disparity value, the maximum disparity value, the distance between cameras, and the additional correction coefficient of the previous slice in the encoding order, respectively. Accordingly, the transmission flag of “0” which represents that nothing has been transmitted is included in PPS#1.

The encoding apparatus 50 may transmit the information used to correct the prediction image using any one of the first to third methods of FIG. 21. In addition, the encoding apparatus 50 may transmit identification information (for example, a flag or an ID) identifying one transmission method among the first to third transmission methods which are adopted as the transmission methods, by allowing the information to be included in the encoded bit stream. Further, the first to third transmission methods of FIG. 21 can be appropriately selected in consideration of the balance between the data amount of the encoded bit stream and the processing load of decoding according to the application using the encoded bit stream.

Further, in the present embodiment, the information used to correct the prediction image is arranged in the slice header as the information related to encoding, but the arrangement region of the information used to correct the prediction image is not limited to the slice header as long as the region is referenced at the time of encoding. For example, the information used to correct the prediction image can be arranged in a new NAL (Network Abstraction Layer) unit such as an existing NAL unit of an NAL unit of the PPS or the like or an NAL unit of APS (Adaptation Parameter Set) proposed by an HEVC standard.

For example, when the correction coefficient and the additional correction coefficient are common in plural pictures, the transmission efficiency can be improved by arranging the common value in the NAL unit (for example, the NAL unit of the PPS or the like) adaptable to the plural pictures. In other words, in this case, since the correction coefficient and the additional correction coefficient common in the plural pictures may be transmitted, it is not necessary to transmit the correction coefficient and the additional correction coefficient for each slice as the case of arranging the value in the slice header.

Accordingly, for example, when a color image is a color image having a flash effect or a fade effect, since parameters such as the minimum disparity value, the maximum disparity value, and the distance between cameras are not likely to be changed, the transmission efficiency is improved by arranging the correction coefficient and the additional correction coefficient in the NAL unit of the PPS.

When the correction coefficient and the additional correction coefficient are different from each other for each picture, it is possible to arrange the correction coefficient and the additional correction coefficient in the slice header and when the values are common in plural pictures, it is possible to arrange the correction coefficient and the additional correction coefficient on the upper layer of the slice header (for example, the NAL unit of the PPS or the like).

Further, the parallax image may be an image (a depth image) formed of a depth value representing a position of a subject of each pixel of a color image in the depth direction, which has a viewpoint corresponding to the parallax image. In this case, the maximum disparity value and the minimum disparity value are respectively the maximum value and the minimum value of a world coordinate value of a position in the depth direction obtained in the multi-viewpoint parallax image.

Further, the present technology can be applied to the encoding method such as AVC, MVC (Multiview Video Coding), or the like other than the HEVC method.

### <Other Configurations of Slice Encoding Unit>

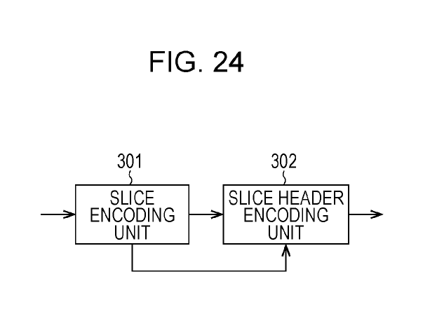

FIG. 24 is a diagram in which the slice encoding unit 61 (FIG. 5) and the slice header encoding unit 62 constituting the multi-viewpoint image encoding unit 55 (FIG. 1) are extracted. In FIG. 24, the description is made with different reference signs in order to distinguish between the slice encoding unit 61 shown in FIG. 5 and the slice header encoding unit 62, but since the basic process of the slice encoding unit 61 shown in FIG. 5 is the same as that of the slice header encoding unit 62, the description thereof will not be repeated.

The slice encoding unit 301 performs the same encoding process as that of the above-described slice encoding unit 61. That is, the slice encoding unit 301 performs encoding in a slice unit on the multi-viewpoint correction color image supplied from the multi-viewpoint color image correction unit 52 (FIG. 1) using the HEVC method.

Further, the slice encoding unit 301 performs encoding in a slice unit on the multi-viewpoint parallax image from the multi-viewpoint parallax image generation unit 53 with a method in conformity with the HEVC method, using the maximum disparity value, the minimum disparity value, and the distance between cameras among the information for generating viewpoints supplied from the information generation unit 54 for generating viewpoints of FIG. 1 as the information related to the disparity. The slice encoding unit 301 outputs the encoded data in a slice unit obtained from the encoding to a slice header encoding unit 302.

The slice header encoding unit 302 sets the maximum disparity value, the minimum disparity value, and the distance between cameras among the information for generating viewpoints supplied from the information generation unit 54 for generating viewpoints (FIG. 1) to the maximum disparity value, the minimum disparity value, and the distance between cameras of the current target slice to be processed and maintains them. In addition, the slice header encoding unit 62 determines whether the maximum disparity value, the minimum disparity value, and the distance between cameras of the current target slice to be processed respectively match the maximum disparity value, the minimum disparity value, and the distance between cameras of the previous slice in the encoding order, in the same PPS unit.

Further, when the depth image formed of the depth value representing the position (distance) in the depth direction is used as a parallax image, the above described maximum disparity value and minimum disparity value respectively become the maximum value and the minimum value of the world coordinate value for the position in the depth direction obtained in the multi-viewpoint parallax image. Even though here is the part for description of the maximum disparity value and the minimum disparity value, the values can be replaced with the maximum value and the minimum value of the world coordinate value for the position in the depth direction when the depth image formed of the depth value representing the position in the depth direction is used as the parallax image.

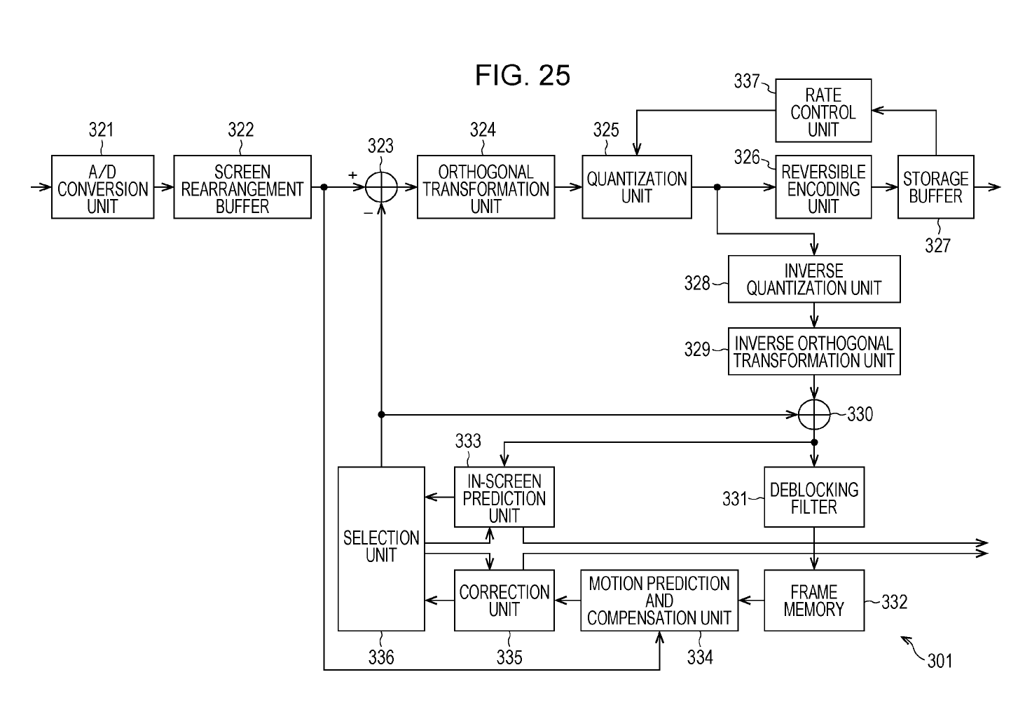

FIG. 25 is a diagram illustrating the internal configuration example of the slice encoding unit 301. The slice encoding unit 301 shown in FIG. 25 is formed of an A/D conversion unit 321, a screen rearrangement buffer 322, an arithmetic unit 323, an orthogonal transformation unit 324, a quantization unit 325, a reversible encoding unit 326, a storage buffer 327, an inverse quantization unit 328, an inverse orthogonal transformation unit 329, an addition unit 330, a deblocking filter 331, a frame memory 332, an in-screen prediction unit 333, a motion prediction and compensation unit 334, a correction unit 335, a selection unit 336, and a rate control unit 337.

The slice encoding unit 301 shown in FIG. 25 has the same configuration as the encoding unit 120 shown in FIG. 6. That is, the A/D conversion unit 321 through the rate control unit 337 of the slice encoding unit 301 shown in FIG. 25 respectively have the same functions as those of the A/D conversion unit 121 through the rate control unit 137 of the encoding unit 120 shown in FIG. 6. Accordingly, the specific description will not be repeated.

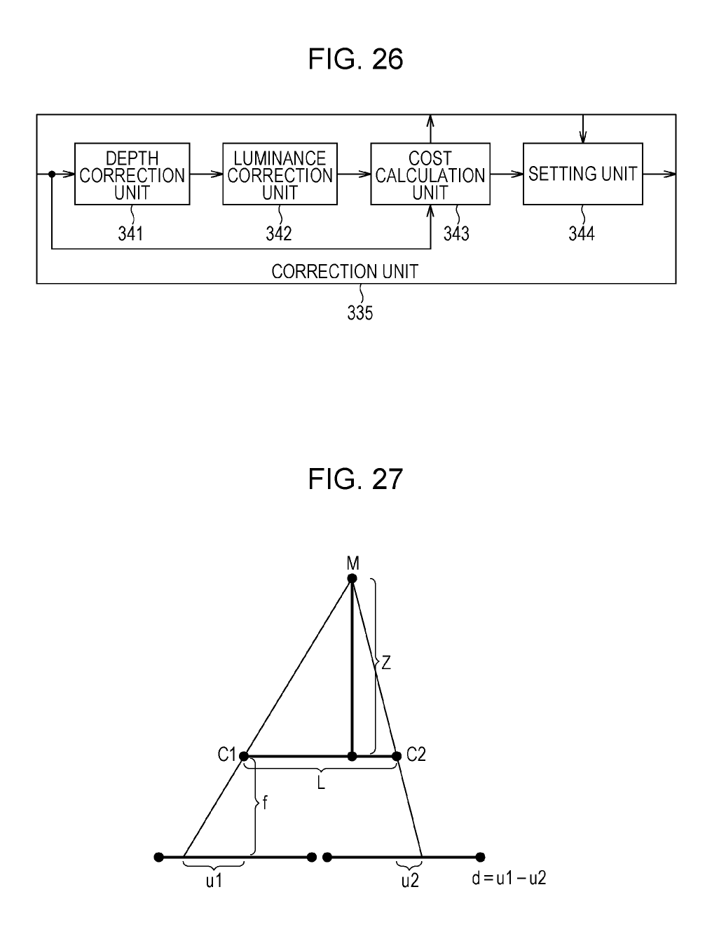

The slice encoding unit 301 shown in FIG. 25 has the same configuration as the encoding unit 120 shown in FIG. 6, but the internal configuration of the correction unit 335 is different from that of the correction unit 135 of the encoding unit 120 shown in FIG. 6. The configuration of the correction unit 335 is shown in FIG. 26.

The correction unit 335 shown in FIG. 26 is formed of a depth correction unit 341, a luminance correction unit 32, a cost calculation unit 343, and a setting unit 344. The processes being performed by each unit will be described with reference to the flowcharts below.

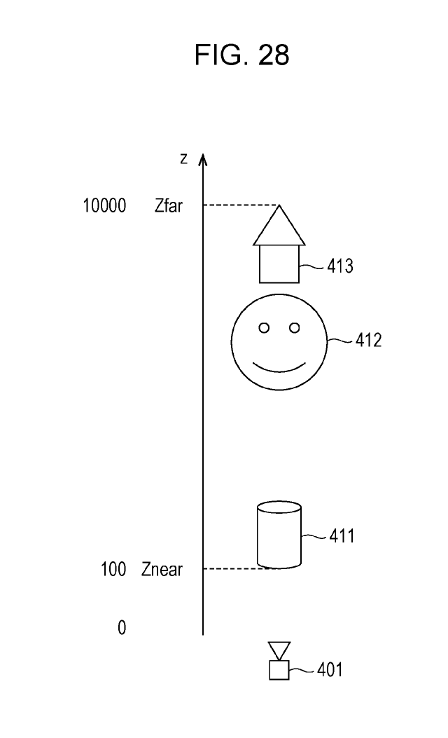

FIG. 27 is a diagram for describing the disparity and the depth. In FIG. 27, the position on which a camera C1 is installed is represented by C1 and the position on which a camera C2 is installed is represented by C2. It is possible to photograph color images having different viewpoints by the cameras C1 and C2. In addition, the cameras C1 and C2 are installed separated by a distance L. M represents an object as an imaging target and is written as an object M. Here, f represents the focal distance of the camera C1.

The following expression is established with the relationship described above.

Z=(L/D)×f

In this expression, Z represents a position of a subject of a parallax image (depth image) in the depth direction (distance between the object M and the camera C1 (camera C2) in the depth direction). D represents (an x component of) a photography disparity vector and represents a disparity value. In other words, D represents the disparity generated between two cameras. Specifically, D(d) represents a value in which a distance u2 from the center of a color image for the position of the object M in the horizontal direction on the color image imaged by the camera C2 is subtracted from a distance u1 from the center of the color image for the position of the object M in the horizontal direction on the color image imaged by the camera C1. In the expression described above, the disparity value D and the position Z can be converted uniquely. Accordingly, the parallax image and the depth image are collectively called the depth image below. The description of the relationships which are satisfied in the above expression and the relationship between the disparity value D and the position Z in the depth direction is further continued below.

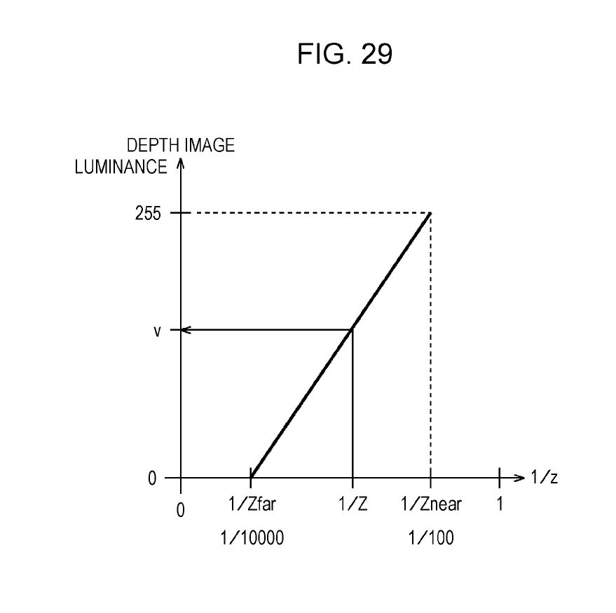

FIGS. 28 and 29 are diagrams for describing relationships of an image imaged by a camera, depth, and a depth value. A camera 401 images a cylinder 411, a face 412, and a house 413. The cylinder 411, the face 412, and the house 413 are disposed in order from the side close to the camera 401. At this time, the position of the cylinder 411 disposed in the closest position to the camera 401 in the depth direction is set to a minimum value Znear of the world coordinate value for the position in the depth direction and the position of the house 413 disposed in the farthest position from the camera 401 is set to a maximum value Zfar of the world coordinate value for the position in the depth direction.

FIG. 29 is a diagram describing a relationship between the minimum value Znear and the maximum value Zfar for the position in the depth direction of the information for generating viewpoints. In FIG. 29, the horizontal axis is an inverse value of a position in the depth direction before normalization and the vertical axis is a pixel value of a depth image. As shown in FIG. 29, the depth value as a pixel value of each pixel is normalized to, for example, a value of 0 to 255 when the an inverse value of the maximum value Zfar and an inverse value of the minimum value Znear are used. Further, a depth image is generated by setting the depth value of each pixel after normalization, which is a value of 0 to 255, to the pixel value.

The graph shown in FIG. 29 corresponds to the graph shown in FIG. 2. The graph shown in FIG. 29 is a graph illustrating the relationship between the minimum value and the maximum value of the depth position of the information for generating viewpoints and the graph shown in FIG. 2 is a graph illustrating the relationship between the maximum disparity value and the minimum disparity value of the information for generating viewpoints.

As described with reference to FIG. 2, the pixel value I of each pixel of the parallax image is represented by the formula (1) using the disparity value d, the minimum disparity value Dmin, and the maximum disparity value Dmax before normalization of the pixel. Here, the formula (1) is shown as the formula (11) as follows again.

$$\begin{matrix}[ Expression 9 ] & \\ I = \frac{255 * ( d - {D}_{min} )}{{D}_{max} - {D}_{min}} & ( 11 )\end{matrix}$$

The pixel value y of each pixel of the depth image is represented by the following formula (13) using the depth value 1/Z, the minimum value Znear, and the maximum value Zfar before normalization of the pixel. Further, here, the inverse value for the position Z is used as the depth value, but the position Z can be used as is as the depth value.

$$\begin{matrix}[ Expression 10 ] & \\ y = 255 \cdot \frac{\frac{1}{Z} - \frac{1}{{Z}_{far}}}{\frac{1}{{Z}_{near}} - \frac{1}{{Z}_{far}}} & ( 13 )\end{matrix}$$

As understood from the formula (13), the pixel value y of the depth image is a value calculated from the maximum value Zfar and the minimum value Znear. As described with reference to FIG. 28, the maximum value Zfar and the minimum value Znear are values determined depending on the position relationship of an object to be imaged. Accordingly, when the position relationship of the object in an image to be imaged is changed, the maximum value Zfar and the minimum value Znear are changed according to the change.

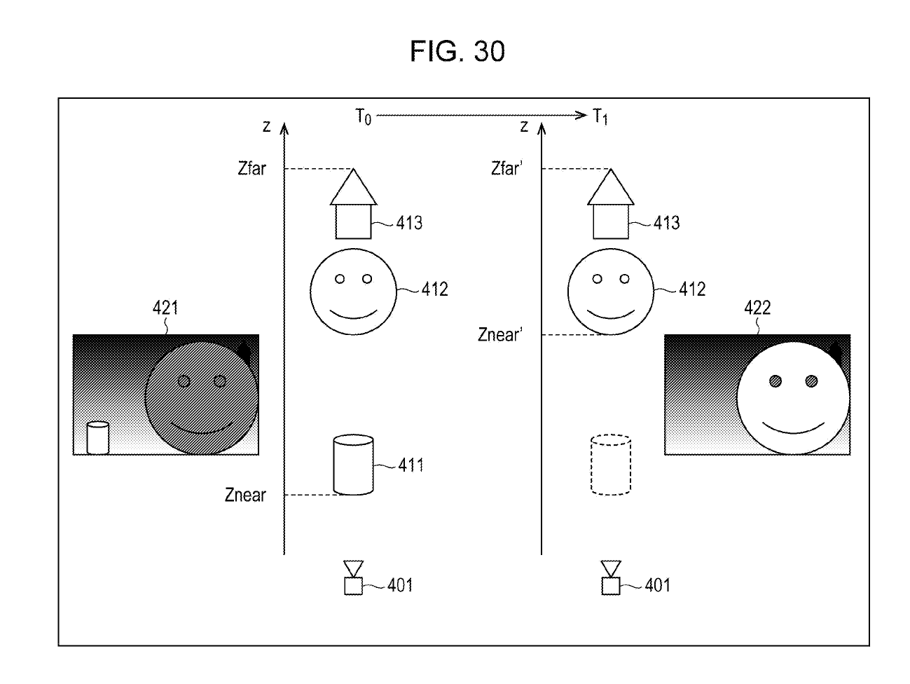

Here, the change in the position relationship of the object will be described with reference to FIG. 30. The left side of FIG. 30 shows the position relationship of the image to be imaged by the camera 401 at the time T₀ and also shows the same position relationship as the position relationship shown in FIG. 28. When the time T₀ is changed to the time T₁, the cylinder 411 positioned close to the camera 401 disappears, so that a case that the position relationship between the face 412 and the house 413 is not changed is assumed.

In this case, when the time T₀ is changed to the time T₁, the minimum value Znear is changed to a minimum value Znear′. That is, while the position Z of the cylinder 411 in the depth direction is the minimum value Znear in the time T₀, the cylinder 411 disappears and then the object at the position closest to the camera 401 is changed to the face 412, so that the position of the minimum value Znear (Znear′) is changed to the position Z of the face 412 according to the change in the time T₁.

The difference (range) between the minimum value Znear and the maximum value Zfar at the time T₀ is set to a depth range A showing the range for the position in the depth direction and the difference (range) between the minimum value Znear′ and the maximum value Zfar at the time T₁ is set to a depth range B. In this case, the depth range A becomes changed to the depth range B. Here, as described above, since the pixel value y of the depth image is a value calculated from the maximum value Zfar and the minimum value Znear when the formula (13) is referenced again, the pixel value calculated using such a value becomes changed when the depth range A is changed to the depth range B.

For example, a depth image 421 at the time T₀ is shown at the left side of FIG. 30. The pixel value of the cylinder 411 is large (bright) because the cylinder 411 is positioned in front of the depth image 421 and the pixel values of the face 412 and the house 413 are smaller (darker) than that of the cylinder 411 because the face 412 and the house 413 are positioned farther than the cylinder 411. In the same way, a depth image 522 at the time T₁ is shown at the right side of FIG. 30. The depth range becomes smaller and the pixel value of the face 412 becomes larger (brighter) compared to that of the depth image 421 since the cylinder 411 disappears. This is because the pixel value y acquired by the formula (13) using the maximum value Zfar and the minimum value Znear is changed even when they are positioned at the same position Z since the depth range is changed as described above.

However, since the position of the face 412 is not changed at the time T₀ and the time T₁, it is preferable that the pixel value of the depth image of the face 412 not be suddenly changed at the time T₀ and time T₁. That is, when the ranges of the maximum value and the minimum value for the position (distance) in the depth direction are suddenly changed, the pixel value (luminance value) of the depth image is considerably changed even if the positions in the depth direction are the same, so it may possibly become unpredictable. Therefore, the case in which the value is controlled to prevent such a case will be described.

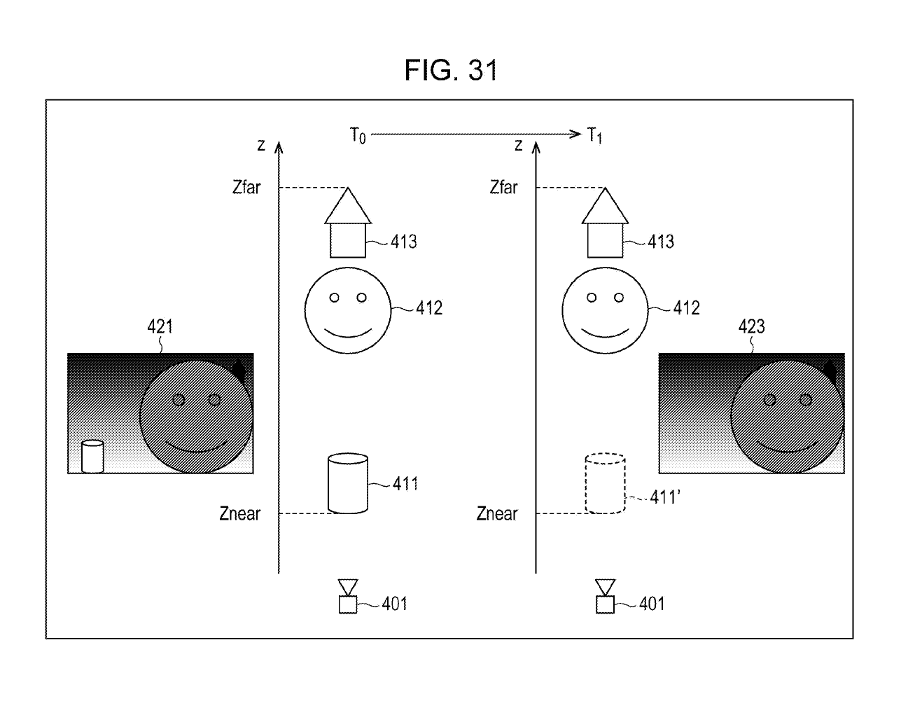

FIG. 31 is the same as the figure shown in FIG. 30. However, the position relationship of the object at the time T₁ illustrated at the right side in FIG. 31 is processed such that there is no change in the minimum value Znear when it is assumed that a cylinder 411′ is positioned in front of the camera 401. By this process, it is possible to process the above-described depth range A and the depth range B without change. Therefore, it is possible to reduce the possibility that unpredictable cases may happen without sudden change in the ranges of the maximum value and the minimum value of the distance in the depth direction and without considerable change in the pixel value (luminance value) of the depth image when the positions in the depth direction are the same.

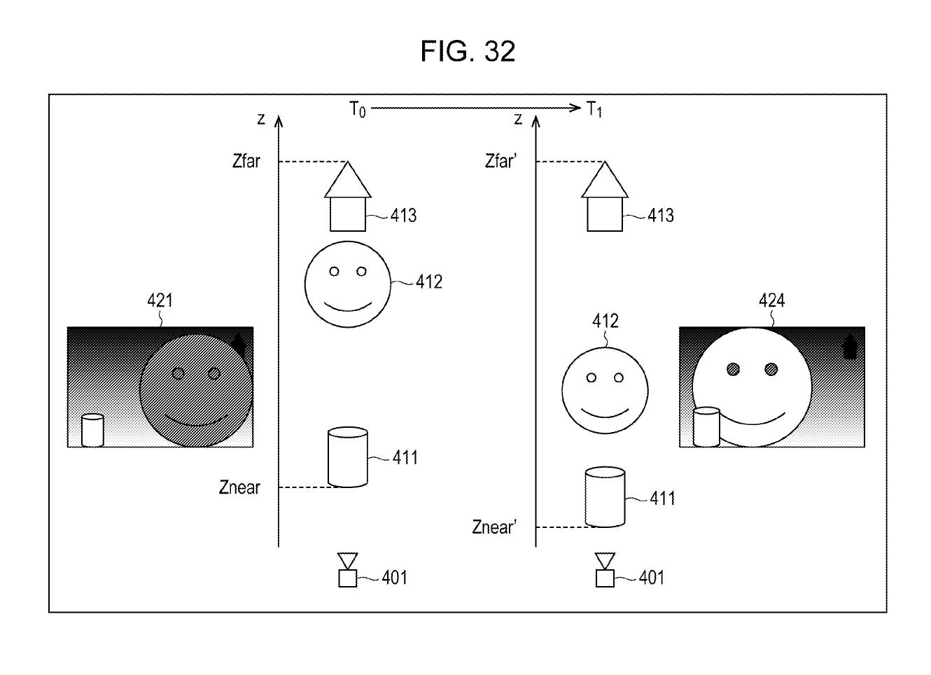

In addition, as shown in FIG. 32, a case in which the position relationship of the object is changed is assumed. In the position relationship of the object shown in FIG. 32, the position relationship at the time T₀ illustrated at the left side of FIG. 32 is the same as the case shown in FIGS. 30 and 31, and it is the case in which the cylinder 411, the face 412, and the house 413 are positioned in order from the side close to the camera 401.

When the face 412 is moved to the side of the camera 401 at the time T₁ and the cylinder 411 is moved to the side of the camera 401 from the above condition, since the minimum value Znear becomes the minimum value Znear′, the difference from the maximum value Zfar is changed and the depth range is changed as shown in FIG. 32. Such sudden change in the ranges of the maximum value and the minimum value for the position in the depth direction is processed that the position of the cylinder 411 is not changed as described with reference to FIG. 31, so that it is possible to prevent the considerable change in the pixel value (luminance value) of the depth image when the positions in the depth direction are the same.

In the case shown in FIG. 32, since the face 412 is moved to the direction of the camera 401, the position in the depth direction of the face 412 becomes smaller (the pixel value (luminance value) of the depth image becomes higher) than the position of the face 412 in the depth direction at the time T₀. However, when the process of preventing the considerable change in the pixel value (luminance value) of the depth image when the above-described positions in the depth direction are the same is performed, the pixel value of the depth image of the face 412 may not be set to the appropriate pixel value (luminance value) in which the pixel value of the depth image corresponds to the position in the depth direction. Therefore, a process in which the pixel value (luminance value) of the face 412 or the like becomes the appropriate pixel value (luminance value) is performed after the process described above with reference to FIG. 31 is performed. In this way, when the positions in the depth direction are the same, the process of preventing the considerable change in the pixel value of the depth image and the process of setting the appropriate pixel value (luminance value) are performed.

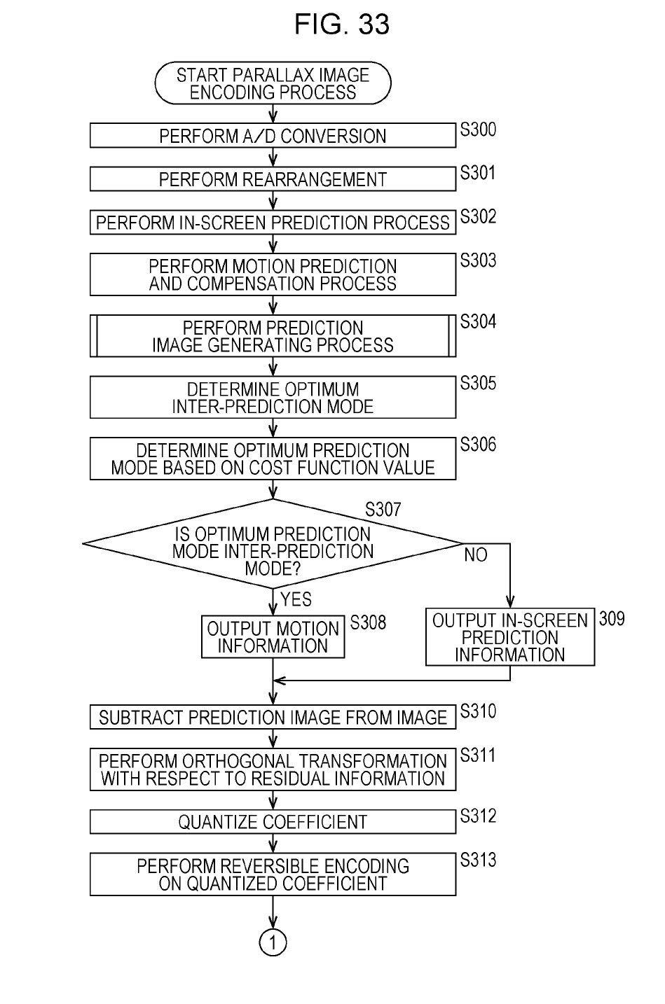

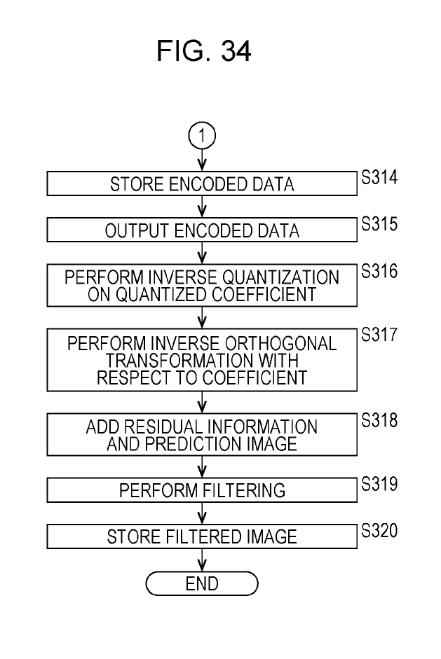

A process related to encoding the depth image when the above-described process is performed will be described with reference to the flowcharts of FIGS. 33 and 34. FIGS. 33 and 34 are flowcharts describing details of the parallax image encoding process of the slice encoding unit 301 shown in FIGS. 24 to 26. The parallax image encoding process is performed for each viewpoint.

The slice encoding unit 301 shown in FIGS. 24 to 26 has basically the same configuration as that of the slice encoding unit 61 shown in FIGS. 5 and 6, but the description in which the internal configuration of the correction unit 335 is different is given. Accordingly, the process other than the processes performed by the correction unit 335 is basically performed as the same process as that of the slice encoding unit 61 shown in FIGS. 5 and 6, that is, the same process as the process of the flowcharts shown in FIGS. 13 and 14. Here, the description of the repetitive parts described in the flowcharts shown in FIGS. 13 and 14 will not be repeated.

The processes of Steps S300 to S303 and Steps S305 to S313 of FIG. 33 are performed in the same manner as the processes of Steps S160 to S163 and Steps S166 to S174 of FIG. 13. However, the process of Step S305 is performed by the cost calculation unit 343 of FIG. 26 and the process of Step S308 is performed by the setting unit 344. Further, the processes of Steps S314 to S320 of FIG. 34 are performed in the same manner as the processes of Steps S175 to S181 of FIG. 14. That is, the same processes are basically performed except that the prediction image generation process performed in Step S304 is different from the process of the flowchart shown in FIG. 13.

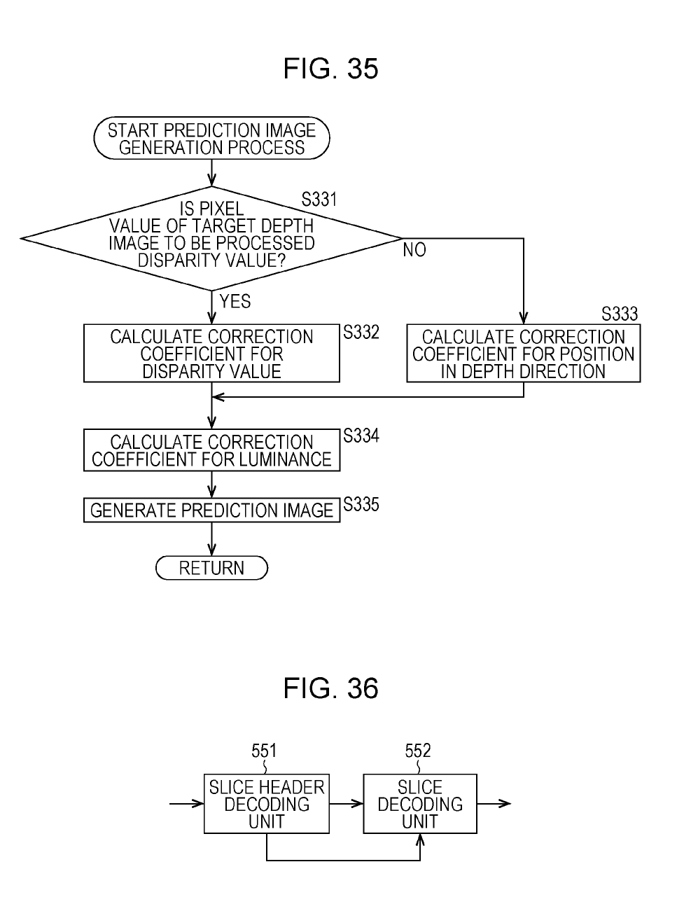

Here, the prediction image generation process performed in Step S304 will be described with reference to the flowchart of FIG. 35. In Step S331, the depth correction unit 341 (FIG. 26) determines whether the pixel value of the target depth image to be processed is the disparity value (disparity).

In Step S331, it is determined that the pixel value of the target depth image to be processed is the disparity value, and the process proceeds to Step S332. In Step S332, the correction coefficient for the disparity value is calculated. The correction coefficient for the disparity value can be acquired by the following formula (14).

$$\begin{matrix}[ Expression 11 ] & \\ \begin{matrix}{v}_{ref}^{′} = \frac{{L}_{cur} {F}_{cur}}{{L}_{ref} {F}_{ref}} \cdot \frac{{Dref}_{max} - {Dref}_{min}}{{Dcur}_{max} - {Dcur}_{min}} \cdot {v}_{ref} + \\ 255 \cdot \frac{{L}_{cur} {F}_{cur}}{{L}_{ref} {F}_{ref}} \cdot \frac{{Dref}_{max} - {Dcur}_{min}}{{Dcur}_{max} - {Dcur}_{min}} \\ = a {v}_{ref} + b\end{matrix} & ( 14 )\end{matrix}$$

In the formula (14), Vref′ and Vref represent the disparity value of the prediction image of the parallax image after correction and the disparity value of the prediction image of the parallax image before correction, respectively. In addition, L_{cur} and L_{ref} represent the distance between cameras of the target parallax image to be encoded and the distance between cameras of the prediction image of the parallax image, respectively. F_{cur} and F_{ref} represent the focal distance of the target parallax image to be encoded and the focal distance of the prediction image of the parallax image, respectively. Dcurₘᵢₙ and Drefₘᵢₙ represent the minimum disparity value of the target parallax image to be encoded and the minimum disparity value of the prediction image of the parallax image, respectively. Dcurₘₐₓ and Drefₘₐₓ represent the maximum disparity value of the target parallax image to be encoded and the maximum disparity value of the prediction image of the parallax image, respectively.

The depth correction unit 341 generates a and b of the formula (14) as the correction coefficients for disparity values. The correction coefficient a represents a weighting coefficient (disparity weighting coefficient) of the disparity and the correction coefficient b represents an offset (disparity offset) of the disparity. The depth correction unit 341 calculates the pixel value of the prediction image of the corrected depth image using the disparity weighting coefficient and the disparity offset based on the above-described formula (14).

Here, the process is a weighting prediction process using the disparity weighting coefficient as the depth weighting coefficient and the disparity offset as the depth offset, used to normalize the disparity as the pixel value of the parallax image which is the depth image as a target, based on the disparity range indicating the range of the disparity. Here, the process is appropriately described as the depth weighting prediction process.

On the other hand, in Step S331, when it is determined that the pixel value of the target depth image to be processed is not the disparity value, the process proceeds to Step S333. In Step S333, the correction coefficient for the position (distance) in the depth direction is calculated. The correction coefficient for the position (distance) in the depth direction can be acquired by the following formula (15).

$$\begin{matrix}[ Expression 12 ] & \\ \begin{matrix}{v}_{ref}^{′} = \frac{\frac{1}{{Zref}_{near}} - \frac{1}{{Zref}_{far}}}{\frac{1}{{Zcur}_{near}} - \frac{1}{{Zcur}_{far}}} \cdot {v}_{ref} + 255 \cdot \frac{\frac{1}{{Zref}_{far}} - \frac{1}{{Zcur}_{far}}}{\frac{1}{{Zcur}_{near}} - \frac{1}{{Zcur}_{far}}} \\ = a {v}_{ref} + b\end{matrix} & ( 15 )\end{matrix}$$

In the formula (15), Vref′ and Vref represent the pixel value of the prediction image of the depth image after correction and the pixel value of the prediction image of the depth image before correction, respectively. In addition, Zcurₙₑₐᵣ and Zrefₙₑₐᵣ represent the position of the subject in the depth direction, which is positioned nearest to the target depth image to be encoded (the minimum value Znear) and the position of the subject in the depth direction, which is positioned nearest to the prediction image of the depth image (the minimum value Znear), respectively. Zcur_{far} and Zref_{far} represent the position of the subject in the depth direction, which is positioned farthest from the target depth image to be encoded (maximum value Zfar) and the position of the subject in the depth direction, which is positioned farthest from the prediction image of the depth image (maximum value Zfar), respectively.

The depth correction unit 341 generates a and b of the formula (15) as the correction coefficients for the position in the depth direction. The correction coefficient a represents the weighting coefficient of the depth value (depth weighting coefficient) and the correction coefficient b represents the offset in the depth direction (depth offset). The depth correction unit 341 calculates the pixel value of the prediction image of the depth image after correction from the depth weighting coefficient and the depth offset based on the formula (15).

The process herein is the weighting prediction process using the depth weighting coefficient as a depth weighting coefficient and the depth offset as a depth offset based on the depth range used to normalize the depth value as the pixel value of the depth image of the depth image as a target depth image. Here, the process is written as the depth weighting prediction process.

In this way, the correction coefficient is calculated using a formula which varies depending on whether the pixel value of the target depth image to be processed is the disparity value (D) or the depth value 1/Z representing the position (distance) (Z) in the depth direction. The correction coefficient is used to calculate the corrected prediction image temporarily. The reason why the term “temporarily” is used here is because the correction of the luminance value is performed at the subsequent stage. When the correction coefficient is calculated in this way, the process proceeds to Step S334.

When the correction coefficient is calculated in this way, the setting unit 344 generates information indicating that the correction coefficient for the disparity value is calculated or the correction coefficient for the position (distance) in the depth direction is calculated, and transmits the information to the decoding side through the slice header encoding unit 302.

In other words, the setting unit 344 determines that the depth weighting prediction process is performed based on the depth range used to normalize the depth value representing the position (distance) in the depth direction or the depth weighting prediction process is performed based on the disparity range used to normalize the disparity value, and sets depth identification data identifying which prediction process is performed based on the determination, and then the depth identification data is transmitted to the decoding side.

The depth identification data is set by the setting unit 344 and included in the slice header by the slice header encoding unit 302 to be sent. When such depth identification data can be shared by the encoding side and the decoding side, it is possible to determine that the depth weighting prediction process is performed based on the depth range used to normalize the depth value representing the position (distance) in the depth direction or the depth weighting prediction process is performed based on the disparity range used to normalize the disparity value representing the disparity by referencing the depth identification data in the decoding side.

Further, the correction coefficient may not be calculated depending on the type of slice after whether or not the correction coefficient is to be calculated is determined depending on the type of slice. Specifically, when the type of slice is a P slice, an SP slice, or a B slice, the correction coefficient is calculated (the depth weighting prediction process is performed), and when the type of slice is another slice, the correction coefficient may not be calculated.

In addition, since one picture is formed of plural slices, the configuration which determines whether or not the correction coefficient is calculated depending on the type of slice may be set to the configuration which determines whether or not the correction coefficient is calculated depending on the type of picture (picture type). For example, when the picture type is a B picture, the correction coefficient may not be calculated. Here, the description will be continued under the assumption that whether or not the correction coefficient is to be calculated is determined depending on the type of slice.

When the depth weighting prediction process is performed in the case of the P slice and SP slice, the setting unit 344 sets, for example, depth_weighted_pred_flag to 1, and when the depth weighting prediction process is not performed, the setting unit 344 sets depth_weighted_pred_flag to 0. The depth_weighted_pred_flag may be easily transmitted by being included in the slice header by the slice header encoding unit 302.

In addition, when the depth weighting prediction process is performed in the case of the B slice, the setting unit 344 sets, for example, depth_weighted_bipred_flag to 1, and when the depth weighting prediction process is not performed (depth weighting prediction process is skipped), the setting unit 344 sets depth_weighted_bipred_flag to 0. The depth_weighted_bipred_flag may be easily transmitted by being included in the slice header by the slice header encoding unit 302.

As described above, it may be determined whether the correction coefficient is necessary to be calculated by referencing depth_weighted_pred_flag or depth_weighted_bipred_flag in the decoding side. In other words, whether or not the correction coefficient is to be calculated is determined depending on the type of slice in the decoding side, so that a process of controlling the correction coefficient not to be calculated depending on the type of slice can be performed.

In Step S334, a luminance correction coefficient is calculated by a luminance correction unit 342. The luminance correction coefficient, for example, can be calculated by applying the luminance correction in the AVC method. The luminance correction in the AVC method is corrected by performing the weighting prediction process using the weighting coefficient and the offset in the same manner as the above-described depth weighting prediction process.

That is, the prediction image corrected by the depth weighting prediction process is generated and the prediction image (depth prediction image) used to encode the depth image is generated by performing the weighting prediction process for correcting the luminance value on the corrected prediction image.

In the case of the luminance correction coefficient, data for identifying the case in which the correction coefficient is calculated and the case in which the correction coefficient is not calculated is set, and then the data may be transmitted to the decoding side. For example, in the P slice and the SP slice, when the correction coefficient of the luminance value is calculated, for example, weighted_pred_flag is set to 1, and when the correction coefficient of the luminance value is not calculated, weighted_pred_flag is set to 0. The weighted_pred_flag may be transmitted by being included in the slice header by the slice header encoding unit 302.

In addition, when the correction coefficient of the luminance value is calculated in the case of the B slice, for example, weighted_bipred_flag is set to 1, and when the correction coefficient of the luminance value is not calculated, weighted_bipred_flag is set to 0. The weighted_bipred_flag may be transmitted by being included in the slice header by the slice header encoding unit 302.

In Step S332 or Step S333, a process of correcting deviation of the luminance is performed in Step S334 after the deviation of normalization is corrected and the effect of converting to the same coordinate system is acquired. When a process of correcting the deviation of normalization is performed after the luminance is corrected, the deviation of normalization may not be appropriately corrected because the relationship between the minimum value Znear and the maximum value Zfar is broken. Therefore, the deviation of normalization is corrected in advance and then the deviation of luminance is corrected.

In addition, the description is made that the depth weighting prediction process correcting the deviation of normalization and the weighting prediction process correcting the luminance value are performed, but it is possible to configure only one of the prediction processes to be performed.

In this way, when the correction coefficient is calculated, the process proceeds to Step S335. The prediction image is generated by the luminance correction unit 342 in Step S335. The generation of the prediction image has already been described, so the description thereof will not be repeated. Further, the depth image is encoded using the generated depth prediction image and the encoded data (depth stream) is generated to be transmitted to the decoding side.

The decoding apparatus receiving the generated image in this way is described.

### [Configuration of Slice Decoding Unit]

FIG. 36 is a diagram in which the slice header decoding unit 173 and the slice decoding unit 174 (FIG. 16) constituting the multi-viewpoint image decoding unit 151 (FIG. 15) are extracted. In FIG. 36, description will be made by imparting different encodings in order to distinguish the slice header decoding unit and the slice decoding unit from the slice header decoding unit 173 and the slice decoding unit 174 of FIG. 16, but the basic processes are the same as those of the slice header decoding unit 173 and the slice decoding unit 174 shown in FIG. 5, so the description will not be repeated.

A slice decoding unit 552 decodes the encoded data of the multiplexed color image in a slice unit using a method corresponding to the encoding method in the slice encoding unit 301 (FIG. 24) based on information other than the information related to the distance between cameras, the maximum disparity value, and the minimum disparity value of the SPS, the PPS, and the slice header supplied from the slice header decoding unit 551.

In addition, the slice decoding unit 552 decodes the encoded data of the multiplexed parallax image (multiplexed depth image) in a slice unit with a method corresponding to the encoding method in the slice encoding unit 301 (FIG. 24) based on information other than the information related to the distance between cameras, the maximum disparity value, and the minimum disparity value of the SPS, the PPS, and the slice header; the distance between cameras; the maximum disparity value; and the minimum disparity value. The slice decoding unit 552 supplies the multi-viewpoint correction color image and the multi-viewpoint parallax image obtained from the decoding to the viewpoint composition unit 152 of FIG. 15.

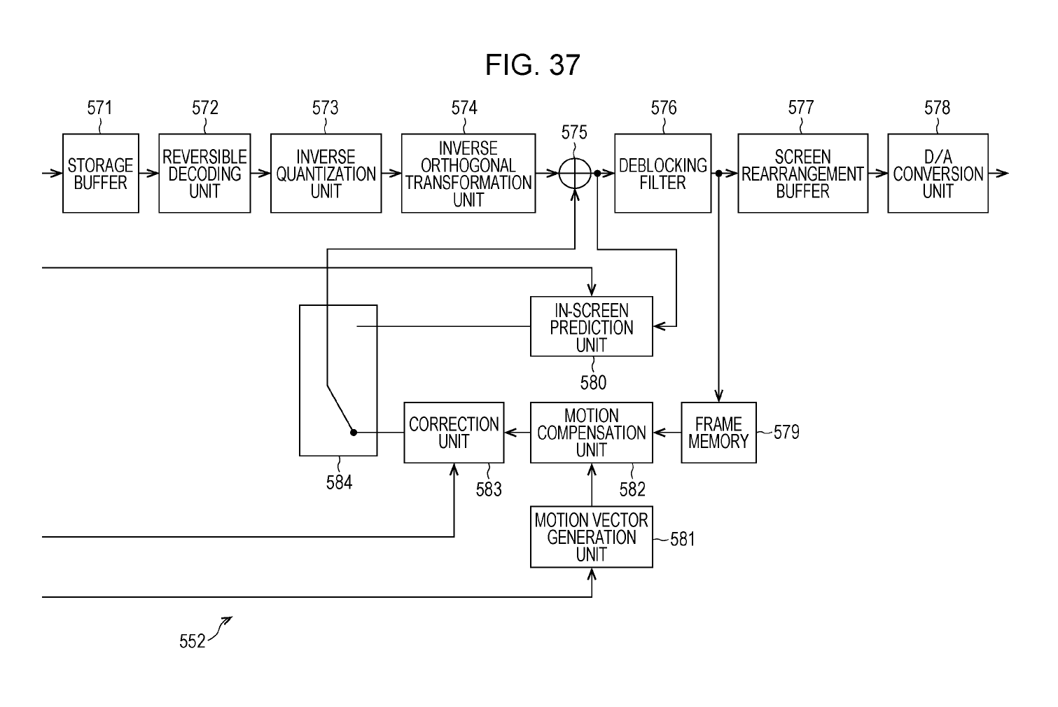

FIG. 37 is a block diagram illustrating the configuration example of the decoding unit which decodes the depth image having one optional viewpoint among the slice decoding unit 552 of FIG. 35. That is, the decoding unit which decodes the multi-viewpoint parallax image among the slice decoding unit 532 is formed of the slice decoding unit 552 of FIG. 37 having plural viewpoints.

The slice decoding unit 552 of FIG. 37 is formed of a storage buffer 571, a reversible decoding unit 572, an inverse quantization unit 573, an inverse orthogonal transformation unit 574, an addition unit 575, a deblocking filter 576, a screen rearrangement buffer 577, a D/A conversion unit 578, a frame memory 579, an in-screen prediction unit 580, a motion vector generation unit 581, a motion compensation unit 582, a correction unit 583, and a switch 584.

The slice decoding unit 552 shown in FIG. 37 has the same configuration as the decoding unit 250 shown in FIG. 17. That is, the storage buffer 571 to the switch 584 of the slice decoding unit 552 shown in FIG. 37 respectively have the same functions as those of the storage buffer 251 to the switch 534 shown in FIG. 17. Accordingly, the detailed description will not be repeated here.

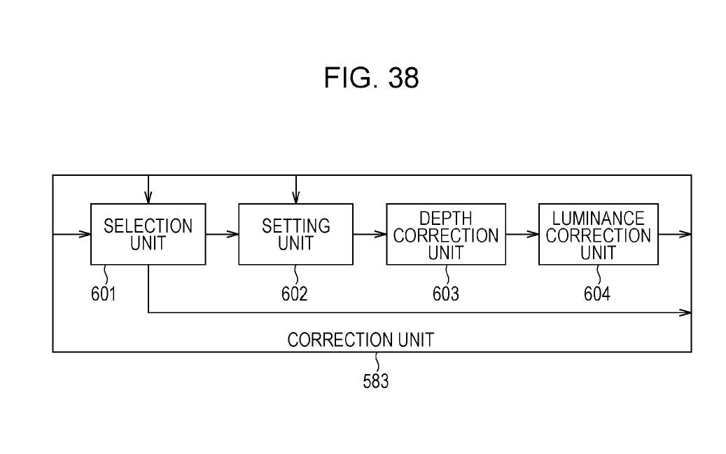

The slice decoding unit 552 shown in FIG. 37 has the same configuration as the decoding unit 250 shown in FIG. 17, but the internal configuration of the correction unit 583 is different from that of the correction unit 263 shown in FIG. 17. The configuration of the correction unit 583 is shown in FIG. 38.

The correction unit 583 shown in FIG. 38 is formed of a selection unit 601, a setting unit 602, a depth correction unit 603, and a luminance correction unit 604. The process performed by these units will be described with reference to the flowchart.

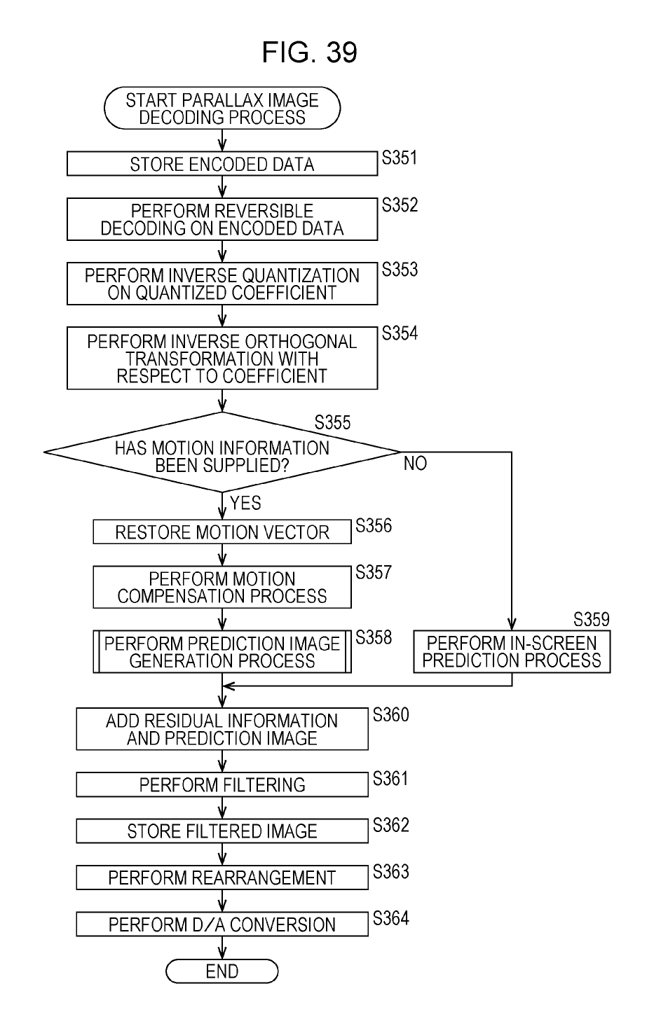

FIG. 39 is a flowchart for describing a process related to the decoding process of the depth image. That is, in the process of the above-described encoding side, a process performed in the receiving side of the depth stream of the depth image having a predetermined viewpoint encoded using the depth prediction image of the depth image having a predetermined viewpoint corrected using the information related to the depth image having a predetermined viewpoint and the information related to the depth image having a predetermined viewpoint will be described.

FIG. 39 is a flowchart describing details of the parallax image decoding process of the slice decoding unit 552 shown in FIGS. 36 to 38. The parallax image decoding process is performed for each viewpoint.

The slice decoding unit 552 shown in FIG. 39 has basically the same configuration as the slice decoding unit 174 shown in FIGS. 16 and 17, but the description is made that the internal configuration of the correction unit 583 is different. Accordingly, the process other than the process performed by the correction unit 583 is basically performed by the same process as that of the slice decoding unit 532 shown in FIGS. 16 and 17, that is, the same process as that of the flowchart shown in FIG. 20. Here, the description of the repetitive parts described in the flowchart shown in FIG. 20 will not be repeated.

The processes of Steps S351 to S357 and Steps S359 to S364 of FIG. 39 are performed as the same processes of Steps S261 to S267 and Steps S270 to S275 of FIG. 20. That is, in regard to the prediction image generation process performed in Step S358, basically the same process is performed except that the process is different from the process of the flowchart shown in FIG. 20.

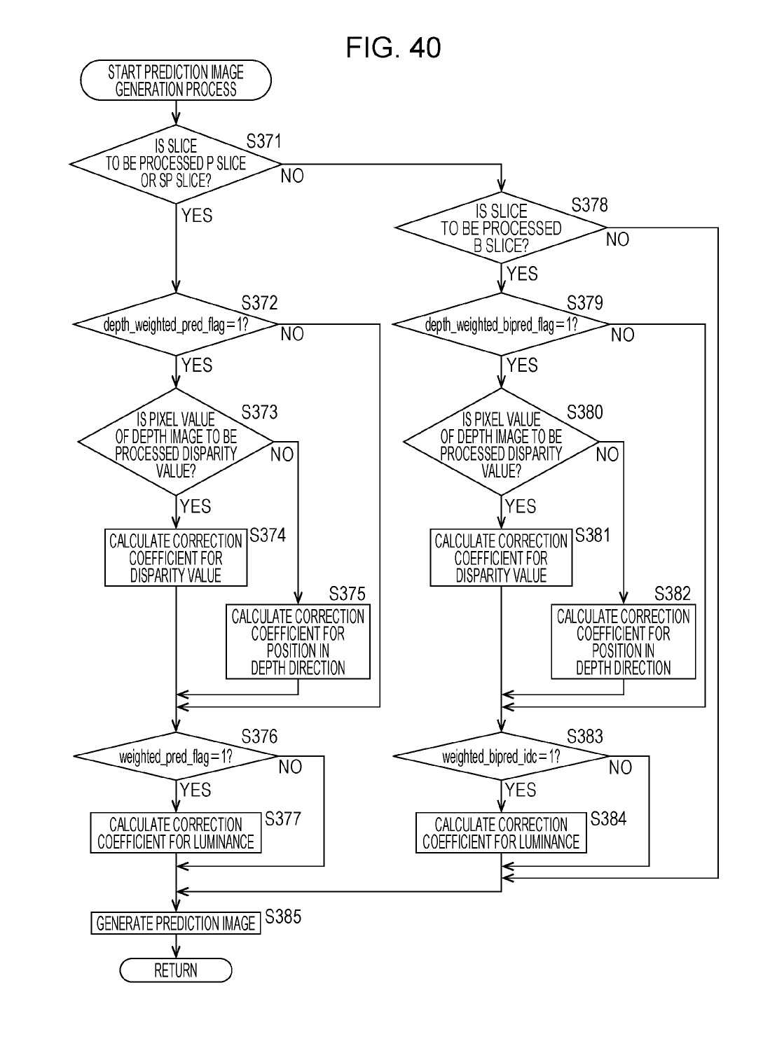

Here, the prediction image generation process performed in Step S358 will be described with reference to the flowchart of FIG. 40.

In Step S371, it is determined that the target slice to be processed is the P slice or the SP slice. In Step S371, when it is determined that the target slice to be processed is the P slice or the SP slice, the process proceeds to Step S372. In Step S372, it is determined whether or not depth_weighted_pred_flag is 1.

When it is determined that depth_weighted_pred_flag is 1 in Step S372, the process proceeds to Step S373, and when it is determined that depth_weighted_pred_flag is not 1 in Step S372, the processes of Steps S373 to S375 are skipped, and then the process proceeds to Step S376.

In Step S373, it is determined whether the pixel value of the target depth image to be processed is the disparity value. In Step S373, when it is determined that the pixel value of the target depth image to be processed is the disparity value, the process proceeds to Step S374.

In Step S374, the correction coefficient for the disparity value is calculated by the depth correction unit 603. The depth correction unit 603 calculates the correction coefficient (disparity weighting coefficient and disparity offset) in the same manner as that of the depth correction unit 341 of FIG. 26 based on the maximum disparity value, the minimum disparity value, and the distance between cameras. When the correction coefficient is calculated, the corrected prediction image is temporarily calculated. The reason why the term “temporarily” is used here is because the prediction image is not the final prediction image used for decoding since the luminance value is corrected in the subsequent process in the same manner as that of the encoding side.

On the other hand, in Step S373, when it is determined that the pixel value of the target depth image to be processed is not the disparity value, the process proceeds to Step S375. In this case, since the pixel value of the target depth image to be processed is the depth value representing the position (distance) in the depth direction, in Step S375, the depth correction unit 603 calculates the correction coefficient (depth weighting coefficient and depth offset) based on the maximum value and the minimum value for the position (distance) in the depth direction in the same manner as that of the depth correction unit 341 of FIG. 26. When the correction coefficient is calculated, the corrected prediction image is temporarily calculated. The reason why the term “temporarily” is used here is because the prediction image is not the final prediction image used for decoding since the luminance value is corrected in the subsequent process in the same manner as that of the encoding side.

When the correction coefficient is calculated in Step S374 or Step S375 or when it is determined that depth_weighted_pred_flag is not 1 in Step S372, the process proceeds to Step S376.

In Step S376, it is determined whether or not weighted_pred_flag is 1. In Step S376, when it is determined that weighted_pred_flag is 1, the process proceeds to Step S377. In Step S377, the luminance correction coefficient is calculated by the luminance correction unit 604. The luminance correction unit 604 calculates the luminance correction coefficient calculated based on a predetermined method in the same manner as that of the luminance correction unit 342 of FIG. 26. The prediction image in which the luminance value is corrected is calculated using the calculated correction coefficient.

In this way, when the luminance correction coefficient is calculated or when it is determined that weighted_pred_flag is not 1 in Step S376, the process proceeds to Step S385. In Step S385, the calculated correction coefficient is used to generate the prediction image.

On the other hand, in Step S371, when it is determined that the target slice to be processed is not the P slice or the SP slice, the process proceeds to Step S378 and it is determined whether or not the target slice to be processed is the B slice. In Step S378, when it is determined that the target slice to be processed is the B slice, the process proceeds to Step S379, and when it is determined that the target slice to be processed is not the B slice, the process proceeds to Step S385.

In Step S379, it is determined whether or not depth_weighted_bipred_flag is 1. In Step S379, when it is determined that depth_weighted_bipred_flag is 1, the process proceeds to Step S380 and when it is determined that depth_weighted_bipred_flag is not 1, the processes of Steps S380 to S382 are skipped, and the process proceeds to Step S383.

In Step S380, it is determined whether the pixel value of the target depth image to be processed is the disparity value. In Step S380, when it is determined that the pixel value of the target depth image to be processed is the disparity value, the process proceeds to Step S381 and the correction coefficient for the disparity value is calculated by the depth correction unit 603. The depth correction unit 603 calculates the correction coefficient based on the maximum disparity value, the minimum disparity value, and the distance between cameras in the same manner as that of the depth correction unit 341 of FIG. 26. The calculated correction coefficient is used to calculate the corrected prediction image.

On the other hand, in Step S380, when it is determined that the pixel value of the target depth image to be processed is not the disparity value, the process proceeds to Step S382. In this case, since the pixel value of the target depth image to be processed is the depth value representing the position (distance) in the depth direction, in Step S382, the depth correction unit 603 calculates the correction coefficient based on the maximum value and the minimum value for the position (distance) in the depth direction in the same manner as that of the depth correction unit 341 of FIG. 26. The calculated correction coefficient is used to calculate the corrected prediction image.

When the correction coefficient is calculated in Step S381 or S382 or when it is determined that depth_weighted_bipred_flag is not 1 in Step S379, the process proceeds to Step S383.

In Step S383, it is determined whether or not weighted_bipred_idc is 1. In Step S383, when it is determined that weighted_bipred_idc is 1, the process proceeds to Step S383. In Step S383, the luminance correction coefficient is calculated by the luminance correction unit 604. The luminance correction unit 604 calculates the luminance correction coefficient calculated based on the predetermined method such as the AVC method in the same manner as the luminance correction unit 342 of FIG. 26. The calculated correction coefficient is used to calculate the prediction image in which the luminance value is corrected.

In this way, when the luminance correction coefficient is calculated, in a case in which it is determined that weighted_bipred_idc is not 1 in Step S383, or it is determined that the target slice to be processed is not the B slice in Step S378, the process proceeds to Step S385. In Step S385, the calculated correction coefficient is used to generate a prediction image.

In this way, when the prediction image generation process is performed in Step S358 (FIG. 39), the process proceeds to Step S360. The process after Step S360 is performed in the same manner as the process after Step S271 of FIG. 20 and the description thereof has already been made, so the description herein will not be repeated.

When the correction coefficient for the disparity value and the correction coefficient for the position (distance) in the depth direction are respectively calculated when the pixel value of the target depth image to be processed is the disparity value and when the pixel value of the target depth image to be processed is not the disparity value, it is possible to appropriately respond to the case in which the prediction image is generated from the disparity value and the case in which the prediction image is generated from the depth value representing the position in the depth direction, and therefore the correction coefficient can be appropriately calculated. In addition, the luminance correction can be appropriately performed by calculating the luminance correction coefficient.

Here, the description is already made that the correction coefficient for the disparity value and the correction coefficient for the position (distance) in the depth direction are calculated respectively when the pixel value of the target depth image to be processed is the disparity value and when the pixel value of the target depth image to be processed is not the disparity value (when the pixel value is the depth value). However, only either one may be calculated. For example, when the correction coefficient for the disparity value is set to be calculated using the disparity value as the pixel value of the target depth image to be processed in the encoding side and the decoding side, only the correction coefficient for the disparity value may be calculated. Further, for example, when the correction coefficient for the position (distance) in the depth direction is set to be calculated using the depth value representing the position (distance) in the depth direction as the pixel value of the target depth image to be processed in the encoding side and the decoding side, only the correction coefficient for the position (distance) in the depth direction may be calculated.

### [In Regard to Arithmetic Precision 1]

As described above, the encoding side calculates, for example, the correction coefficient for the position in the depth direction in Step S333 (FIG. 35) and the decoding side calculates, for example, the correction coefficient for the position in the depth direction in Step S375 (FIG. 40). The encoding side and the decoding side each calculate the correction coefficient for the position in the depth direction, but when the correction coefficients being calculated are not the same as each other, prediction images which are different from each other are generated, so the same correction coefficients are necessarily calculated in the encoding side and the decoding side. In other words, in the encoding side and the decoding side, it is necessary for the arithmetic precision to be the same.

Further, description will be continued with the example of the correction coefficient for the position (distance) in the depth direction and this applies to the correction coefficient for the disparity value in the same way.

Here, the formula (15) used to calculate the correction coefficient for the position in the depth direction will be shown as the formula (16) again.

$$\begin{matrix}[ Expression 13 ] & \\ \begin{matrix}{v}_{ref}^{′} = \frac{\frac{1}{{Zref}_{near}} - \frac{1}{{Zref}_{far}}}{\frac{1}{{Zcur}_{near}} - \frac{1}{{Zcur}_{far}}} \cdot {v}_{ref} + 255 \cdot \frac{\frac{1}{{Zref}_{far}} - \frac{1}{{Zcur}_{far}}}{\frac{1}{{Zcur}_{near}} - \frac{1}{{Zcur}_{far}}} \\ = a {v}_{ref} + b\end{matrix} & ( 16 )\end{matrix}$$

The part of the correction coefficient a of the formula (16) will be represented by the following formula (17).

$$\begin{matrix}[ Expression 14 ] & \\ \begin{matrix}a = \frac{\frac{1}{{Zref}_{near}} - \frac{1}{{Zref}_{far}}}{\frac{1}{{Zcur}_{near}} - \frac{1}{{Zcur}_{far}}} \\ = \frac{A - B}{C - D}\end{matrix} & ( 17 )\end{matrix}$$

A, B, C, and D in the formula (17) are values represented by the fixed point, so they can be calculated by the following formula (18).

A=INT({1<<shift}/Zrefₙₑₐᵣ)

B=INT({1<<shift}/Zref_{far})

C=INT({1<<shift}/Zcurₙₑₐᵣ)

D=INT({1<<shift}/Zcur_{far}) (18)

In the formula (17), A represents (1/Zrefₙₑₐᵣ), but it is possible for (1/Zrefₙₑₐᵣ) to be a value including a value after the decimal point. For example, when a process of rounding off the value after the decimal point is performed if the value after the decimal point is included, the arithmetic precision may vary in the encoding side and the decoding side according to the value after the rounded-off decimal point.

For example, when the integer part is a high value, the ratio of the value after the decimal point in the total number is small if the value after the decimal point is rounded off, so that an error of the arithmetic precision is not considerable, but when the integer part is a small value, for example, when the integer part is 0, the value after the decimal point becomes important, so it is possible for an error in the arithmetic precision to be made when the value after the decimal point is rounded off.

Here, as described above, it is possible to cause the value after the decimal point not to be rounded off when the value after the decimal point is important, by the fixed point representation. In addition, the above-described A, B, C, and D are represented by the fixed point and the correction coefficient a being calculated from these values is regarded as a value such that the following formula (19) is satisfied.

a={(A−B)<<denom}/(C−D) (19)

In the formula (19), luma_log 2_weight_denom defined by AVC can be used as denom.

For example, when the value of 1/Z is 0.12345 and the value is treated as an integer by rounding off to INT after performing Mbit shift, the formula will be as follows. 0.12345→x1000INT (123.45)=123

In this case, the integer value of 123 is used as the value of 1/Z by calculating INT of 123.45 as the value in which 1000 is multiplied. In addition, when the information of ×1000 is shared in the encoding side and the decoding side in this case, it is possible to match the arithmetic precision.

Further, when a floating point is included, the value is converted to a fixed point and then further converted to an integer from the fixed point. The fixed point is represented by, for example, an integer Mbit and a decimal Nbit, and M and N are set by the standard. In addition, an integer is represented by, for example, an integer part N digit and a decimal part M digit and then represented by an integer value a and a decimal value b. For example, in a case of 12.25, N=4, M=2, a=1100, and b=0.01 are satisfied. In addition, (a<<M+b)=110001 is satisfied in this case.

In this way, the part of the correction coefficient a can be calculated based on the formulae (18) and (19). In addition, the values of shift and denom are shared in the encoding side and the decoding side, and it is possible to match the arithmetic precision in the encoding side and the decoding side. As the common method, it can be implemented by supplying the values of shift and denom to the encoding side and the decoding side. In addition, it can be implemented by setting the values of shift and denom to be the same as each other in the encoding side and the decoding side, in other words, by setting the values to be fixed values.

Here, the description is made with the example of the part of the correction coefficient a, but the part of the correction coefficient b may be calculated in the same manner. Further, the above-described shift may be set to equal to or more than the precision of the position Z. That is, the value multiplied by the shift may be set to be greater than the value of the position Z. In other words, the precision of the position Z may be set to be equal to or less than the precision of the shift.

Further, when shift or denom is sent, it may be sent together with depth_weighted_pred_flag. Here, the correction coefficients a and b, that is, it is described that the weighting coefficient and the offset of the position Z are shared by the encoding side and the decoding side, but the arithmetic order may be set to be shared in the encoding side and the decoding side.

The setting unit which sets the arithmetic precision may be included in the depth correction unit 341 (FIG. 26). In this case, the depth correction unit 341 may set the arithmetic precision used for the arithmetic operation using the depth image as a target when the depth weighting prediction process is performed using the depth weighting coefficient and the depth offset. Further, as described above, the depth correction unit 341 performs the depth weighting prediction process on the depth image in conformity with the set arithmetic precision and may generate the depth stream by encoding the depth image using the depth prediction image obtained from the result.

When the order of the arithmetic operation varies, since the same correction coefficient may not be possibly calculated, the order of the arithmetic operation may be shared in the encoding side and the decoding side. In addition, the way of the sharing is the same as the case described above, and the order of the arithmetic operation may be shared by being sent or by being set as a fixed value.

In addition, the shift parameter representing the shift amount of the shift arithmetic operation is set and the set shift parameter may be sent or received together with the generated depth stream. The shift parameter may be fixed in a sequence unit and variable in a GOP, Picture, or Slice unit.

### [In Regard to Arithmetic Precision 2]

When the part of the correction coefficient a in the above-described formula (16) is transformed, the correction coefficient a can be represented by the following formula (20).

$$\begin{matrix}[ Expression 15 ] & \\ a = \frac{( {Zref}_{far} - {Zref}_{near} ) ( {Zcur}_{near} * {Zcur}_{far} )}{( {Zcur}_{far} - {Zcur}_{near} ) ( {Zref}_{near} * {Zref}_{far} )} & ( 20 )\end{matrix}$$

In the formula (20), the numerator of (Zcurₙₑₐᵣ×Zcur_{far}) and the denominator of (Zrefₙₑₐᵣ×Zref_{far}) may overflow because Zs are multiplied. For example, when the upper limit is set to 32 bit and denom is set to 5, since 27 bit remains, 13 bit×13 bit becomes the limit when such a setting is done. Accordingly, in this case, for example, values departing from the range of ±4096 may not be used as the value of Z, but it is assumed that, for example, a value of 10000 which is greater than 4096 is used as the value of Z.

Therefore, the part of Z×Z is controlled so as not to overflow and the correction coefficient a is calculated by setting the value of Z to be satisfied by the following formula (21) when the correction coefficient a is calculated with the formula (20) in order to widen the range of the value of Z.

Znear=Znear<<x

Zfar=Zfar<<y (21)

In order to satisfy the formula (21), the precisions of Znear and Zfar are reduced by shift and controlled so as not to overflow.

The shift amount such as x or y is the same as in the case described above, and may be shared in the encoding side and the decoding side by being transmitted and also may be shared in the encoding side and the decoding side as a fixed value.

The information used for the correction coefficients a and b and the information related to the precision (shift amount) may be included in the slice header or an NAL (Network Abstraction Layer) unit such as SPS or PPS.

### Second Embodiment

### Description of Computer to which the Present Technology is Applied

Next, the above-described series of processes may be performed by hardware or software. When these series of processes are performed by software, the program constituting the software is installed in a general computer or the like.

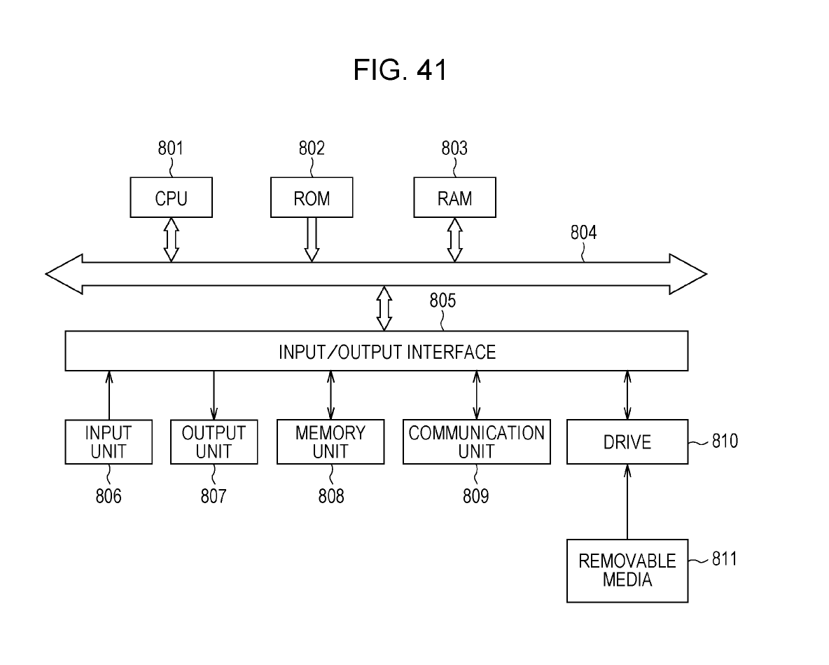

Here, FIG. 41 illustrates the configuration example of an embodiment of the computer in which the program operating the above-described series of processes is installed.

The program can be stored in a memory unit 808 or ROM (Read Only Memory) 802 in advance as a recording medium included in a computer.

Alternatively, the program can be stored (recorded) in a removable media 811. Such a removable media 811 can be provided as so-called package software. Here, examples of the removable media 811 include a floppy disk, a CD-ROM (Compact Disc Read Only Memory), an MO (Magneto Optical) disk, a DVD (Digital Versatile Disc), a magnetic disk, and a semiconductor memory.

Further, the program can be installed in the computer from the above-described removable media 811 through a drive 810 or can be installed in the memory unit 808 included in the computer by downloading the program in the computer through a communication network or a broadcasting network. That is, the program can be transmitted to the computer through an artificial satellite for digital satellite broadcasting in a wireless manner from a download site or can be transmitted to the computer through a network such as a LAN (Local Area Network) or the Internet in a wired manner.

The computer includes a CPU (Central Processing Unit) 801 and the CPC 801 is connected to an input/output interface 805 through a bus 804.

The CPU 801 performs the program stored in the ROM 802 when a command is input by the operation of an input unit 806 or the like by a user through the input/output interface 805. Alternatively, the CPU 801 performs the program stored in the memory unit 808 by loading the program in a RAM (Random Access Memory) 803.

In this way, the CPU 801 performs the process according to the above-described flowchart or the process performed by the configuration of the above-described block diagram. In addition, the CPU 801 outputs the process result from an output unit 807 or sends the result from a communication unit 809 or stores the result in the memory unit 808 through, for example, the input/output interface 805 as needed.

In addition, the input unit 806 is formed of a keyboard, a mouse, a microphone, and the like. Further, the output unit 807 is formed of an LCD (Liquid Crystal Display) or a speaker.

Here, the process performed according to the program by the computer in the present specification is not necessarily performed in chronological order according to the order described in the flowcharts. That is, the process performed according to the program by the computer includes a process (for example, a process performed by a parallel process or an object) performed in parallel or separately.

Further, the program may be processed by one computer (processor) or may be processed in distribution by plural computers. In addition, the program may be performed by being transferred to a remote computer.

The present technology may be applied to an encoding apparatus and a decoding apparatus which are used at the time of communicating through a network media such as satellite broadcasting, a cable TV (television), the Internet, and a cellular phone or to process on a storage media such as light, a magnetic disk, and a flash memory.

Further, the encoding apparatus and the decoding apparatus described above may be applied to an optional electronic device. Hereinafter, the examples will be described.

### Third Embodiment

### Configuration Example of Television Apparatus

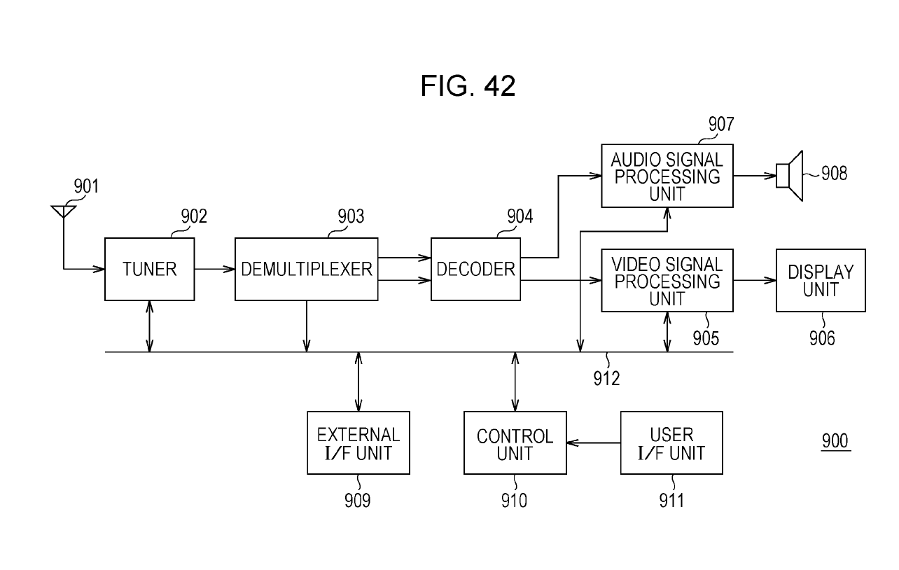

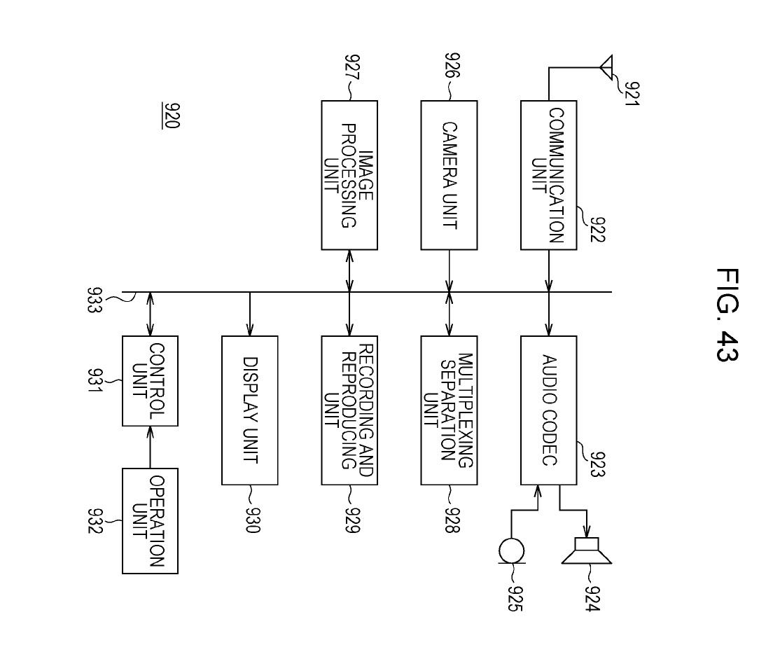

FIG. 42 schematically illustrates an example of the configuration of the television apparatus to which the present technology is applied. A television apparatus 900 includes an antenna 901, a tuner 902, a demultiplexer 903, a decoder 904, a video signal processing unit 905, a display unit 906, an audio signal processing unit 907, a speaker 908, and an external interface unit 909. Further, the television apparatus 900 includes a control unit 910, a user interface unit 911, and the like.

The tuner 902 performs demodulation by selecting a desired channel from the broadcasting signal received by the antenna 901, and the obtained encoded bit stream is output to the demultiplexer 903.

The demultiplexer 903 extracts a packet of the video or audio of a target program to be viewed from the encoded bit stream and the data of the extracted packet is output to the decoder 904. Further, the demultiplexer 903 supplies the packet of data such as an EPG (Electronic Program Guide) or the like to the control unit 910. In addition, when scramble is performed, the scramble is released by the multiplexer or the like.

The decoder 904 performs the decoding process of the packet, outputs video data generated by the decoding process to the video signal processing unit 905, and outputs audio data to the audio signal processing unit 907.

The video signal processing unit 905 performs video processing or the like on video data according to noise elimination or a user setting. The video signal processing unit 905 generates image data or the like by the process based on the application supplied through the video data of the program which is displayed on the display unit 906 or through a network. In addition, the video signal processing unit 905 generates video data for displaying a menu screen or the like to select items or the like and the video data is superposed on the video data of the program. The video signal processing unit 905 drives the display unit 906 by generating a driving signal based on the video data generated in this way.

The display unit 906 drives a display device (for example, a liquid crystal display element or the like) based on the driving signal from the video signal processing unit 905 and displays the video of the program or the like.

The audio signal processing unit 907 performs a predetermined process such as the noise elimination on the audio data, performs a D/A conversion process of the audio data after the process or an amplification process, and outputs the audio by supplying the data to the speaker 908.

The external interface unit 909 is an interface for connecting an external device or a network and performs transmitting or receiving data such as video data or audio data.

The user interface unit 911 is connected to the control unit 910. The user interface unit 911 is formed of an operation switch, a remote control signal receiving unit, and the like and supplies the operation signal according to user operation to the control unit 910.

The control unit 910 is formed with a CPU (Central Processing Unit), a memory, or the like. The memory stores the program performed by the CPU, various pieces of data necessary when the CPU performs a process, EPG data, and data acquired through the network. The program stored in the memory is performed by being read by the CPU at a predetermined timing, for example, at the time of starting the television apparatus 900 or the like. The CPU controls each unit such that the television apparatus 900 is operated according to the user operation by performing the program.

In addition, the television apparatus 900 is provided with a bus 912 for connecting the control unit 910 with the tuner 902, the demultiplexer 903, the video signal processing unit 905, the audio signal processing unit 907, or the external interface unit 909.

In the television apparatus formed in this way, the decoder 904 has a function of the decoding apparatus (decoding method) of the present application. For this reason, encoded data of a parallax image in which encoding efficiency is improved by being encoded using the information related to the parallax image can be decoded.

### Fourth Embodiment

### Configuration Example of Cellular Phone

FIG. 43 schematically illustrates an example of the configuration of a cellular phone to which the present technology is applied. A cellular phone 920 includes a communication unit 922, an audio codec 923, a camera unit 926, an image processing unit 927, a multiplexing separation unit 928, a recording and reproducing unit 929, a display unit 930, and a control unit 931. These are connected with each other through a bus 933.

Further, the communication unit 922 is connected with an antenna 921 and the audio codec 923 is connected with a speaker 924 and a microphone 925. In addition, the control unit 931 is connected with an operation unit 932.

The cellular phone 920 performs various operations such as transmitting or receiving an audio signal, electronic mail, or image data, photographing an image, or recording data in various modes such as a speech mode or a data communication mode.

In the speech mode, the audio signal generated by the microphone 925 is supplied to the communication unit 922 by performing conversion to the audio data or data compression by the audio codec 923. The communication unit 922 performs a modulation process or a frequency conversion process of the audio data and generates a transmission signal. In addition, the communication unit 922 supplies the transmission signal to the antenna 921 and then transmits the signal to a base station not shown in the figure. Further, the communication unit 922 performs the amplification process, the frequency conversion process, or the demodulation process of the reception signal received by the antenna 921 and supplies the obtained audio data to the audio codec 923. The audio codec 923 performs data expansion of the audio data or conversion to an analog audio signal and outputs the audio data to the speaker 924.

Further, in the data communication mode, when mail is transmitted, the control unit 931 receives character data input by the operation of the operation unit 932 and displays the input character on the display unit 930. In addition, the control unit 931 generates mail data based on a user instruction in the operation unit 932 supplies the mail data to the communication unit 922. The communication unit 922 performs the modulation process or the frequency conversion process of the mail data and transmits the obtained transmission signal from the antenna 921. In addition, the communication unit 922 performs the amplification process, the frequency conversion process, or the demodulation process of the reception signal received by the antenna 921 and restores the mail data. The mail data is supplied to the display unit 930 and the contents of the mail are displayed.

Further, the cellular phone 920 can store the received mail data in a storage medium by the recording and reproducing unit 929. The storage medium is an optional rewritable storage medium. For example, the storage medium is removable media such as a semiconductor memory, for example, a RAM or a built-in flash memory, a hard disk, a magnetic disk, a magneto optical disk, an optical disk, a USB memory, or a memory card.

When the image data is transmitted in the data communication mode, the image data generated from the camera unit 926 is supplied to the image processing unit 927. The image processing unit 927 performs the encoding process of the image data and generates encoded data.

The multiplexing separation unit 928 multiplexes the encoded data generated from the image processing unit 927 and the audio data supplied from the audio codec 923 using a predetermined method and supplies the multiplexed data to the communication unit 922. The communication unit 922 performs the modulation process or the frequency conversion process of the multiplexed data and transmits the obtained transmission signal from the antenna 921. Further, the communication unit 922 performs the amplification process, the frequency conversion process, or the demodulation process of the reception signal received by the antenna 921 and restores the multiplexed data. The multiplexed data is supplied to the multiplexing separation unit 928. The multiplexing separation unit 928 separates the multiplexed data and supplies the encoded data to the image processing unit 927 and the audio data to the audio codec 923. The image processing unit 927 performs the decoding process of the encoded data and generates image data. The image data is supplied to the display unit 930 and the received image is displayed. The audio codec 923 converts the audio data to the analog audio signal, supplies the signal to the speaker 924, and outputs the received audio.

In the cellular phone apparatus configured in this way, the image processing unit 927 has a function of the encoding apparatus and the decoding apparatus (encoding method and decoding method) of the present application. For this reason, it is possible to improve the encoding efficiency of the parallax image using the information related to the parallax image. In addition, the encoded data of the parallax image whose encoding efficiency is improved by being encoded using the information related to the parallax image can be decoded.

### Fifth Embodiment

### Configuration Example of Recording and Reproducing Apparatus

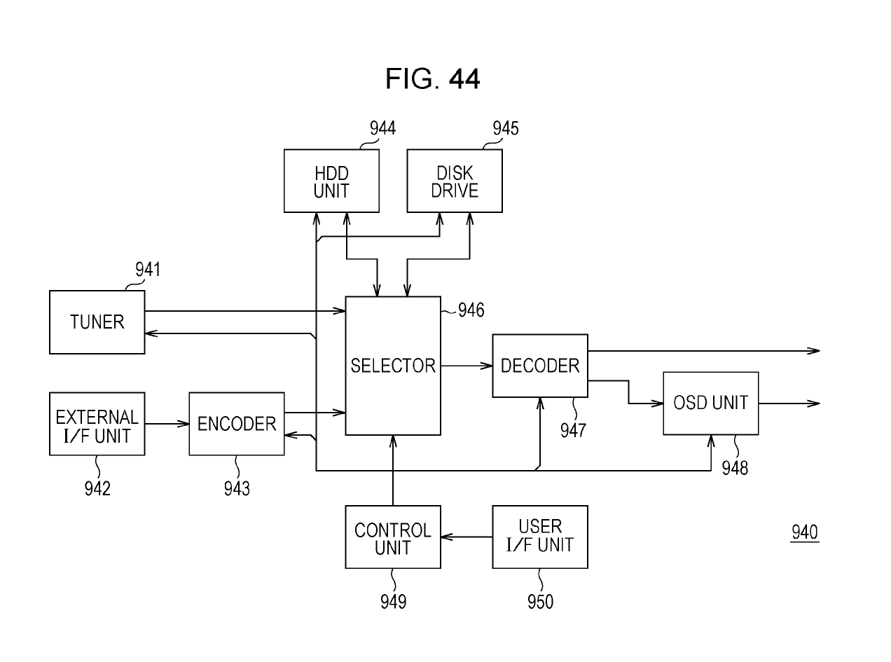

FIG. 44 schematically illustrates the configuration of a recording and reproducing apparatus to which the present technology is applied. The recording and the reproducing apparatus 940 records audio data and video data of a received broadcasting program in a recording medium and provides the recorded data to a user at a timing according to an instruction of the user. In addition, the recording and the reproducing apparatus 940 can acquire the audio data or the video data from other apparatuses and record the data in the recording medium. Further, the recording and reproducing apparatus 940 can display an image in a monitor apparatus or the like or output audio by decoding the audio data or the video data recorded in the recording medium to be output.

The recording and reproducing apparatus 940 includes a tuner 941, an external interface unit 942, an encoder 943, an HDD (Hard Disk Driver) unit 944, a disk drive 945, a selector 946, a decoder 947, an OSD (On-Screen Display) unit 948, a control unit 949, and a user interface unit 950.

The tuner 941 selects a desired channel from broadcasting signals received by an antenna not shown in the figure. The tuner 941 outputs the encoded bit stream obtained by demodulating the signal received from the desired channel to the selector 946.

The external interface unit 942 is formed of at least one of an IEEE1394 interface, a network interface unit, a USB interface, and a flash memory interface. The external interface unit 942 is an interface for being connected with an external device, a network, or a memory card and receives data such as the recorded video data or audio data.

The encoder 943 encodes the video data or the audio data when the data supplied from the external interface unit 942 is not encoded using a predetermined method and outputs the encoded bit stream to the selector 946.

The HDD unit 944 records content data such as video or audio, various programs, or other data in a built-in hard disk and reads the data from the hard disk at the time of reproducing.

The disk drive 945 records and reproduces a signal on an optical disk included therein. Examples of the optical disk include a DVD disk (DVD-video, DVD-RAM, DVD-R, DVD-RW, DVD+R, DVD+RW, and the like), a Blu-ray disk, and the like.

The selector 946 selects any one of the encoded bit streams from the tuner 941 or the encoder 943 at the time of recording video or audio and supplies the stream to either of the HDD unit 944 or the disk drive 945. In addition, the selector 946 supplies the encoded bit stream output from the HDD unit 944 or the disk drive 945 to the decoder 947.

The decoder 947 performs a decoding process of the encoded bit stream. The decoder 947 supplies the video data generated from the decoding process to the OSD unit 948. Further, the decoder 947 outputs the audio data generated from the decoding process.

The OSD unit 948 generates video data for displaying a menu screen or the like to select items or the like and outputs the video data by superposing on the video data output from the decoder 947.

The control unit 949 is connected to the user interface unit 950. The user interface unit 950 is formed of an operation switch, a remote control signal receiving unit, and the like and supplies the operation signal corresponding to the user operation to the control unit 949.

The control unit 949 is formed with a CPU, a memory, or the like. The memory stores the program performed by the CPU or various pieces of data which is necessary when the CPU performs a process. The program stored in the memory is performed by being read by the CPU at a predetermined timing, for example, at the time of starting the recording and reproducing apparatus 940. The CPU controls each unit such that the recording and reproducing unit 940 is operated according to the user operation by performing the program.

The recording and reproducing apparatus formed in this way has a function of the decoding apparatus (decoding method) of the present application in the decoder 947. For this reason, encoded data of the parallax image in which encoding efficiency is improved by being encoded using the information related to the parallax image can be decoded.

### Sixth Embodiment

### Configuration Example of Imaging Apparatus

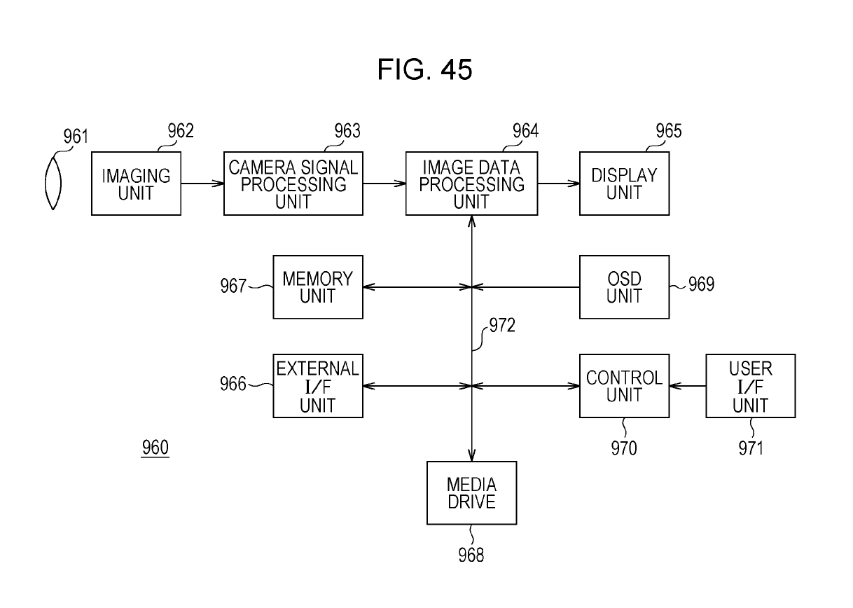

FIG. 45 schematically illustrates the configuration of an imaging apparatus to which the present technology is applied. An imaging apparatus 960 images a subject, displays the image of the subject on a display unit, and records the image as image data in a recording medium.

The imaging apparatus 960 includes an optical block 961, an imaging unit 962, a camera signal processing unit 963, an image data processing unit 964, a display unit 965, an external interface unit 966, a memory unit 967, a media drive 968, an OSD unit 969, and a control unit 970. In addition, a user interface unit 971 is connected to the control unit 970. Further, the image data processing unit 964, the external interface unit 966, the memory unit 967, the media drive 968, the OSD unit 969, and the control unit 970 are connected to one another through a bus 972.

The optical block 961 is formed with a focus lens or a diaphragm mechanism. The optical block 961 images an optical image of a subject on an imaging surface of the imaging unit 962. The imaging unit 962 is formed with a CCD or a CMOS image sensor and generates an electrical signal corresponding to the optical image by photoelectric conversion to be supplied to the camera signal processing unit 963.

The camera signal processing unit 963 performs a camera signal process such as knee correction, gamma correction, or color correction on the electrical signal supplied from the imaging unit 962. The camera signal processing unit 963 supplies the image data after the camera signal process to the image data processing unit 964.

The image data processing unit 964 performs the encoding process of the image data supplied from the camera signal processing unit 963. The image data processing unit 964 supplies the encoded data generated from the encoding process to the external interface unit 966 or the media drive 968. In addition, the image data processing unit 964 performs a decoding process of the encoded data supplied from the external interface unit 966 or the media drive 968. The image data processing unit 964 supplies the image data generated from the decoding process to the display unit 965. Further, the image data processing unit 964 supplies the image data supplied from the camera signal processing unit 963 to the display unit 965 and supplies the data for display which is acquired from the OSD unit 969 to the display unit 965 by superposing the data on the image data.

The OSD unit 969 generates data for display such as signals, characters, a menu screen with figures, or icons and outputs the data to the image data processing unit 964.

The external interface unit 966 is formed of a USB input/output terminal and connected to a printer when the printer prints an image. In addition, the external interface unit 966 is connected to a drive if necessary and includes removable media such as a magnetic disk, an optical disk, and the like, and the computer program read from the media is installed if necessary. In addition, the external interface unit 966 has a network interface to be connected to a predetermined network such as a LAN or the Internet. The control unit 970 follows the instruction from the user interface unit 971, reads the encoded data from the memory unit 967, and can supply the data to another apparatus connected through the network from the external interface unit 966. In addition, the control unit 970 acquires the encoded data or the image data supplied from another apparatus through the network using the external interface unit 966 and can supply the data to the image data processing unit 964.

As recording media driven by the media drive 968, for example, optional read/write removable media such as a magnetic disk, a magneto optical disk, an optical disk, or a semiconductor memory may be used. Further, the types of recording media as the removable media are optional, so the type may be a tape device, a disk, or a memory card. A noncontact IC card may be used as well.

Moreover, the media drive 968 and the recording media are integrated to be formed of a non-portable recording medium such as a built-in hard disk drive or an SSD (Solid State Drive).

The control unit 970 is formed with a CPU or a memory. The memory stores the program performed by the CPU or various pieces of data necessary when the CPU performs a process. The program stored in the memory is performed by being read by the CPU at a predetermined timing, for example, at the time of starting the imaging apparatus 960. The CPU controls each unit such that the imaging apparatus 960 is operated according to the user operation by performing the program.

In the imaging apparatus formed in this way, the image data processing unit 964 has a function of the encoding apparatus and the decoding apparatus (encoding method and decoding method) of the present application. For this reason, it is possible to improve encoding efficiency of the parallax image using the information related to the parallax image. Further, the encoded data of the parallax image in which encoding efficiency is improved by being encoded using the information related to the parallax image can be decoded.

The embodiments of the present technology are not limited to the above-described embodiments and various modifications are possible without departing from the scope of the present technology.

Further, the present technology can be configured as follows.

(1) An image processing apparatus including a depth motion prediction unit which performs a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target; a motion prediction unit which generates a depth prediction image by performing a weighting prediction process using a weighting coefficient and an offset after the depth weighting prediction process is performed by the depth motion prediction unit; and an encoding unit which generates a depth stream by encoding a target depth image to be encoded, using the depth prediction image generated by the motion prediction unit.

(2) The image processing apparatus according to (1) further including a setting unit which sets depth identification data which identifies whether the depth weighting prediction process is performed based on the depth range or the depth weighting prediction process is performed based on a disparity range indicating a range of a disparity value, which is used when the disparity value as a pixel value of the depth image is normalized; and a transmission unit which transmits the depth stream generated by the encoding unit and the depth identification data set by the setting unit.

(3) The image processing apparatus according to (1) or (2), further including a control unit which selects whether to perform the depth weighting prediction process by the depth motion prediction unit according to a picture type when the depth image is encoded.

(4) The image processing apparatus according to (3), in which the control unit controls the depth motion prediction unit such that the depth weighting prediction process performed by the depth motion prediction unit is skipped when the depth image is encoded as a B picture.

(5) The image processing apparatus according to any one of (1) to (4), further including a control unit which selects whether to perform the weighting prediction process by the motion prediction unit according to a picture type when the depth image is encoded.

(6) An image processing method of an image processing apparatus, including a depth motion predicting step of performing a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target; a motion predicting step of generating a depth prediction image by performing a weighting prediction process using a weighting coefficient and an offset after the depth weighting prediction process is performed by the process of the depth motion predicting step; and an encoding step of generating a depth stream by encoding a target depth image to be encoded, using the depth prediction image generated by the process of the motion predicting step.

(7) An image processing apparatus including a receiving unit which receives a depth stream, encoded using a prediction image of a depth image that is corrected using information with regard to the depth image, and the information with regard to the depth image; a depth motion prediction unit which calculates a depth weighting coefficient and a depth offset based on a depth range indicating a range of a position in a depth direction, which is used when a depth value representing the position in the depth direction as a pixel value of the depth image is normalized, using the information with regard to the depth image received by the receiving unit and performs a depth weighting prediction process using the depth weighting coefficient and the depth offset with the depth image as a target; a motion prediction unit which generates a depth prediction image by performing a weighting prediction process using a weighting coefficient and an offset after the depth weighting prediction process is performed by the depth motion prediction unit; and a decoding unit which decodes the depth stream received by the receiving unit using the depth prediction image generated by the motion prediction unit.

(8) The image processing apparatus according to (7), in which the receiving unit receives depth identification data which identifies whether the depth weighting prediction process is performed based on the depth range at the time of encoding or the depth weighting prediction process is performed based on a disparity range indicating a range of a disparity value, which is used when the disparity value as a pixel value of the depth image is normalized, and the depth motion prediction unit performs the depth weighting prediction process according to the depth identification data received by the receiving unit.

(9) The image processing apparatus according to (7) or (8), further including a control unit which selects whether to perform the depth weighting prediction process by the depth motion prediction unit according to a picture type when the depth stream is decoded.

(10) The image processing apparatus according to (9), in which the control unit controls the depth motion prediction unit such that the depth weighting prediction process performed by the depth motion prediction unit is skipped when the depth stream is decoded as a B picture.

(11) The image processing apparatus according to any one of (7) to (10), further including a control unit which selects whether to perform the weighting prediction process by the motion prediction unit according to a picture type when the depth stream is decoded.

(12) An image processing method of an image processing apparatus, including a receiving step of receiving a depth stream encoded using a prediction image of a depth image that is corrected using information with regard to the depth image, and the information with regard to the depth image; a depth motion predicting step of calculating a depth weighting coefficient and a depth offset based on a depth range indicating a range of a position in a depth direction, which is used when a depth value representing the position in the depth direction as a pixel value of the depth image is normalized, using the information with regard to the depth image received by the process of the receiving step and performing a depth weighting prediction process using the depth weighting coefficient and the depth offset with the depth image as a target; a motion predicting step of generating a depth prediction image by performing a weighting prediction process using a weighting coefficient and an offset after the depth weighting prediction process is performed by the process of the depth motion predicting step; and a decoding step of decoding the depth stream received by the process of the receiving step using the depth prediction image generated by the process of the motion predicting step.

(13) An image processing apparatus including a depth motion prediction unit which performs a depth weighting prediction process using a depth weighting coefficient and a depth offset based on a disparity range indicating a range of a disparity, which is used when the disparity as a pixel value of a depth image is normalized, with the depth image as a target; a motion prediction unit which generates a depth prediction image by performing a weighting prediction process using a weighting coefficient and an offset after the depth weighting prediction process is performed by the depth motion prediction unit; and an encoding unit which generates a depth stream by encoding a target depth image to be encoded, using the depth prediction image generated by the motion prediction unit.

(14) The image processing apparatus according to (13), further including a control unit which controls the depth weighting prediction unit such that the depth weighting prediction process is changed according to a type of the depth image, in which the depth motion prediction unit performs the depth weighting prediction process based on a depth range indicating a range of a position in a depth direction, which is used when a depth value indicating the position in the depth direction as a pixel value of the depth image is normalized with the depth image as a target.

(15) The image processing apparatus according to (14), in which the control unit changes the depth weighting prediction process depending on whether the type of the depth image is a type in which the depth value is used as a pixel value or is a type in which the disparity is used as a pixel value.

(16) The image processing apparatus according to any one of (13) to (15), further including a control unit which controls the motion prediction unit to perform the weighting prediction process or to skip the weighting prediction process.

(17) The image processing apparatus according to any one of (13) to (16), further including a setting unit which sets weighting predicting identification data and identifies whether to perform the weighting prediction process or to skip the weighting prediction process; and a transmission unit which transmits the depth stream generated by the encoding unit and the weighting predicting identification data set by the setting unit.

(18) An image processing method of an image processing apparatus, including a depth motion predicting step of performing a depth weighting prediction process using a depth weighting coefficient and a depth offset based on a disparity range indicating a range of a disparity, which is used when the disparity as a pixel value of a depth image is normalized, with the depth image as a target; a motion predicting step of generating a depth prediction image by performing a weighting prediction process using a weighting coefficient and an offset after the depth weighting prediction process is performed by the process of the depth motion predicting step; and an encoding step of generating a depth stream by encoding a target depth image to be encoded, using the depth prediction image generated by the process of the motion predicting step.

(19) An image processing apparatus including a receiving unit which receives a depth stream, encoded using a prediction image of a depth image that is corrected using information with regard to the depth image, and the information with regard to the depth image; a depth motion prediction unit which calculates a depth weighting coefficient and a depth offset based on a disparity range indicating a range of a disparity, which is used when the disparity as a pixel value of the depth image is normalized, using the information with regard to the depth image received by the receiving unit and performs a depth weighting prediction process using the depth weighting coefficient and the depth offset with the depth image as a target; a motion prediction unit which generates a depth prediction image by performing a weighting prediction process using a weighting coefficient and an offset after the depth weighting prediction process is performed by the depth motion prediction unit; and a decoding unit which decodes the depth stream received by the receiving unit using the depth prediction image generated by the motion prediction unit.

(20) An image processing method of an image processing apparatus, including a receiving step of receiving a depth stream encoded using a prediction image of a depth image that is corrected using information with regard to the depth image, and the information with regard to the depth image; a depth motion predicting step of calculating a depth weighting coefficient and a depth offset based on a disparity range indicating a range of a disparity, which is used when the disparity as a pixel value of the depth image is normalized, using the information with regard to the depth image received by the process of the receiving step and performing a depth weighting prediction process using the depth weighting coefficient and the depth offset with the depth image as a target; a motion predicting step of generating a depth prediction image by performing a weighting prediction process using a weighting coefficient and an offset after the depth weighting prediction process is performed by the process of the depth motion predicting step; and a decoding step of decoding the depth stream received by the process of the receiving step using the depth prediction image generated by the process of the motion predicting step.

### REFERENCE SIGNS LIST

50 ENCODING APPARATUS
64 SPS ENCODING UNIT
123 ARITHMETIC UNIT
134 MOTION PREDICTION AND COMPENSATION UNIT
135 CORRECTION UNIT
150 DECODING APPARATUS
152 VIEWPOINT COMPOSITION UNIT
171 SPS DECODING UNIT
255 ADDITION UNIT
262 MOTION COMPENSATION UNIT
263 CORRECTION UNIT

1. An image processing apparatus, comprising:
a depth motion prediction unit which performs a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target;
a motion prediction unit which generates a depth prediction image by performing a weighting prediction process using a weighting coefficient and an offset after the depth weighting prediction process is performed by the depth motion prediction unit; and
an encoding unit which generates a depth stream by encoding a target depth image to be encoded, using the depth prediction image generated by the motion prediction unit.

2. The image processing apparatus according to claim 1, further comprising:
a setting unit which sets depth identification data which identifies whether the depth weighting prediction process is performed based on the depth range or the depth weighting prediction process is performed based on a disparity range indicating a range of a disparity value, which is used when the disparity value as a pixel value of the depth image is normalized; and
a transmission unit which transmits the depth stream generated by the encoding unit and the depth identification data set by the setting unit.

3. The image processing apparatus according to claim 1, further comprising a control unit which selects whether to perform the depth weighting prediction process by the depth motion prediction unit according to a picture type when the depth image is encoded.

4. The image processing apparatus according to claim 3, wherein the control unit controls the depth motion prediction unit such that the depth weighting prediction process performed by the depth motion prediction unit is skipped when the depth image is encoded as a B picture.

5. The image processing apparatus according to claim 1, further comprising a control unit which selects whether to perform the weighting prediction process by the motion prediction unit according to a picture type when the depth image is encoded.

6. An image processing method of an image process apparatus, comprising:
a depth motion predicting step of performing a depth weighting prediction process using a depth weighting coefficient and a depth offset based on a depth range indicating a range of a position in a depth direction, which is used when a depth value representing the position in the depth direction as a pixel value of a depth image is normalized, with the depth image as a target;
a motion predicting step of generating a depth prediction image by performing a weighting prediction process using a weighting coefficient and an offset after the depth weighting prediction process is performed by the process of the depth motion predicting step; and
an encoding step of generating a depth stream by encoding a target depth image to be encoded, using the depth prediction image generated by the process of the motion predicting step.

7. An image processing apparatus, comprising:
a receiving unit which receives a depth stream, encoded using a prediction image of a depth image that is corrected using information with regard to the depth image, and the information with regard to the depth image;
a depth motion prediction unit which calculates a depth weighting coefficient and a depth offset based on a depth range indicating a range of a position in a depth direction, which is used when a depth value representing the position in the depth direction as a pixel value of the depth image is normalized, using the information with regard to the depth image received by the receiving unit and performs a depth weighting prediction process using the depth weighting coefficient and the depth offset with the depth image as a target;
a motion prediction unit which generates a depth prediction image by performing a weighting prediction process using a weighting coefficient and an offset after the depth weighting prediction process is performed by the depth motion prediction unit; and
a decoding unit which decodes the depth stream received by the receiving unit using the depth prediction image generated by the motion prediction unit.

8. The image processing apparatus according to claim 7, wherein
the receiving unit receives depth identification data which identifies whether the depth weighting prediction process is performed based on the depth range at the time of encoding or the depth weighting prediction process is performed based on a disparity range indicating a range of a disparity value, which is used when the disparity value as a pixel value of the depth image is normalized, and
the depth motion prediction unit performs the depth weighting prediction process according to the depth identification data received by the receiving unit.

9. The image processing apparatus according to claim 7, further comprising a control unit which selects whether to perform the depth weighting prediction process by the depth motion prediction unit according to a picture type when the depth stream is decoded.

10. The image processing apparatus according to claim 9, wherein the control unit controls the depth motion prediction unit such that the depth weighting prediction process performed by the depth motion prediction unit is skipped when the depth stream is decoded as a B picture.

11. The image processing apparatus according to claim 7, further comprising a control unit which selects whether to perform the weighting prediction process by the motion prediction unit according to a picture type when the depth stream is decoded.

12. An image processing method of an image processing apparatus, comprising:
a receiving step of receiving a depth stream encoded using a prediction image of a depth image that is corrected using information with regard to the depth image, and the information with regard to the depth image;
a depth motion predicting step of calculating a depth weighting coefficient and a depth offset based on a depth range indicating a range of a position in a depth direction, which is used when a depth value representing the position in the depth direction as a pixel value of the depth image is normalized, using the information with regard to the depth image received by the process of the receiving step and performing a depth weighting prediction process using the depth weighting coefficient and the depth offset with the depth image as a target;
a motion predicting step of generating a depth prediction image by performing a weighting prediction process using a weighting coefficient and an offset after the depth weighting prediction process is performed by the process of the depth motion predicting step; and
a decoding step of decoding the depth stream received by the process of the receiving step using the depth prediction image generated by the process of the motion predicting step.

13. An image processing apparatus, comprising:
a depth motion prediction unit which performs a depth weighting prediction process using a depth weighting coefficient and a depth offset based on a disparity range indicating a range of a disparity, which is used when the disparity as a pixel value of a depth image is normalized, with the depth image as a target;
a motion prediction unit which generates a depth prediction image by performing a weighting prediction process using a weighting coefficient and an offset after the depth weighting prediction process is performed by the depth motion prediction unit; and
an encoding unit which generates a depth stream by encoding a target depth image to be encoded, using the depth prediction image generated by the motion prediction unit.

14. The image processing apparatus according to claim 13, further comprising a control unit which controls the depth weighting prediction unit such that the depth weighting prediction process is changed according to a type of the depth image,
wherein the depth motion prediction unit performs the depth weighting prediction process based on a depth range indicating a range of a position in a depth direction, which is used when a depth value indicating the position in the depth direction as a pixel value of the depth image is normalized with the depth image as a target.

15. The image processing apparatus according to claim 14, wherein the control unit changes the depth weighting prediction process depending on whether the type of the depth image is a type in which the depth value is used as a pixel value or is a type in which the disparity is used as a pixel value.

16. The image processing apparatus according to claim 13, further comprising a control unit which controls the motion prediction unit to perform the weighting prediction process or to skip the weighting prediction process.

17. The image processing apparatus according to claim 13, further comprising:
a setting unit which sets weighting predicting identification data and identifies whether to perform the weighting prediction process or to skip the weighting prediction process; and
a transmission unit which transmits the depth stream generated by the encoding unit and the weighting predicting identification data set by the setting unit.

18. An image processing method of an image processing apparatus, comprising:
a depth motion predicting step of performing a depth weighting prediction process using a depth weighting coefficient and a depth offset based on a disparity range indicating a range of a disparity, which is used when the disparity as a pixel value of a depth image is normalized, with the depth image as a target;
a motion predicting step of generating a depth prediction image by performing a weighting prediction process using a weighting coefficient and an offset after the depth weighting prediction process is performed by the process of the depth motion predicting step; and
an encoding step of generating a depth stream by encoding a target depth image to be encoded, using the depth prediction image generated by the process of the motion predicting step.

19. An image processing apparatus, comprising:
a receiving unit which receives a depth stream, encoded using a prediction image of a depth image that is corrected using information with regard to the depth image, and the information with regard to the depth image;
a depth motion prediction unit which calculates a depth weighting coefficient and a depth offset based on a disparity range indicating a range of a disparity, which is used when the disparity as a pixel value of the depth image is normalized, using the information with regard to the depth image received by the receiving unit and performs a depth weighting prediction process using the depth weighting coefficient and the depth offset with the depth image as a target;
a motion prediction unit which generates a depth prediction image by performing a weighting prediction process using a weighting coefficient and an offset after the depth weighting prediction process is performed by the depth motion prediction unit; and
a decoding unit which decodes the depth stream received by the receiving unit using the depth prediction image generated by the motion prediction unit.

20. An image processing method of an image processing apparatus, comprising:
a receiving step of receiving a depth stream encoded using a prediction image of a depth image that is corrected using information with regard to the depth image, and the information with regard to the depth image;
a depth motion predicting step of calculating a depth weighting coefficient and a depth offset based on a disparity range indicating a range of a disparity, which is used when the disparity as a pixel value of the depth image is normalized, using the information with regard to the depth image received by the process of the receiving step and performing a depth weighting prediction process using the depth weighting coefficient and the depth offset with the depth image as a target;
a motion predicting step of generating a depth prediction image by performing a weighting prediction process using a weighting coefficient and an offset after the depth weighting prediction process is performed by the process of the depth motion predicting step; and
a decoding step of decoding the depth stream received by the process of the receiving step using the depth prediction image generated by the process of the motion predicting step.
